(19) United States
(12) Patent Application Publication
(10) Pub. No.: US 2015/0086860 A1
(43) Pub. Date: Mar. 26, 2015

(54) POWER STORAGE DEVICE

(71) Applicant: SEMICONDUCTOR ENERGY LABORATORY CO., LTD., Atsugi-shi (JP)

(72) Inventors: Rie YOKOI, Atsugi (JP); Jun ISHIKAWA, Atsugi (JP); Teppei OGUNI, Atsugi (JP); Kai KIMURA, Atsugi (JP); Satoshi SEO, Sagamihara (JP); Tamae MORIWAKA, Isehara (JP)

(21) Appl. No.: 14/489,938

(22) Filed: Sep. 18, 2014

(30) Foreign Application Priority Data
Sep. 26, 2013 (JP) 2013-200405

(51) Int. Cl. H01M 10/0525; H01M 4/136; H01M 4/131; H01M 4/62; H01M 10/0566; H01M 4/133

(52) U.S. Cl. CPC H01M 10/0525; H01M 10/0566; H01M 4/133; H01M 4/131; H01M 4/621; H01M 4/136; H01M 4/622
USPC 429/188

(57) ABSTRACT

A power storage device with reduced initial irreversible capacity is provided. The power storage device includes a positive electrode, a negative electrode, and an electrolyte solution. The negative electrode includes a negative electrode active material and a water-soluble polymer. The electrolyte solution includes an ionic liquid. The ionic liquid includes a cation and a monovalent amide anion.

### BACKGROUND OF THE INVENTION

1. Field of the Invention

The present invention relates to a power storage device using an ionic liquid.

2. Description of the Related Art

Owing to an increasing demand for portable electronic devices such as a mobile phone and a laptop personal computer and development of an electric vehicle (EV) and the like, a demand for power storage devices such as an electric double layer capacitor, a lithium ion secondary battery, and a lithium ion capacitor has been significantly increasing in recent years. Power storage devices are required to have high capacity, high performance, safety in various operating environments, and the like.

To satisfy the above requirements, electrolyte solutions of the power storage devices have been actively developed. Cyclic carbonates are used for the electrolyte solutions of the power storage devices. In particular, ethylene carbonate is often used because of its high dielectric constant and high ionic conductivity.

However, not only ethylene carbonate but also many other organic solvents have volatility and a low flash point. For this reason, in the case of using an organic solvent for an electrolyte solution of a power storage device, the temperature inside the power storage device might rise due to a short circuit, overcharge, or the like and the power storage device might burst or catch fire.

In consideration of the risks, the use of an ionic liquid, which is nonvolatile and flame-retardant, for an electrolyte solution of a power storage device has been studied. An ionic liquid is also referred to as an ambient temperature molten salt, which is a salt formed by a combination of a cation and an anion. Examples of the ionic liquid are an ionic liquid including a quaternary ammonium-based cation and an ionic liquid including an imidazolium-based cation (see Patent Document 1 and Non-Patent Document 1).

### REFERENCE

### Patent Document

[Patent Document 1] Japanese Published Patent Application No. 2003-331918

### Non-Patent Document

[Non-Patent Document 1] Hajime Matsumoto et al., Fast cycling of Li/LiCoO₂ cell with low-viscosity ionic liquids based on bis(fluorosulfonyl)imide [FSI]⁻, Journal of Power Sources 160, 2006, pp. 1308-1313

### SUMMARY OF THE INVENTION

By using an ionic liquid, which is nonvolatile and flame-retardant, for an electrolyte solution of a power storage device, the safety of the power storage device can be increased. Furthermore, when a lithium ion secondary battery is used as a power storage device, the power storage device can achieve high energy density.

In the case where a material that reacts with lithium at a low potential, such as silicon or graphite, is used for a negative electrode of a lithium ion secondary battery, the cell voltage of the battery can be increased and high energy density can be obtained.

In the case where a material that reacts with lithium at a low potential is used for the negative electrode, however, the low potential might allow a reaction of an electrolyte solution at a potential higher than the potential at which the material reacts with lithium ions. Thus, the initial irreversible capacity of a power storage device is increased, resulting in a problem of a decrease in initial capacity. Also in the case where an electrolyte solution including an ionic liquid is used, depending on the cation species of the ionic liquid, a cation of the ionic liquid undergoes a reaction at a potential higher than a lithium redox potential in some cases.

In view of the above problem, an object of one embodiment of the present invention is to provide a power storage device with reduced initial irreversible capacity. Another object of one embodiment of the present invention is to provide a power storage device with high capacity. Another object of one embodiment of the present invention is to provide a power storage device with high energy density. Another object of one embodiment of the present invention is to provide a power storage device in which a decomposition reaction of an electrolyte solution is suppressed.

One embodiment of the present invention is a power storage device including a positive electrode, a negative electrode, and an electrolyte solution. The negative electrode includes a negative electrode active material and a water-soluble polymer. The electrolyte solution includes an ionic liquid. The ionic liquid includes a cation and a monovalent amide anion.

Another embodiment of the present invention is a power storage device including a positive electrode, a negative electrode, and an electrolyte solution. The negative electrode includes a negative electrode active material, a first material, and a second material. The first material includes a material having rubber elasticity. The second material includes a water-soluble polymer. The electrolyte solution includes an ionic liquid. The ionic liquid includes a cation and a monovalent amide anion.

In the above structure, the water-soluble polymer is preferably polysaccharide. The material having rubber elasticity is preferably a polymer including a styrene monomer unit or a butadiene monomer unit. The monovalent amide anion is preferably an anion represented by (CₙF₂ₙ₊₁SO₂)₂N⁻ (n is greater than or equal to 0 and less than or equal to 3) or CF₂(CF₂SO₂)₂N⁻.

In the above structure, it is preferable that a coating film be provided on a surface of the negative electrode and that the ratio of the proportion of oxygen to the proportion of fluorine (O/F) in the coating film be greater than or equal to 0.1 and less than or equal to 2.

In the above structure, it is preferable that the electrolyte solution include a lithium ion, that a coating film be provided on a surface of the negative electrode, that the coating film include lithium fluoride and lithium carbonate, and that the weight ratio of lithium carbonate to lithium fluoride (lithium carbonate/lithium fluoride) be less than or equal to 2.

In the above structure, it is preferable that the negative electrode active material be a carbon material. It is further preferable that the carbon material be at least one kind selected from natural graphite, artificial graphite, mesophase pitch-based carbon fiber, isotropic pitch-based carbon fiber, and graphene.

By using an ionic liquid for the electrolyte solution, the safety of the power storage device can be increased.

According to one embodiment of the present invention, a power storage device with reduced initial irreversible capacity can be provided. According to another embodiment of the present invention, a power storage device with high capacity can be provided. According to another embodiment of the present invention, a power storage device with high energy density can be provided. According to another embodiment of the present invention, a power storage device in which a decomposition reaction of an electrolyte solution is suppressed can be provided. According to another embodiment of the present invention, the safety of a power storage device can be increased.

### BRIEF DESCRIPTION OF THE DRAWINGS

FIGS. 1A and 1B show an external view and a cross-sectional view of a power storage device.

FIGS. 2A to 2C show an external view, a cross-sectional view, and the operation of a power storage device.

FIGS. 3A and 3B show an external view and a cross-sectional view of a power storage device.

FIGS. 4A and 4B illustrate embodiments of an active material.

FIGS. 5A and 5B illustrate concepts of the behavior of ions around a surface of an active material.

FIGS. 6A and 6B illustrate concepts of the behavior of ions around a surface of an active material.

FIG. 7 illustrates an electrode of a power storage device.

FIG. 8 shows the results of charge and discharge of power storage devices.

FIG. 9 shows the cycle performance of a power storage device.

FIG. 10 shows a cross-sectional TEM image of a graphite particle and a surface coating film.

FIGS. 11A and 11B show cyclic voltammograms.

FIGS. 12A and 12B show the results of X-ray photoelectron spectroscopy measurement.

FIGS. 13A and 13B show the results of X-ray photoelectron spectroscopy measurement.

FIGS. 14A and 14B show the results of X-ray photoelectron spectroscopy measurement.

FIGS. 15A and 15B show the results of X-ray photoelectron spectroscopy measurement.

FIGS. 16A and 16B show the results of X-ray photoelectron spectroscopy measurement.

FIGS. 17A to 17E illustrate application examples of a power storage device.

FIG. 18 illustrates application examples of a power storage device.

FIGS. 19A to 19C illustrate an application example of a power storage device.

FIGS. 20A and 20B illustrate an application example of a power storage device.

FIGS. 21A and 21B illustrate an example of a power storage device.

FIGS. 22A1, 22A2, 22B1, and 22B2 illustrate examples of a power storage device.

FIGS. 23A and 23B illustrate examples of a power storage device.

FIGS. 24A and 24B illustrate examples of a power storage device.

FIG. 25 illustrates an example of a power storage device.

FIG. 26 shows an external view of a storage battery.

FIG. 27 shows an external view of a storage battery.

FIGS. 28A to 28C illustrate a method for manufacturing a storage battery.

FIGS. 29A to 29C show the results of charge and discharge of storage batteries.

FIGS. 30A and 30B show the results of charge and discharge of storage batteries.

FIG. 31 shows the results of charge and discharge of storage batteries.

FIG. 32 shows a chart showing a method for manufacturing a storage battery.

FIGS. 33A and 33B show the results of a charge-discharge cycle test of a storage battery.

FIG. 34 shows the results of a charge-discharge cycle test of a storage battery,

### DETAILED DESCRIPTION OF THE INVENTION

Embodiments of the present invention will be described below in detail with reference to the accompanying drawings. Note that the present invention is not limited to the description below, and it is easily understood by those skilled in the art that a variety of changes and modifications can be made without departing from the spirit and scope of the present invention. Therefore, the present invention is not construed as being limited to the description in the embodiments and examples below.

### Embodiment 1

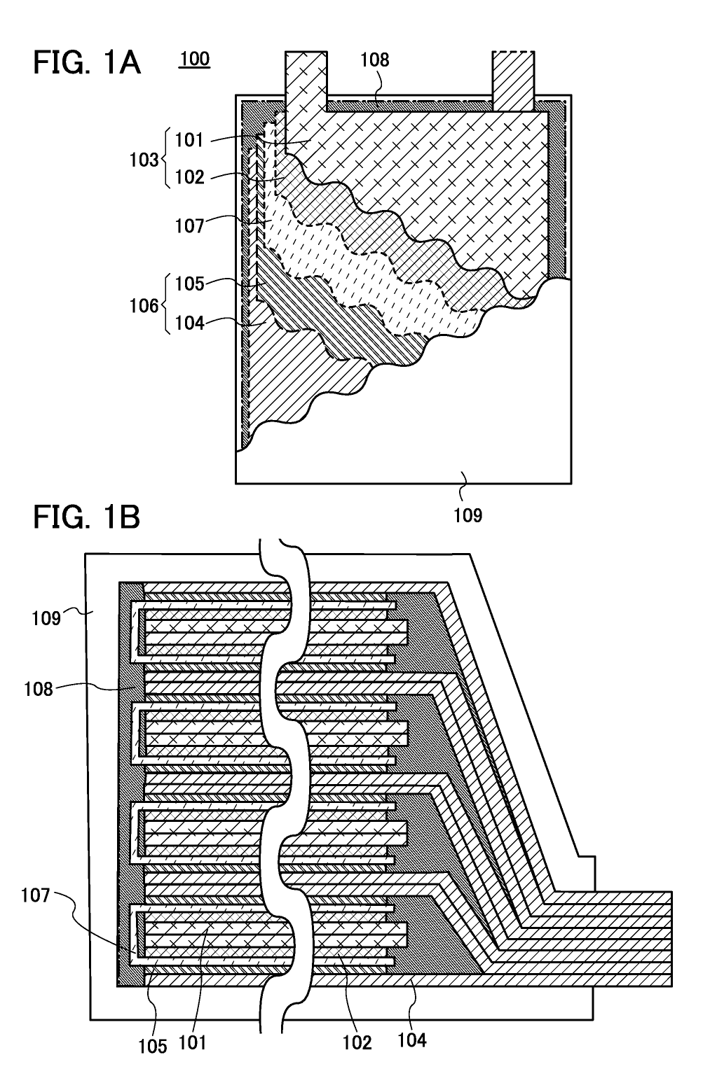

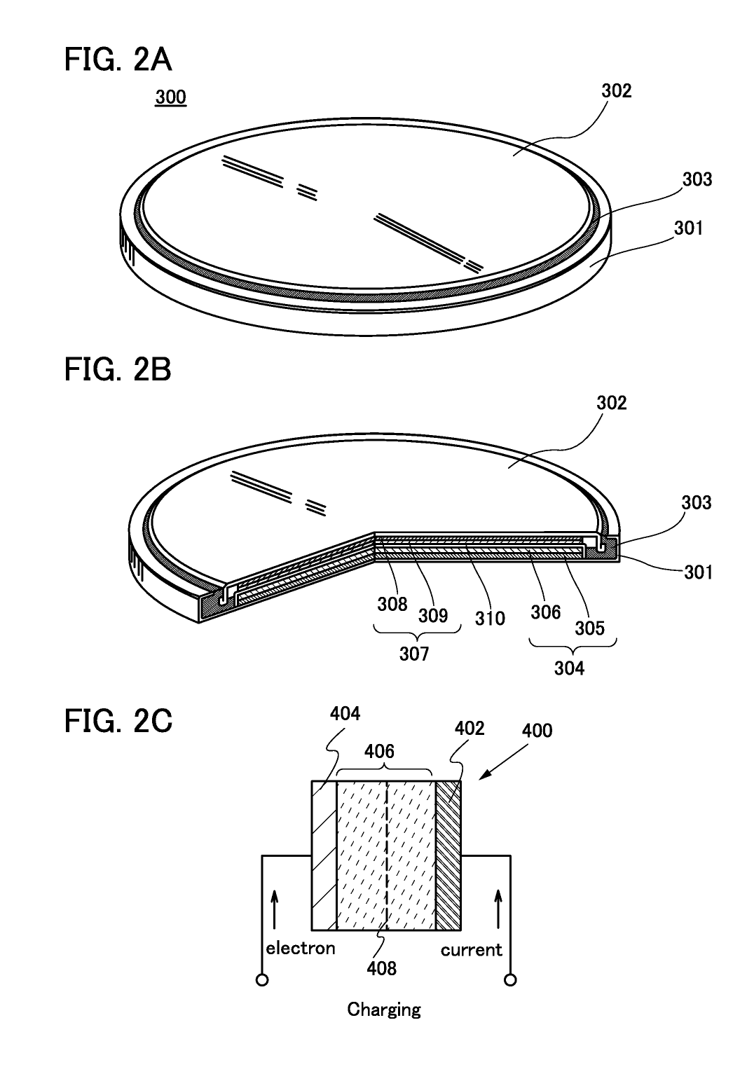

In this embodiment, a structure of a power storage device of one embodiment of the present invention and a method for manufacturing the power storage device are described with reference to FIGS. 1A and 1B and FIGS. 2A to 2C.

A power storage device in this specification and the like refers to any element having a function of storing power and any device having a function of storing power. For example, a lithium ion secondary battery, a lithium ion capacitor, and an electric double layer capacitor are included in the category of the power storage device.

FIG. 1A illustrates a laminated lithium ion secondary battery as an example of the power storage device.

A power storage device 100 illustrated in FIG. 1 A is a laminated storage battery. The power storage device 100 includes a positive electrode 103 including a positive electrode current collector 101 and a positive electrode active material layer 102, a negative electrode 106 including a negative electrode current collector 104 and a negative electrode active material layer 105, a separator 107, an electrolyte solution 108, and an exterior body 109. The separator 107 is provided between the positive electrode 103 and the negative electrode 106 in a region surrounded by the exterior body 109. The electrolyte solution 108 is provided in the region surrounded by the exterior body 109.

First, a structure of the negative electrode 106 is described.

For the negative electrode current collector 104, it is possible to use a highly conductive material, for example, a metal such as copper, nickel, or titanium. The negative electrode current collector 104 can have a foil shape, a plate shape (sheet shape), a net shape, a punching-metal shape, an expanded-metal shape, or the like as appropriate. The negative electrode current collector 104 preferably has a thickness greater than or equal to 10 μm and less than or equal to 30 μm.

The negative electrode active material layer 105 includes a negative electrode active material. An active material refers only to a substance which relates to insertion and extraction of an ion serving as a carrier. In this specification and the like, however, a layer including a conductive additive, a binder, or the like as well as a material that is actually a “negative electrode active material” is also referred to as a negative electrode active material layer.

A material in and from which lithium can be dissolved and precipitated or a material into and from which lithium ions can be inserted and extracted can be used as the negative electrode active material of the negative electrode active material layer 105; for example, a lithium metal, a carbon-based material, or an alloy-based material can be used. The lithium metal is preferable because of its low redox potential (3.045 V lower than that of a standard hydrogen electrode) and high specific capacity per unit weight and per unit volume (3860 mAh/g and 2062 mAh/cm³, respectively).

Examples of the carbon-based material include graphite, graphitized carbon (soft carbon), non-graphitized carbon (hard carbon), a carbon nanotube, graphene, and carbon black.

Graphite is categorized as artificial graphite, such as meso-carbon microbeads (MCMB), coke-based artificial graphite, or pitch-based artificial graphite, or as natural graphite, such as spherical natural graphite,

Graphite has a low potential substantially equal to that of a lithium metal (lower than or equal to 0.3 V vs. Li/Li⁺) when lithium ions are inserted into the graphite (while a lithium-graphite intercalation compound is formed). For this reason, a lithium ion secondary battery can have a high operating voltage. In addition, graphite is preferable because of its advantages such as relatively high capacity per unit volume, small volume expansion, low cost, and safety greater than that of a lithium metal.

For the negative electrode active material, a material which enables charge-discharge reactions by an alloying reaction and a dealloying reaction with lithium can be used. For example, a material including at least one of Ga, Si, Al, Ge, Sn, Pb, Sb, Bi, Ag, Zn, Cd, In, and the like can be used. Such elements have higher capacity than carbon. In particular, silicon has a high theoretical capacity of 4200 mAh/g. For this reason, silicon is preferably used for the negative electrode active material. Examples of an alloy-based material including such elements are SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Alternatively, for the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a nitride including lithium and a transition metal, can be used. For example, Li_{2.6}Co_{0.4}N₃ is preferable because of its high charge-discharge capacity (900 mAh/g and 1890 mAh/cm³).

A nitride including lithium and a transition metal is preferably used, in which case lithium ions are included in the negative electrode active material and thus the negative electrode active material can be used in combination with a material for a positive electrode active material which does not include lithium ions, such as V₂O₅ or Cr₃O₈. In the case of using a material including lithium ions for a positive electrode active material, the nitride including lithium and a transition metal can be used for the negative electrode active material by extracting the lithium ions included in the positive electrode active material in advance.

Alternatively, a material which causes a conversion reaction can be used for the negative electrode active material. For example, a transition metal oxide which does not cause an alloying reaction with lithium, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As the conductive additive, a carbon material, for example, natural graphite, artificial graphite such as meso-carbon microbeads, mesophase pitch-based carbon fibers, isotropic pitch-based carbon fibers, carbon nanotubes, acetylene black (AB), or graphene can be used. Alternatively, metal powder or metal fibers of copper, nickel, aluminum, silver, gold, or the like, a conductive ceramic material, or the like can be used.

Flaky graphene has an excellent electrical characteristic of high conductivity and excellent physical properties of high flexibility and high mechanical strength. For this reason, the use of graphene as the conductive additive can increase the points and the area where the negative electrode active material particles are in contact with each other.

Note that graphene in this specification includes single-layer graphene and multilayer graphene including 2 or more and 100 or less layers. Single-layer graphene refers to a one-atom-thick sheet of carbon molecules having π bonds. Graphene oxide refers to a compound formed by oxidation of such graphene. When graphene oxide is reduced to graphene, oxygen contained in the graphene oxide is not entirely released and part of the oxygen remains in the graphene. In the case where graphene contains oxygen, the proportion of the oxygen measured by X-ray photoelectron spectroscopy (XPS) is 2% or more and 20% or less, preferably 3% or more and 15% or less of the whole graphene.

As the binder, a material such as styrene-butadiene rubber (SBR), styrene-isoprene-styrene rubber, acrylonitrile-butadiene rubber, butadiene rubber, ethylene-propylene-diene copolymer, polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, isobutylene, polyethylene terephthalate, nylon, polyvinylidene fluoride (PVdF), or polyacrylonitrile (PAN) can be used.

Alternatively, polysaccharide may be used as the binder, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used.

A single binder may be used or plural kinds of binders may be used in combination. For example, a binder having a high adhesive force or a high elasticity and a binder having high viscosity modifying properties may be used in combination. As the binder having high viscosity modifying properties, for example, a water-soluble polymer is preferably used. An example of a water-soluble polymer having especially high viscosity modifying properties is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

An example of combination use of plural kinds of binders is a combination of styrene-butadiene rubber (SBR) and carboxymethyl cellulose (CMC).

Note that a cellulose derivative such as carboxymethyl cellulose obtains a higher solubility in a solvent when converted into a salt such as a sodium salt or an ammonium salt of carboxymethyl cellulose, and accordingly, easily exerts an effect as a viscosity modifier. The high solubility can also increase the dispersibility of an active material and other components in the formation of a paste for an active material layer of an electrode. In this specification, cellulose and a cellulose derivative used as a binder in an active material layer of an electrode include salts thereof.

An aqueous solution in which a water-soluble polymer is dissolved can have a stable viscosity. In the aqueous solution, an active material or another binder such as styrene-butadiene rubber can be stably dispersed. Furthermore, a water-soluble polymer is expected to be easily and stably adsorbed to an active material surface because it has a functional group. For example, carboxymethyl cellulose has a hydroxyl group or a carboxyl group as a functional group. The functional group is supposed to provide mutual interaction between polymers, such as a bond of polymers through hydrogen bonding. Therefore, the water-soluble polymer is expected to cover a large area of the active material surface.

Here, especially in the case of using an ionic liquid, it is important that the active material surface is covered. For example, when a binder covers the active material surface, an effect that suppresses a side reaction of the active material with a cation during a reaction with lithium ions can be expected.

In the case of a material having a layered structure, such as graphite, not only lithium ions but also the cation of the ionic liquid is inserted between graphite layers in some cases. This insertion of the cation is a factor of irreversible capacity and might cause separation of a layer or the like. It is highly probable that the binder covering a large area of the active material surface suppresses the cation insertion to reduce the irreversible capacity. In the case where the binder covering the active material surface forms a film, the film is expected to serve as a passivation film to suppress decomposition of the electrolyte solution. The passivation film refers to a film that suppresses electron conduction, that is, suppresses decomposition of the electrolyte solution at a potential at which a battery reaction of the active material occurs. It is preferable that the passivation film can conduct lithium ions while suppressing electron conduction.

In an example shown here, a cellulose derivative having high viscosity modifying properties is used as the binder and graphite is used as the active material. As the cellulose derivative, sodium carboxymethyl cellulose (hereinafter, CMC—Na) is used. It is highly probable that CMC-Na covering the active material surface physically prevents the insertion of a cation between graphite layers. Now, suppose that a material having rubber elasticity, such as styrene-butadiene rubber (hereinafter, SBR), is used as another binder. Since a polymer including a styrene monomer unit or a butadiene monomer unit, such as SBR, has rubber elasticity and easily expands and contracts, a highly reliable electrode which is resistant to stress due to expansion and contraction of an active material during charging and discharging, bending of the electrode, or the like can be obtained. On the other hand, SBR has a hydrophobic group and thus is slightly soluble in water in many cases. Thus, in some cases, particles of SBR are dispersed in an aqueous solution without being dissolved in water. Therefore, when a paste for the active material layer of the electrode is formed using SBR, it is difficult to increase the viscosity of the paste to an appropriate degree for application of the active material layer of the electrode. Meanwhile, when CMC-Na, which has high viscosity modifying properties, is used, the viscosity of a solution such as a paste can be increased moderately. By mixing CMC-Na with the active material and SBR in a solution, e.g. in a paste, a uniform dispersion is formed, so that a favorable electrode having high uniformity, specifically, an electrode having high uniformity in electrode thickness or electrode resistance can be obtained. By being uniformly dispersed, SBR as well as CMC—Na might cover a surface of the active material. In this case, SBR may also contribute to suppression of cation insertion or a function as a passivation film.

Next, a method for forming the negative electrode 106 is described.

First, in order to form the negative electrode active material layer 105, a negative electrode paste is formed. The negative electrode paste can be formed in such a manner that the above-described material to which a conductive additive and a binder are added as appropriate is mixed with a solvent. As the solvent, for example, water or N-methylpyrrolidone (NMP) can be used. Water is preferably used in terms of the safety and cost. With the use of a water-soluble polymer as the binder, a paste with an appropriate viscosity for application can be formed. In addition, a paste with high dispersibility can be formed. Accordingly, a surface of the active material can be favorably covered with the binder. In the first stage of forming the paste, by kneading the active material and the water-soluble polymer into a thick paste, a paste with highly stable viscosity can be formed. It is also possible to increase the dispersibility of each material. Furthermore, the surface of the active material can be easily covered with the binder.

For example, here, graphite is used as the negative electrode active material, CMC—Na and SBR are used as binders, and water is used as the solvent.

First, an aqueous solution is prepared in such a manner that CMC-Na serving as a viscosity modifier is dissolved in pure water. For example, the polymerization degree of CMC-Na is preferably higher than or equal to 200 and lower than or equal to 1000, further preferably higher than or equal to 600 and lower than or equal to 800. Then, the active material is weighed and the CMC-Na aqueous solution is added thereto. When CMC-Na accounts for less than 1% of the total weight of graphite, CMC-Na, and SBR, non-uniform application is likely to occur (the thickness uniformity is poor, so that a thin region is locally formed). The non-uniform application is caused by an increase in viscosity due to drying of the paste (volatilization of the solvent), for example. If the content of CMC-Na is higher than 7 weight %, the fluidity of the paste decreases. Thus, it is preferable that CMC-Na account for 1% or more and 7% or less of the total weight of graphite, CMC-Na, and SBR.

Subsequently, the mixture of these materials is kneaded with a mixer into a thick paste. “Kneading something into a thick paste” means “mixing something with a high viscosity”. As conditions of the mixing, for example, a 5-minute kneading of the mixture into a thick paste may be performed 4 to 6 times at 1500 rpm. By kneading the mixture into a thick paste, the cohesion of the active material can be weakened and the active material and CMC-Na can be dispersed highly uniformly. At this time, part of CMC-Na is supposed to be able to attach to and cover a surface of graphite.

Subsequently, an SBR aqueous dispersion is added to the mixture, and mixing is performed. For example, the mixing may be performed with a mixer for 5 minutes at 1500 rpm.

Subsequently, pure water serving as a dispersion medium is added to the mixture until a predetermined viscosity is obtained, and mixing is performed to form a paste. As conditions of the mixing, for example, a 5-minute mixing may be performed once or twice with a mixer at 1500 rpm. Through the above steps, a favorable paste in which the active material, CMC—Na, and SBR are uniformly dispersed can be formed.

In the case where a film of CMC—Na or SBR is formed on the active material surface, the film is preferably the one that can suppress only cation insertion while allowing insertion and extraction of lithium. Such an effect might be obtained even when CMC-Na or SBR is not in a film form. A porous film of CMC-Na or SBR may be formed. A porous film is preferably formed for the following reason: since a porous film does not seriously hinder insertion and extraction of lithium, it can suppress an increase in reaction resistance while suppressing cation insertion. Accordingly, an electrode having favorable characteristics can be obtained.

The negative electrode current collector 104 may be subjected to surface treatment. Examples of the surface treatment are corona discharge treatment, plasma treatment, and undercoat treatment. The surface treatment can increase the wettability of the negative electrode current collector 104 with respect to the negative electrode paste. In addition, the adhesion between the negative electrode current collector 104 and the negative electrode active material layer 105 can be increased.

Here, the “undercoat” refers to a film formed over a current collector before applying a negative electrode paste to the current collector for the purpose of reducing the interface resistance between an active material layer and the current collector or increasing the adhesion between the active material layer and the current collector. Note that the undercoat is not necessarily in a film form and may be formed in an island shape. In addition, the undercoat may serve as an active material to have capacity. For the undercoat, a carbon material can be used, for example. Examples of the carbon material are graphite, carbon black such as acetylene black or ketjen black, and carbon nanotubes.

Subsequently, the negative electrode paste is applied to the negative electrode current collector 104.

Then, the negative electrode paste is dried to form the negative electrode active material layer 105. In the drying step of the negative electrode paste, drying using a hot plate is performed in an air atmosphere at 70° C. for 30 minutes, and then, further drying is performed in a reduced pressure environment at 100° C. for 10 hours. The negative electrode active material layer 105 formed in this manner has a thickness greater than or equal to 20 μm and less than or equal to 150 μm, for example.

Note that the negative electrode active material layer 105 may be predoped. There is no particular limitation on the method for predoping the negative electrode active material layer 105. For example, the negative electrode active material layer 105 may be predoped electrochemically. For example, before the battery is assembled, the negative electrode active material layer 105 can be predoped with lithium in an electrolyte solution described later with the use of a lithium metal as a counter electrode.

Next, a structure of the positive electrode 103 is described.

For the positive electrode current collector 101, it is possible to use a highly conductive material, for example, a metal such as gold, platinum, aluminum, or titanium, or an alloy thereof (e.g., stainless steel). For example, gold, platinum, or aluminum is preferable. Alternatively, an aluminum alloy to which an element that improves heat resistance, such as silicon, titanium, neodymium, scandium, or molybdenum, is added can be used. The positive electrode current collector 101 can have a foil shape, a plate shape (sheet shape), a net shape, a punching-metal shape, an expanded-metal shape, or the like as appropriate. The positive electrode current collector 101 preferably has a thickness greater than or equal to 10 μm and less than or equal to 30 μm.

The positive electrode active material layer 102 includes a positive electrode active material. As described above, an active material refers only to a substance which relates to insertion and extraction of an ion serving as a carrier. In this specification and the like, however, a layer including a conductive additive, a binder, or the like as well as a material that is actually a “positive electrode active material” is also referred to as a positive electrode active material layer.

As the positive electrode active material, a compound such as LiFeO₂, LiCoO₂, LiNiO₂, LiMn₂O₄, V₂O₅, Cr₂O₅, or MnO₂ can be used.

Alternatively, a lithium-containing complex phosphate (LiMPO₄ (general formula) (M is at least one of Fe(II), Mn(II), Co(II), and Ni(II))) can be used. Typical examples of the general formula LiMPO₄ are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a <1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Alternatively, a lithium-containing complex silicate such as Li₍₂₋ⱼ₎MSiO₄ (general formula) (M is at least one of Fe(II), Mn(II), Co(II), and Ni(II); 0≦j≦2) can be used. Typical examples of the general formula Li₍₂₋ⱼ₎MSiO₄ are Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ₗ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

In the case where carrier ions are alkaline-earth metal ions or alkali metal ions other than lithium ions, the positive electrode active material may contain, instead of lithium in the above lithium compound, lithium-containing complex phosphate, or lithium-containing complex silicate, an alkali metal (e.g., sodium or potassium) or an alkaline-earth metal (e.g., calcium, strontium, barium, beryllium, or magnesium).

A variety of additives such as a conductive additive and a binder can be used for the positive electrode active material layer 102.

Note that in addition to the above-described conductive additive for the negative electrode active material layer 105, a less-graphitized carbon material may be used as the conductive additive for the positive electrode active material layer 102. As the less-graphitized carbon material, carbon black such as acetylene black or ketjen black may be used.

Next, a method for forming the positive electrode 103 is described.

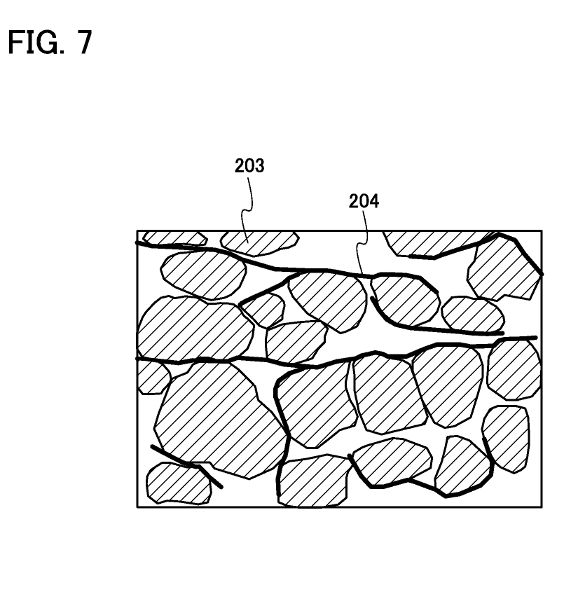

FIG. 7 shows a longitudinal sectional view of the positive electrode active material layer 102. The positive electrode active material layer 102 includes particles of a positive electrode active material 203, graphene 204 as a conductive additive, and a binding agent (also referred to as a binder) (not illustrated).

The longitudinal section of the positive electrode active material layer 102 in FIG. 7 shows substantially uniform dispersion of the sheet-like graphene 204 in the positive electrode active material layer 102. The graphene 204 is schematically illustrated by a thick line in FIG. 7 but is actually a thin film having a thickness corresponding to the thickness of a single layer or a multi-layer of carbon molecules. A plurality of flakes of the graphene 204 is formed in such a way as to wrap, coat, or adhere to surfaces of a plurality of particles of the positive electrode active material 203, so that the graphene 204 makes surface contact with the positive electrode active material 203. Furthermore, flakes of the graphene 204 are also in surface contact with each other; consequently, the plurality of flakes of the graphene 204 forms a three-dimensional electrical conduction network.

This is because graphene oxide with extremely high dispersibility in a polar solvent is used for the formation of the graphene 204. The solvent is removed by volatilization from a dispersion medium in which graphene oxide is uniformly dispersed, and the graphene oxide is reduced to graphene; hence, flakes of the graphene 204 remaining in the positive electrode active material layer 102 partly overlap with each other and are dispersed such that surface contact is made, thereby forming an electrical conduction path.

Unlike a conventional conductive additive in the form of particles, such as acetylene black, which makes point contact with an active material, the graphene 204 is capable of surface contact with low contact resistance; accordingly, the electrical conduction between particles of the positive electrode active material 203 and the graphene 204 can be improved without an increase in the amount of a conductive additive. Thus, the proportion of the positive electrode active material 203 in the positive electrode active material layer 102 can be increased. Accordingly, the discharge capacity of a storage battery can be increased.

Next, an example of a method for forming a positive electrode in which graphene is used as a conductive additive is described. First, an active material, a binding agent (also referred to as a binder), and graphene oxide are prepared.

Graphene oxide is a raw material for the graphene 204 that serves as a conductive additive later. Graphene oxide can be formed by various synthesis methods such as a Hummers method, a modified Hummers method, and oxidation of graphite. Note that the method for forming an electrode for a storage battery of the present invention is not limited by the degree of separation of graphene oxide flakes.

For example, in a Hummers method, graphite such as flake graphite is oxidized to graphite oxide. The obtained graphite oxide is graphite which is oxidized in places and thus to which a functional group such as a carbonyl group, a carboxyl group, or a hydroxyl group is bonded. In the graphite oxide, the crystallinity of graphite is lost and the distance between layers is increased. Therefore, graphene oxide can be easily obtained by separation of the layers from each other by ultrasonic treatment or the like.

The length of one side (also referred to as a flake size) of graphene oxide is greater than or equal to 50 nm and less than or equal to 100 μm, preferably greater than or equal to 800 nm and less than or equal to 20 μm. Particularly in the case where the flake size is smaller than the average particle diameter of the positive electrode active material 203, the surface contact with a plurality of particles of the positive electrode active material 203 and connection between graphene flakes become difficult, resulting in difficulty in improving the electrical conductivity of the positive electrode active material layer 102.

A positive electrode paste is formed by adding a solvent to such graphene oxide, an active material, and a binding agent. As the solvent, water or a polar organic solvent such as N-methylpyrrolidone (NMP) or dimethylformamide can be used. As the binding agent, PVdF, SBR, or CMC—Na may be used, for example.

Note that graphene oxide may be contained at a proportion higher than or equal to 0.1 weight % and lower than or equal to 10 weight %, preferably higher than or equal to 0.1 weight % and lower than or equal to 5 weight %, further preferably higher than or equal to 0.2 weight % and lower than or equal to 1 weight % of the total weight of the mixture of the graphene oxide, the positive electrode active material, the conductive additive, and the binding agent. On the other hand, the graphene obtained after the positive electrode paste is applied to the current collector and reduction is performed may be contained at a proportion higher than or equal to 0.05 weight % and lower than or equal to 5 weight %, preferably higher than or equal to 0.05 weight % and lower than or equal to 2.5 weight %, further preferably higher than or equal to 0.1 weight % and lower than or equal to 0.5 weight % of the total weight of the positive electrode active material layer. This is because the weight of graphene is reduced by almost half owing to the reduction of the graphene oxide.

Note that a solvent may be further added after the mixing so that the viscosity of the mixture can be adjusted. The mixing and the addition of the polar solvent may be repeated plural times.

Subsequently, the positive electrode paste is applied to the current collector.

The paste applied to the current collector is dried by ventilation drying, reduced pressure (vacuum) drying, or the like, so that the positive electrode active material layer 102 is formed. The drying is preferably performed using hot air with a temperature higher than or equal to 50° C. and lower than or equal to 180° C. There is no particular limitation on the atmosphere.

The positive electrode current collector 101 may be subjected to surface treatment. Examples of the surface treatment are corona discharge treatment, plasma treatment, and undercoat treatment. The surface treatment can increase the wettability of the positive electrode current collector 101 with respect to the positive electrode paste. In addition, the adhesion between the positive electrode current collector 101 and the positive electrode active material layer 102 can be increased.

The positive electrode active material layer 102 may be pressed by a compression method such as a roll press method or a flat plate press method so as to be consolidated.

Subsequently, a reaction is caused in a solvent containing a reducer. Through this step, the graphene oxide contained in the active material layer is reduced to the graphene 204. Note that it is possible that oxygen in the graphene oxide is not entirely released but partly remains in the graphene. In the case where the graphene 204 contains oxygen, the proportion of the oxygen measured by XPS is 2% or more and 20% or less, preferably 3% or more and 15% or less of the whole graphene. This reduction treatment is preferably performed at a temperature higher than or equal to room temperature and lower than or equal to 150° C.

Examples of the reducer are ascorbic acid, hydrazine, dimethyl hydrazine, hydroquinone, sodium borohydride (NaBH₄), tetra butyl ammonium bromide (TBAB), LiAlH₄, ethylene glycol, polyethylene glycol, N,N-diethylhydroxylamine, and a derivative thereof.

A polar solvent can be used as the solvent. Any material can be used for the polar solvent as long as it can dissolve the reducer. For example, water, methanol, ethanol, acetone, tetrahydrofuran (THF), dimethylformamide (DMF), N-methylpyrrolidone (NMP), dimethyl sulfoxide (DMSO), or a mixed solution of two or more of them can be used.

After that, washing and drying are performed. The drying is preferably performed in a reduced pressure (vacuum) atmosphere or a reduction atmosphere. This drying step is preferably performed, for example, in vacuum at a temperature higher than or equal to 50° C. and lower than or equal to 200° C. for longer than or equal to 1 hour and shorter than or equal to 48 hours. The drying allows evaporation, volatilization, or removal of the polar solvent and moisture in the positive electrode active material layer 102. The drying may be followed by pressing.

Note that heating can facilitate the reduction reaction. After the drying following the chemical reduction, heating may further be performed.

Through the above steps, the positive electrode active material layer 102 in which the positive electrode active material 203 and the graphene 204 are uniformly dispersed can be formed. The positive electrode active material layer 102 formed in this manner has a thickness greater than or equal to 20 μm and less than or equal to 150 μm.

The electrolyte solution 108 includes a nonaqueous solvent and an electrolyte.

In one embodiment of the present invention, an ionic liquid is used as the nonaqueous solvent. One solvent or a mixed solvent of a plurality of ionic liquids may be used as the ionic liquid. Furthermore, a mixed solvent of an ionic liquid and an organic solvent may be used as the nonaqueous solvent.

An ionic liquid of one embodiment of the present invention includes a cation and an anion, specifically, an organic cation and an anion. Examples of the organic cation are aliphatic onium cations, such as a quaternary ammonium cation, a tertiary sulfonium cation, and a quaternary phosphonium cation, and aromatic cations, such as an imidazolium cation and a pyridinium cation. Examples of the anion are a monovalent amide-based anion, a monovalent methide-based anion, a fluorosulfonate anion, a perfluoroalkylsulfonate anion, tetrafluoroborate, perfluoroalkylborate, hexafluorophosphate, and perfluoroalkylphosphate.

An ionic liquid represented by General Formula (G1) below can be used, for example.

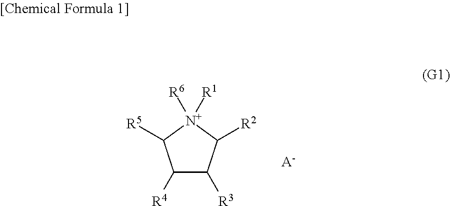

In General Formula (G1), R¹ to R⁶ separately represent an alkyl group having 1 or more and 20 or less carbon atoms, a methoxy group, a methoxymethyl group, a methoxyethyl group, or a hydrogen atom.

In addition, an ionic liquid represented by General Formula (G2) below can be used, for example.

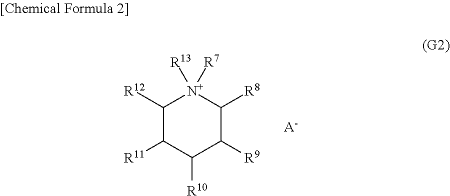

In General Formula (G2), R⁷ to R¹³ separately represent an alkyl group having 1 or more and 20 or less carbon atoms, a methoxy group, a methoxymethyl group, a methoxyethyl group, or a hydrogen atom.

In addition, an ionic liquid represented by General Formula (G3) below can be used, for example.

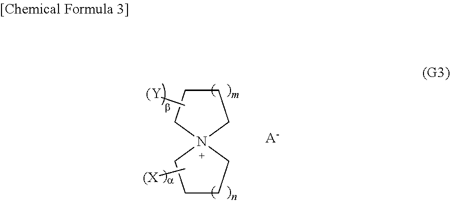

In General Formula (G3), n and m are each greater than or equal to 1 and less than or equal to 3, and α and β are each greater than or equal to 0 and less than or equal to 6. When n is 1, α is greater than or equal to 0 and less than or equal to 4. When n is 2, α is greater than or equal to 0 and less than or equal to 5. When n is 3, α is greater than or equal to 0 and less than or equal to 6. When m is 1, β is greater than or equal to 0 and less than or equal to 4. When m is 2, β is greater than or equal to 0 and less than or equal to 5. When m is 3, β is greater than or equal to 0 and less than or equal to 6. Note that “α or β is 0” means that at least one of two aliphatic rings is unsubstituted. Here, the case where both α and β are 0 is excluded. X or Y is a substituent such as a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

General Formulae (G1) to (G3) each include an aliphatic quaternary ammonium cation as the cation.

Examples of the anion represented by A⁻ in General Formulae (G1) to (G3) are a monovalent amide-based anion, a monovalent methide-based anion, a fluorosulfonate anion (SO₃F⁻), a perfluoroalkylsulfonate anion, tetrafluoroborate (BF₄⁻), perfluoroalkylborate, hexafluorophosphate (PF₆⁻), and perfluoroalkylphosphate. An example of a monovalent amide anion is (CₙF₂ₙ₊₁SO₂)₂N⁻ (n is greater than or equal to 0 and less than or equal to 3). An example of a monovalent cyclic amide anion is CF₂(CF₂SO₂)₂N⁻. An example of a monovalent methide anion is (CₙF₂ₙ₊₁SO₂)₃C⁻ (n is greater than or equal to 0 and less than or equal to 3). An example of a monovalent cyclic methide anion is CF₂(CF₂SO₂)₂C⁻(CF₃SO₂). An example of the perfluoroalkylsulfonate anion is (CₙF₂ₘ₊₁SO₃)⁻ (m is greater than or equal to 0 and less than or equal to 4). An example of perfluoroalkylborate is {BFₘ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m). An example of perfluoroalkylphosphate is {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m). Note that the anion is not limited to these examples.

In the power storage device of one embodiment of the present invention, the ionic liquid may be a stereoisomer of any of the ionic liquids represented by General Formulae (G1) to (G3). Isomers are different compounds with the same molecular formula. Stereoisomers are a particular kind of isomers in which only the spatial orientation differs but coupling of atoms is the same. Thus, in this specification and the like, the term “stereoisomers” includes enantiomers, geometric (cis-trans) isomers, and diastereomers which are isomers that have two or more chiral centers and are not enatiomers.

When the ionic liquid has low reduction resistance and a low potential negative electrode material such as graphite or silicon is used for the negative electrode, the ionic liquid is reduced, which leads to an increase in initial irreversible capacity.

Note that an ionic liquid including an aliphatic quaternary ammonium cation has high reduction resistance; therefore, a low potential negative electrode material such as graphite or silicon can be favorably used. However, even in the case where the ionic liquid including an aliphatic quaternary ammonium cation is used as an electrolyte solution, there is still a demand for a further reduction in initial irreversible capacity.

In the formation of an electrode paste for an electrode including a water-soluble polymer, an active material and the water-soluble polymer are uniformly dispersed, whereby the water-soluble polymer can cover an active material surface. Thus, further suppression of decomposition of the electrolyte solution can be expected. In particular, in the case where a material having a layered structure, such as graphite, is used, it can be expected that the use of the water-soluble polymer can prevent the cation of the ionic liquid from being inserted between graphite layers.

The electrolyte dissolved in the nonaqueous solvent may be a salt which includes ions serving as carriers and is compatible with the positive electrode active material layer. As the salt, an alkali metal ion or an alkaline-earth metal ion can be used. Examples of the alkali metal ion are a lithium ion, a sodium ion, and a potassium ion. Examples of the alkaline-earth metal ion are a calcium ion, a strontium ion, a barium ion, a beryllium ion, and a magnesium ion. In the case where a material containing lithium is used for the positive electrode active material layer, a salt including a lithium ion (hereinafter also referred to as a lithium salt) is preferably selected. In the case where a material containing sodium is used for the positive electrode active material layer, an electrolyte containing sodium is preferably selected.

As the lithium salt, lithium chloride (LiCl), lithium fluoride (LiF), lithium perchlorate (LiClO₄), lithium fluoroborate (LiBF₄), LiAsF₆, LiPF₆, Li(CF₃SO₂)₂N, or the like can be used.

Introduction of a substituent to the aliphatic quaternary ammonium cation decreases the degree of symmetry of the molecule. This can decrease a melting point of the ionic liquid in some cases. The use of an electrolyte solution including such an ionic liquid enables a power storage device to operate favorably even in a low temperature environment.

The ionic liquid which can be used as the nonaqueous solvent is described in detail in Embodiment 2.

As the separator, for example, the one formed using paper, nonwoven fabric, glass fibers, ceramics, or synthetic fibers containing nylon (polyamide), vinylon (polyvinyl alcohol-based fibers), polyester, acrylic, polyolefin, or polyurethane can be used.

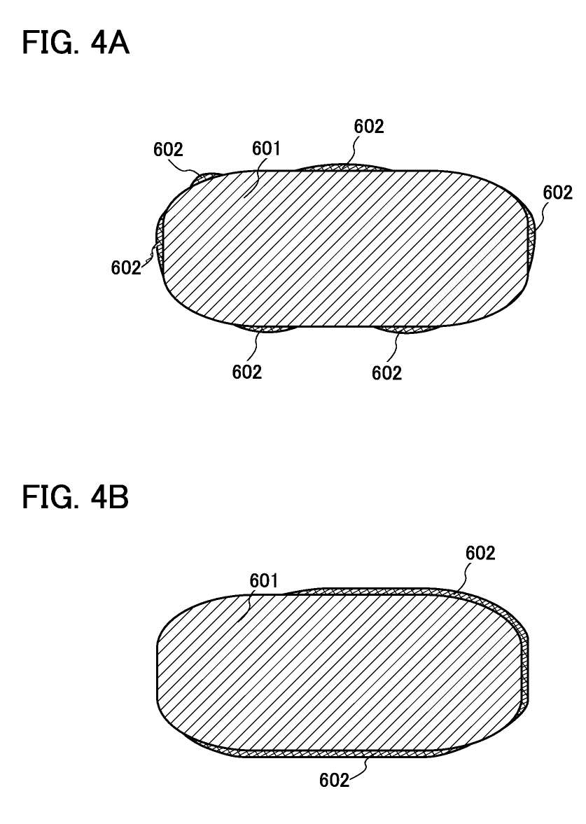

Here, FIGS. 4A and 4B illustrate an active material 601 and a binder 602 which covers the active material 601. The binder 602 having an island shape may cover the active material 601 as illustrated in FIG. 4A, or a film of the binder 602 may cover a large area of the active material 601 as illustrated in FIG. 4B. The binder 602 may be a porous film or is not necessarily a film as long as it is attached to the surface. The binder 602, which covers the active material 601, may be formed of a plurality of materials. For example, the binder 602 preferably includes a water-soluble polymer. An example of the water-soluble polymer is a cellulose derivative such as carboxymethyl cellulose.

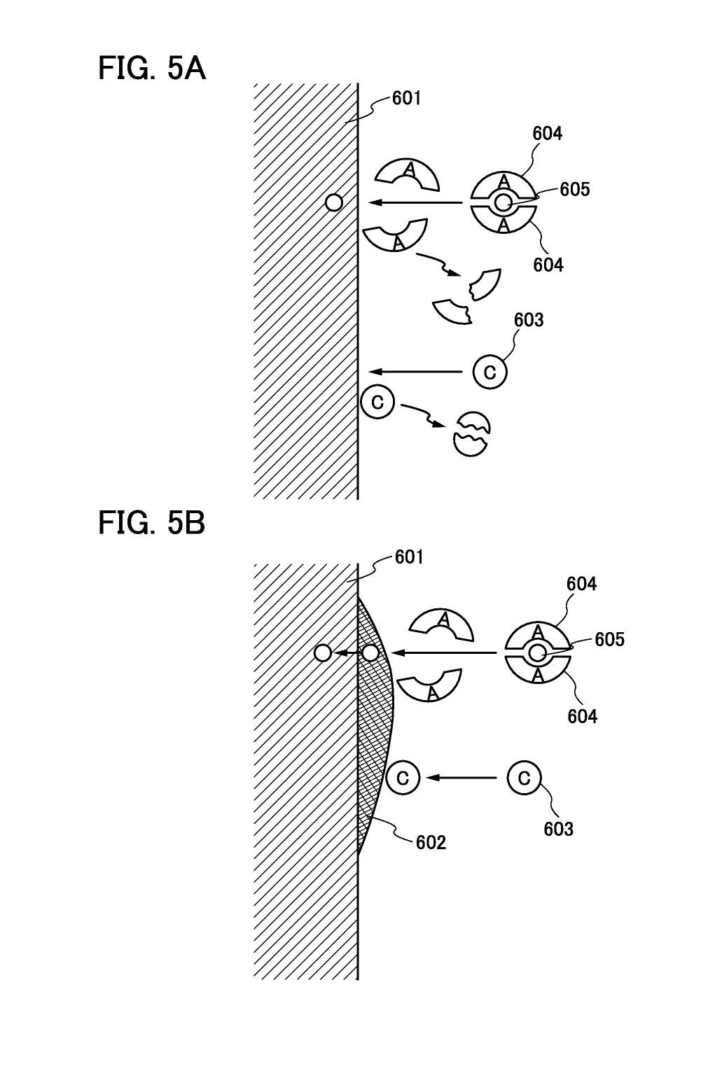

FIG. 5A illustrates ions around a surface of the active material 601, namely, a cation 603 of the ionic liquid, an anion 604 of the ionic liquid, and a cation 605 which contributes to a battery reaction. Here, the cation 605 is an alkali metal ion or an alkaline-earth metal ion. The alkali metal ion can be selected from the alkali metal ions given above. The alkaline-earth metal ion can be selected from the alkaline-earth metal ions given above. The anion 604 is coordinated to the cation 605. The anion 604 of the ionic liquid is detached from the cation 605 at the surface of the active material 601, so that a battery reaction between the cation 605 and the active material occurs. At this time, in the case where the battery reaction occurs at a low potential, the detached anion 604 of the ionic liquid is decomposed at the surface of the active material 601.

Since the cation 603 itself of the ionic liquid has electric charge, the cation 603 is supposed to easily reach the surface of the active material and react with it. In this case, when the battery reaction occurs at a low potential, the cation 603 of the ionic liquid is also decomposed at the surface of the active material 601. The decomposition of the anion 604 and the cation 603 of the ionic liquid causes initial irreversible capacity of the battery. Furthermore, decomposed matters are supposedly deposited to form a coating film on the surface. The coating film refers to a film which covers a surface of an active material and is formed by deposition of decomposed matters of an electrolyte solution, or the like. The coating film may include a binder.

In FIG. 5B, a surface of the active material 601 is covered with the binder 602. In this case, it is probable that when the binder 602 is thick or dense enough to serve as a passivation film, the cation 603 of the ionic liquid and the anion 604 of the ionic liquid are prevented from reacting with the surface of the active material 601. It is preferable that the binder 602 can conduct the cation 605, which contributes to the battery reaction, while preventing the cation 603 of the ionic liquid and the anion 604 of the ionic liquid from reacting with the surface of the active material 601.

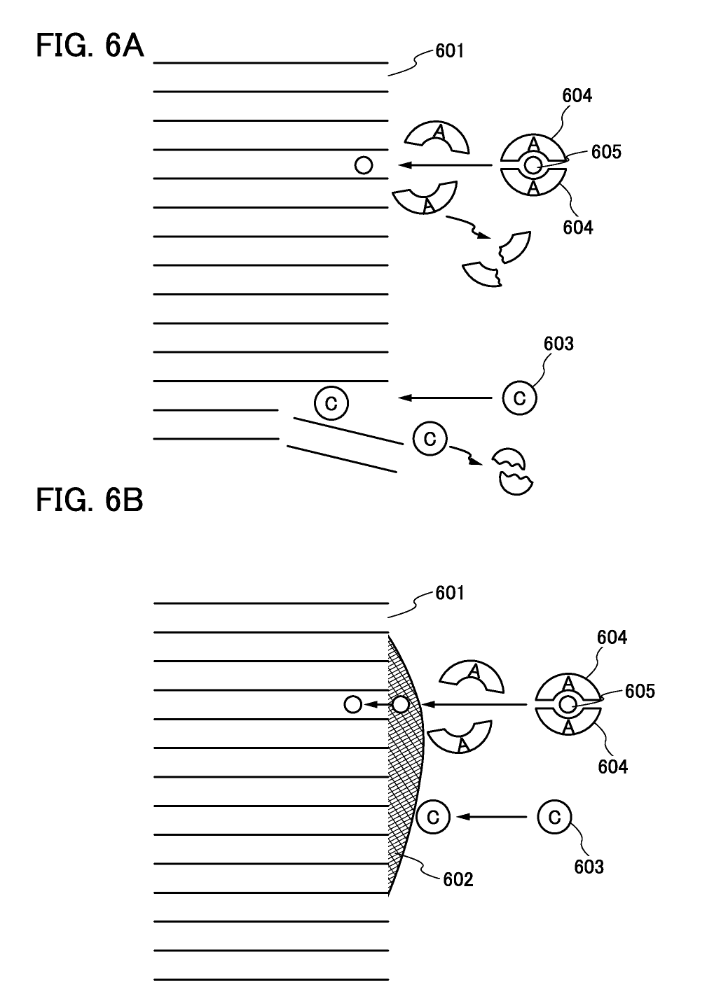

In FIGS. 6A and 6B, which are specific examples of FIGS. 5A and 5B, graphite and a lithium ion are used as the active material 601 and the cation 605, which contributes to the battery reaction, respectively. In FIG. 6A, the anion 604 of the ionic liquid, which is coordinated to the cation 605, i.e., the lithium ion is detached and decomposed at the surface of the active material 601. The cation 605, i.e., the lithium ion is inserted between graphite layers. The cation 603 of the ionic liquid might be inserted between graphite layers, in which case there is a possibility that a graphite layer is separated as illustrated in FIG. 6A.

In FIG. 6B, the surface of the active material 601, i.e., graphite is covered with the binder 602. It can be expected that the insertion of the cation 603 of the ionic liquid is suppressed in a portion covered with the binder 602.

In the power storage device 100 illustrated in FIG. 1A, the positive electrode current collector 101 and the negative electrode current collector 104 also serve as terminals for an electrical contact with an external portion. For this reason, the positive electrode current collector 101 and the negative electrode current collector 104 may be arranged so that they partly exist outside the exterior body 109 and are exposed. Alternatively, a lead electrode may be bonded to the positive electrode current collector 101 or the negative electrode current collector 104 by ultrasonic welding, so that instead of the positive electrode current collector 101 and the negative electrode current collector 104, the lead electrode exists outside the exterior body 109 and is exposed.

As the exterior body 109 of the power storage device 100, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body can be used.

FIG. 1B illustrates an example of a cross-sectional structure of the power storage device 100. Although only two current collectors are illustrated in FIG. 1A for simplicity, an actual power storage device includes three or more electrode layers.

The example in FIG. 1B includes 16 electrode layers. The power storage device 100 has flexibility even though including the 16 electrode layers. FIG. 1B illustrates a structure including 8 negative electrode current collectors 104 and 8 positive electrode current collectors 101, namely 16 current collectors in total. Note that FIG. 1B illustrates a cross section of a lead portion of the negative electrode, and the 8 negative electrode current collectors 104 are bonded to each other by ultrasonic welding. Needless to say, the number of electrode layers is not limited to 16 and may be more than 16 or less than 16. In the case of a large number of electrode layers, the power storage device can have high capacity. In contrast, in the case of a small number of electrode layers, the power storage device can have small thickness and high flexibility.

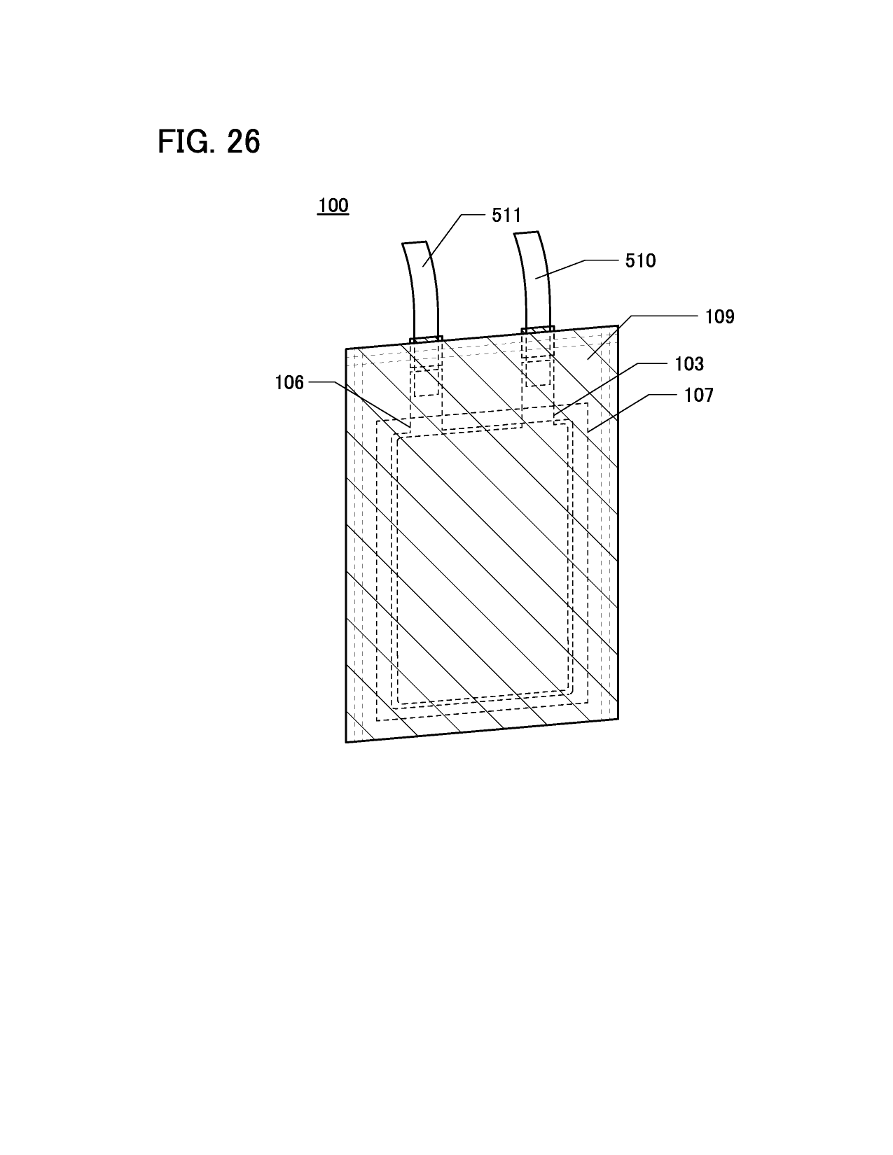

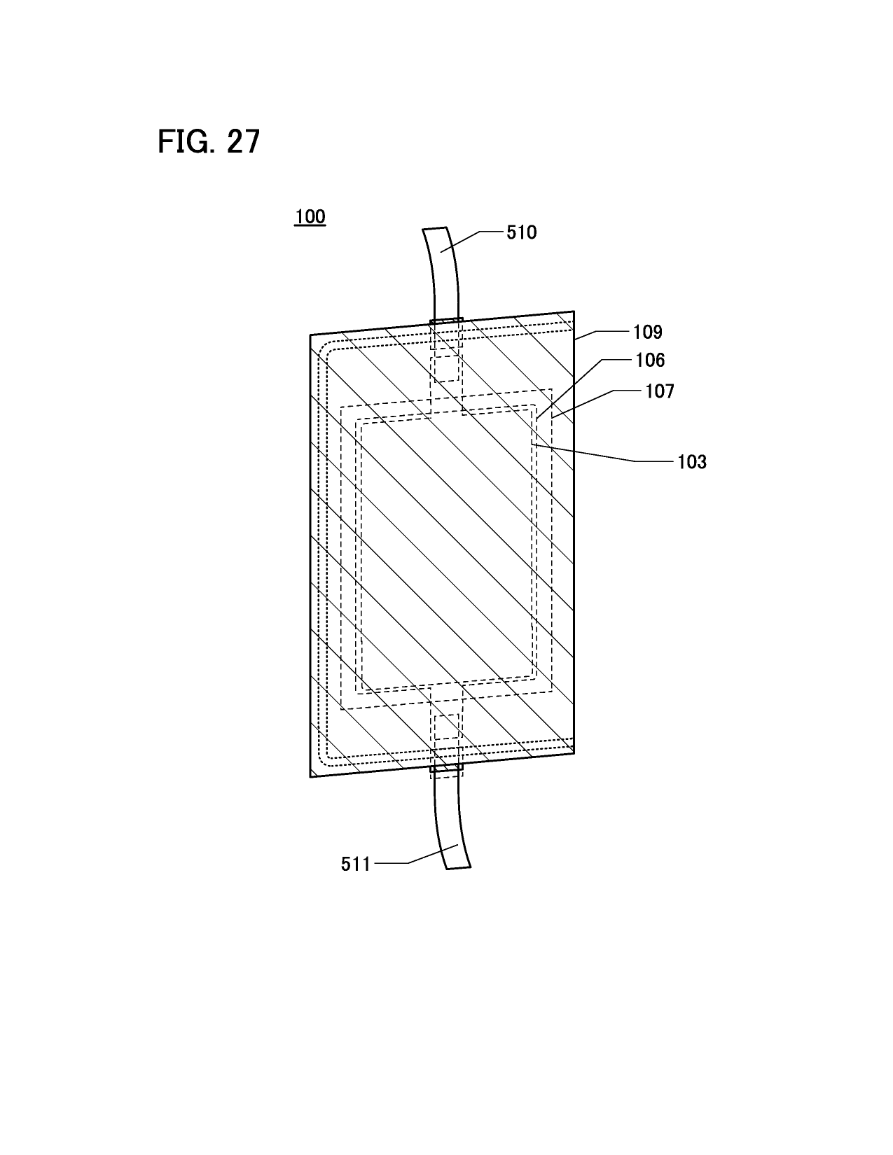

FIG. 26 and FIG. 27 each illustrate an example of an external view of the power storage device 100 which is a laminated storage battery. In FIG. 26 and FIG. 27, the positive electrode 103, the negative electrode 106, the separator 107, the exterior body 109, a positive electrode lead 510, and a negative electrode lead 511 are illustrated.

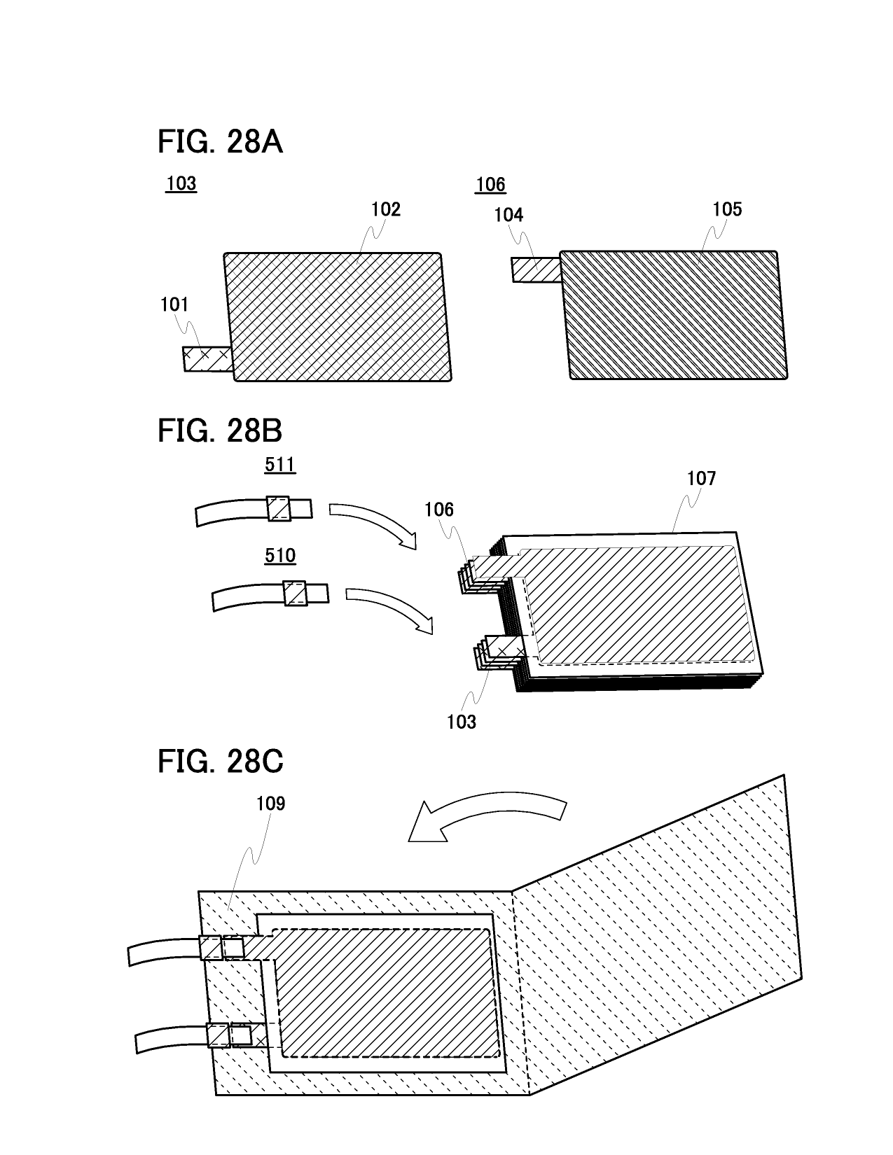

FIG. 28A shows external views of the positive electrode 103 and the negative electrode 106. The positive electrode 103 includes the positive electrode current collector 101, and the positive electrode active material layer 102 is formed on a surface of the positive electrode current collector 101. The positive electrode 103 includes a region in which part of the positive electrode current collector is exposed (hereinafter, the region is referred to as a tab region). The negative electrode 106 includes the negative electrode current collector 104, and the negative electrode active material layer 105 is formed on a surface of the negative electrode current collector 104. The negative electrode 106 includes a region in which part of the negative electrode current collector is exposed, i.e., a tab region. The areas and the shapes of the tab regions in the positive electrode and the negative electrode are not limited to those illustrated in FIG. 28A.

### [Method for Manufacturing Laminated Storage Battery]

An example of a method for manufacturing the laminated storage battery whose external view is shown in FIG. 26 is described with reference to FIGS. 28B and 28C.

First, the negative electrode 106, the separator 107, and the positive electrode 103 are stacked. FIG. 28B illustrates the stack including the negative electrode 106, the separator 107, and the positive electrode 103. In the example shown here, 5 negative electrodes and 4 positive electrodes are used. Then, the tab regions of the positive electrodes 103 are bonded to each other, and the positive electrode lead 510 is bonded to the tab region of the positive electrode on the outermost surface. The bonding may be performed by ultrasonic welding, for example. In a similar manner, the tab regions of the negative electrodes 106 are bonded to each other, and the negative electrode lead 511 is bonded to the tab region of the negative electrode on the outermost surface.

Subsequently, the negative electrode 106, the separator 107, and the positive electrode 103 are placed over the exterior body 109.

Subsequently, the exterior body 109 is folded along the dashed line as illustrated in FIG. 28C. Then, outer edges of the exterior body 109 are bonded together. The bonding may be performed by thermocompression, for example. At this time, part (or one side) of the exterior body 109 is left unbonded (to provide an inlet) so that the electrolyte solution 108 can be introduced later.

Subsequently, the electrolyte solution 108 is introduced into the exterior body 109 through the inlet of the exterior body 109. The electrolyte solution 108 is preferably introduced in a reduced pressure atmosphere or in an inert gas atmosphere. Lastly, the inlet is closed by bonding. In this manner, the power storage device 100, which is a laminated storage battery, can be manufactured.

### [Coin-Type Storage Battery]

Next, a coin-type storage battery is described as another example of the power storage device with reference to FIGS. 2A to 2C. FIG. 2A shows an external view of the coin-type storage battery and FIG. 2B shows a cross-sectional view thereof

In a power storage device 300 illustrated in FIG. 2A, which is a coin-type storage battery, a positive electrode can 301 doubling as a positive electrode terminal and a negative electrode can 302 doubling as a negative electrode terminal are insulated from each other and sealed by a gasket 303 formed of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. A separator 310 and an electrolyte solution (not illustrated) are provided between the positive electrode active material layer 306 and the negative electrode active material layer 309.

The positive electrode 304, the negative electrode 307, and the separator 310 in FIGS. 2A and 2B can have the structures described with reference to FIGS. 1A and 1B.

A metal having corrosion resistance, such as stainless steel, iron, nickel, aluminum, or titanium, can be used for the positive electrode can 301 and the negative electrode can 302. The positive electrode can 301 and the negative electrode can 302 are electrically connected to the positive electrode 304 and the negative electrode 307, respectively.

The positive electrode 304, the negative electrode 307, and the separator 310 are immersed in the electrolyte solution. Then, as illustrated in FIG. 2B, the positive electrode can 301, the positive electrode 304, the separator 310, the negative electrode 307, and the negative electrode can 302 are stacked in this order with the positive electrode can 301 positioned at the bottom. The positive electrode can 301 and the negative electrode can 302 are subjected to pressure bonding with the gasket 303 provided therebetween. Thus, the coin-type storage battery is manufactured.

Here, a current flow in charging a battery is described with reference to FIG. 2C. When a battery using lithium is regarded as a closed circuit, lithium ions move and a current flows in the same direction. Note that between charging and discharging of the battery using lithium, the roles of an anode and a cathode are switched, and an oxidation reaction and a reduction reaction occur on the sides of the corresponding electrodes; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charging is performed, discharging is performed, a reverse pulse current is supplied, and a charging current is supplied. The use of the terms “anode” and “cathode”, which relate to an oxidation reaction and a reduction reaction, might cause confusion because the roles of the anode and the cathode are switched between charging and discharging. Therefore, the terms “anode” and “cathode” are not used in this specification. If the term “anode” or “cathode” is used, it should be mentioned whether it is a matter of charging or discharging and to which electrode (positive electrode or negative electrode) the anode or the cathode corresponds.

Two terminals in FIG. 2C are connected to a charger, and a storage battery 400 is charged. As the charging of the storage battery 400 proceeds, a potential difference between electrodes increases. The positive direction in FIG. 2C is the direction in which a current flows from one external terminal of the storage battery 400 to a positive electrode 402, flows from the positive electrode 402 to a negative electrode 404 in the storage battery 400, and flows from the negative electrode 404 to the other external terminal of the storage battery 400. In other words, a current flows in the direction of a flow of a charging current. The storage battery 400 is filled with an electrolyte solution 406. The storage battery 400 also includes a separator 408 between the positive electrode 402 and the negative electrode 404.

### [Cylindrical Storage Battery]

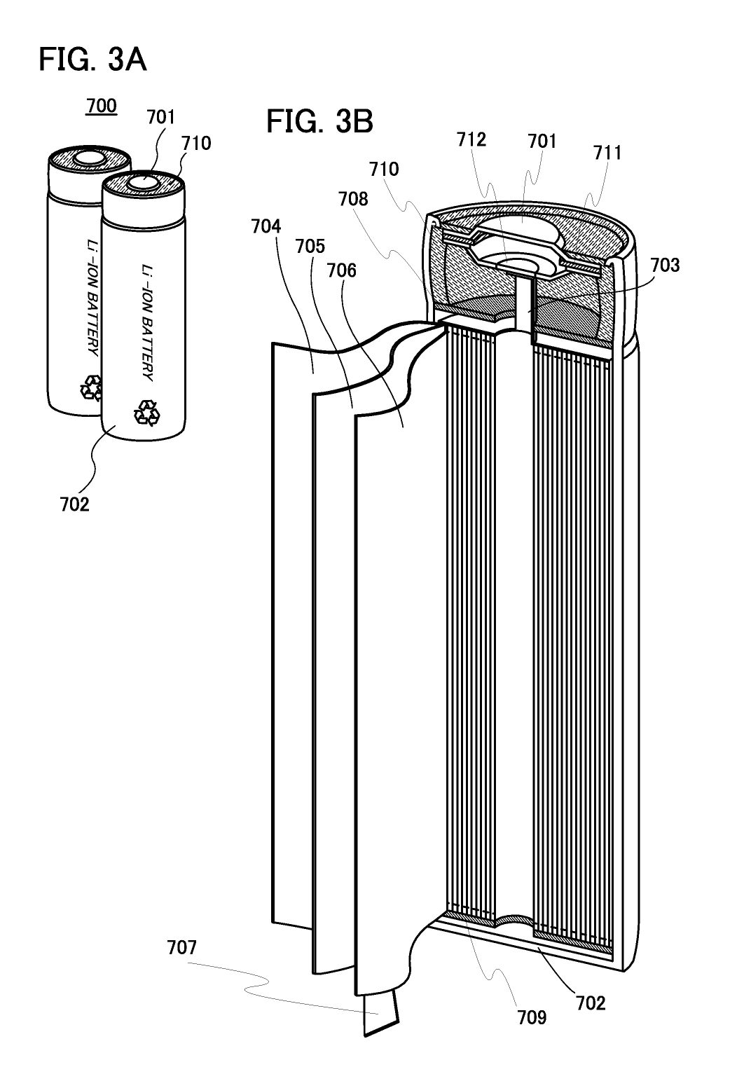

Next, an example of a cylindrical storage battery is described with reference to FIGS. 3A and 3B. As illustrated in FIG. 3A, a power storage device 700 is a cylindrical storage battery and includes a positive electrode cap (battery cap) 701 on the top surface and a battery can (outer can) 702 on the side surface and bottom surface. The positive electrode cap 701 and the battery can 702 are insulated from each other by a gasket (insulating gasket) 710.

FIG. 3B schematically shows a cross section of the cylindrical storage battery. Inside the battery can 702 having a hollow cylindrical shape, a battery element in which a strip-shaped positive electrode 704 and a strip-shaped negative electrode 706 are wound with a stripe-shaped separator 705 interposed therebetween is provided. Although not illustrated, the battery element is wound around a center pin. The battery can 702 is closed at one end and opened at the other end. For the battery can 702, a metal having corrosion resistance in an electrolyte solution, such as nickel, aluminum, or titanium, an alloy of such metals, or an alloy of such a metal and another metal (e.g., stainless steel) can be used. Alternatively, the battery can 702 is preferably coated with nickel, aluminum, or the like in order to prevent corrosion by the electrolyte solution. Inside the battery can 702, the battery element in which the positive electrode, the negative electrode, and the separator are wound is interposed between a pair of insulating plates 708 and 709 which face each other. In addition, the battery can 702 including the battery element is filled with a nonaqueous electrolyte solution (not illustrated). As the nonaqueous electrolyte solution, a nonaqueous electrolyte solution which is similar to that of the coin-type storage battery can be used.

Although the positive electrode 704 and the negative electrode 706 can be formed in a manner similar to that of the positive electrode and the negative electrode of the coin-type storage battery described above, the difference lies in that since the positive electrode and the negative electrode of the cylindrical storage battery are wound, active materials are formed on both sides of the current collectors. A positive electrode terminal (positive electrode current collecting lead) 703 is connected to the positive electrode 704, and a negative electrode terminal (negative electrode current collecting lead) 707 is connected to the negative electrode 706. Both the positive electrode terminal 703 and the negative electrode terminal 707 can be formed using a metal material such as aluminum. The positive electrode terminal 703 and the negative electrode terminal 707 are resistance-welded to a safety valve mechanism 712 and the bottom of the battery can 702, respectively. The safety valve mechanism 712 is electrically connected to the positive electrode cap 701 through a positive temperature coefficient (PTC) element 711. The safety valve mechanism 712 cuts off the electrical connection between the positive electrode cap 701 and the positive electrode 704 when the internal pressure of the battery exceeds a predetermined threshold value. The PTC element 711 is a heat sensitive resistor whose resistance increases as temperature rises, and controls the amount of current by increase in resistance to prevent abnormal heat generation. Barium titanate (BaTiO₃)-based semiconductor ceramics or the like can be used for the PTC element.

Note that in this embodiment, the laminated storage battery, the coin-type storage battery, and the cylindrical storage battery are given as examples of the power storage device; however, storage batteries with a variety of shapes, such as a sealed storage battery and a square storage battery, can be used. Further, a structure in which a plurality of positive electrodes, a plurality of negative electrodes, and a plurality of separators are stacked or wound may be employed.

For the negative electrode of each of the power storage devices 100, 300, and 700, which are described in this embodiment, the negative electrode active material layer of one embodiment of the present invention is used. Thus, the discharge capacity of the power storage devices 100, 300, and 700 can be increased.

This embodiment can be implemented in combination with any of the other embodiments as appropriate.

### Embodiment 2

In this embodiment, an ionic liquid which can be used as an electrolyte solution of the power storage device of one embodiment of the present invention is described in detail.

The ionic liquid which can be used as the electrolyte solution is composed of an organic cation and an anion.

Examples of the organic cation are aliphatic onium cations, such as a quaternary ammonium cation, a tertiary sulfonium cation, and a quaternary phosphonium cation, and aromatic cations, such as an imidazolium cation and a pyridinium cation.

Examples of the anion are a monovalent amide-based anion, a monovalent methide-based anion, a fluorosulfonate anion, a perfluoroalkylsulfonate anion, tetrafluoroborate, perfluoroalkylborate, hexafluorophosphate, and perfluoroalkylphosphate.

As the ionic liquid, the following can be used.

As the ionic liquid, an ionic liquid composed of a quaternary ammonium cation and a monovalent anion and represented by General Formula (G1) below can be used, for example.

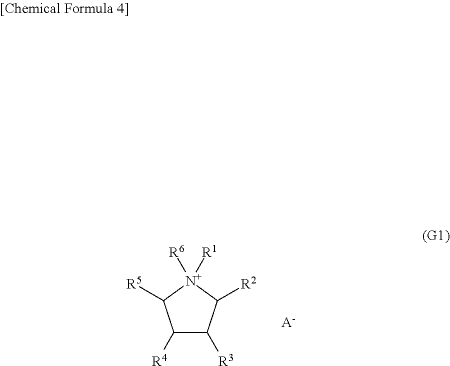

In General Formula (G1), R¹ to R⁶ separately represent an alkyl group having 1 or more and 20 or less carbon atoms, a methoxy group, a methoxymethyl group, a methoxyethyl group, or a hydrogen atom.

As the ionic liquid, an ionic liquid composed of a quaternary ammonium cation and a monovalent anion and represented by General Formula (G2) below can be used, for example.

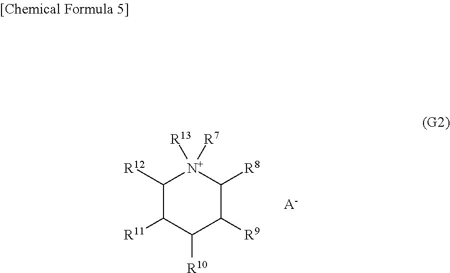

In General Formula (G2), R⁷ to R¹³ separately represent an alkyl group having 1 or more and 20 or less carbon atoms, a methoxy group, a methoxymethyl group, a methoxyethyl group, or a hydrogen atom.

As the ionic liquid, an ionic liquid composed of a quaternary ammonium cation and a monovalent anion and represented by General Formula (G3) below can be used, for example.

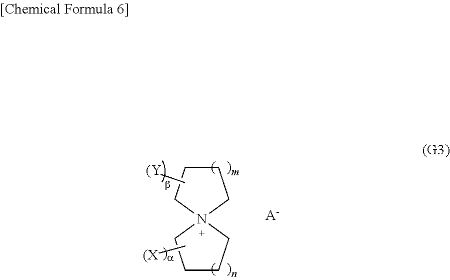

In General Formula (G3), n and m are each greater than or equal to 1 and less than or equal to 3, and α and β are each greater than or equal to 0 and less than or equal to 6. When n is 1, α is greater than or equal to 0 and less than or equal to 4. When n is 2, α is greater than or equal to 0 and less than or equal to 5. When n is 3, α is greater than or equal to 0 and less than or equal to 6. When m is 1, β is greater than or equal to 0 and less than or equal to 4. When m is 2, β is greater than or equal to 0 and less than or equal to 5. When m is 3, β is greater than or equal to 0 and less than or equal to 6. Note that “α or β is 0” means that at least one of two aliphatic rings is unsubstituted. Here, the case where both α and β are 0 is excluded. X or Y is a substituent such as a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms. In addition, A⁻ represents a monovalent amide anion, a monovalent methide anion, a fluorosulfonate anion, a perfluoroalkylsulfonate anion, tetrafluoroborate, perfluoroalkylborate, hexafluorophosphate, or perfluoroalkylphosphate.

In a Spiro quaternary ammonium cation, two aliphatic rings that form a Spiro ring are each a five-membered ring, a six-membered ring, or a seven-membered ring.

As an example of the quaternary ammonium cation represented in General Formula (G3), a quaternary ammonium cation having a Spiro ring including a five-membered ring can be given. An ionic liquid including the quaternary ammonium cation is represented by General Formula (G4) below.

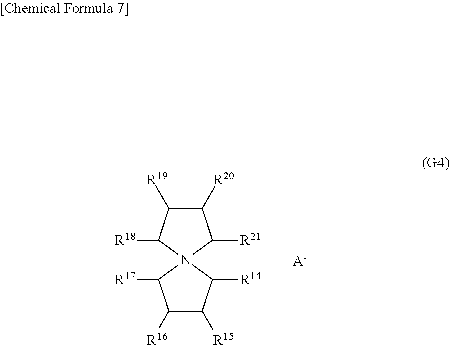

In General Formula (G4), R¹⁴ to R²¹ separately represent a hydrogen atom, a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

In addition, an ionic liquid represented by General Formula (G5) below can be used, for example.

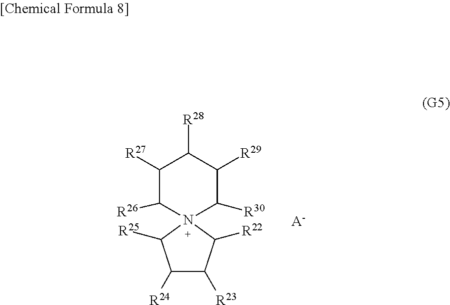

In General Formula (G5), R²² to R³⁰ separately represent a hydrogen atom, a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

In addition, an ionic liquid represented by General Formula (G6) below can be used, for example.

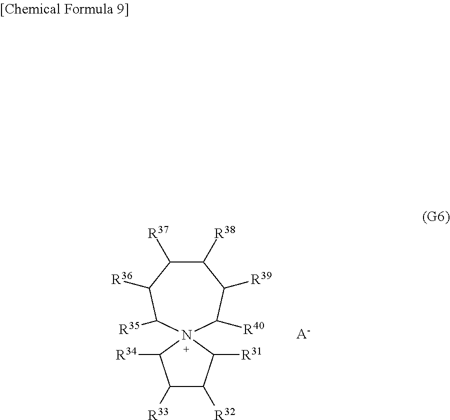

In General Formula (G6), R³¹ to R⁴⁰ separately represent a hydrogen atom, a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

In addition, an ionic liquid represented by General Formula (G7) below can be used, for example.

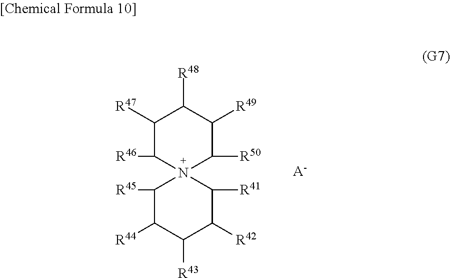

In General Formula (G7), R⁴¹ to R⁵⁰ separately represent a hydrogen atom, a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

In addition, an ionic liquid represented by General Formula (G8) below can be used, for example.

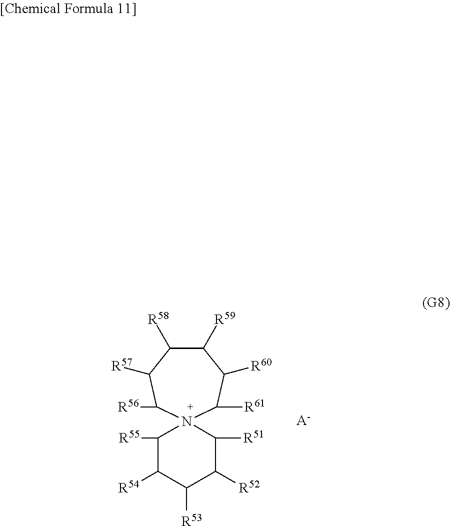

In General Formula (G8), R⁵¹ to R⁶¹ separately represent a hydrogen atom, a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

In addition, an ionic liquid represented by General Formula (G9) below can be used, for example.

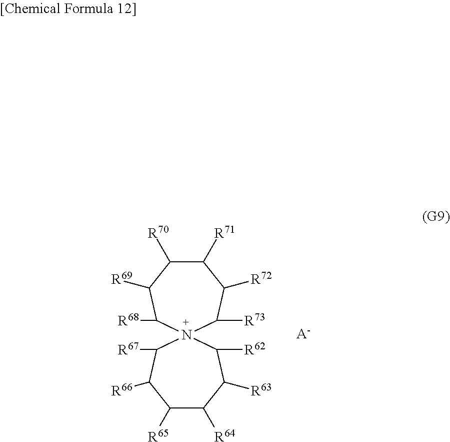

In General Formula (G9), R⁶² to R⁷³ separately represent a hydrogen atom, a straight chain or lateral chain alkyl group having 1 or more and 4 or less carbon atoms, a straight chain or lateral chain alkoxy group having 1 or more and 4 or less carbon atoms, or a straight chain or lateral chain alkoxyalkyl group having 1 or more and 4 or less carbon atoms.

Examples of the anion in General Formulae (G1) to (G9) are a monovalent amide-based anion, a monovalent methide-based anion, a fluorosulfonate anion (SO₃F⁻), a perfluoroalkylsulfonate anion, tetrafluoroborate (BF₄⁻), perfluoroalkylborate, hexafluorophosphate (PF₆⁻), and perfluoroalkylphosphate. An example of a monovalent amide anion is (CₙF₂ₙ₊₁SO₂)₂N⁻ (n is greater than or equal to 0 and less than or equal to 3). An example of a monovalent cyclic amide anion is CF₂(CF₂SO₂)₂N⁻. An example of a monovalent methide anion is (CₙF₂ₙ₊₁SO₂)₃C⁻ (n is greater than or equal to 0 and less than or equal to 3). An example of a monovalent cyclic methide anion is CF₂(CF₂SO₂)₂C⁻(CF₃SO₂). An example of the perfluoroalkylsulfonate anion is (CₘF₂ₘ₊₁SO₃)⁻ (m is greater than or equal to 0 and less than or equal to 4). An example of perfluoroalkylborate is {BFₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m). An example of perfluoroalkylphosphate is {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m). Note that the anion is not limited to these examples.

Specific examples of the ionic liquid are organic compounds represented by Structural Formulae (101) to (120), Structural Formulae (201) to (230), Structural Formulae (301) to (327), Structural Formulae (401) to (457), Structural Formulae (501) to (605), and Structural Formulae (701) to (709).

Pyrrolidinium-based ionic liquids are represented by Structural Formulae (101) to (120).

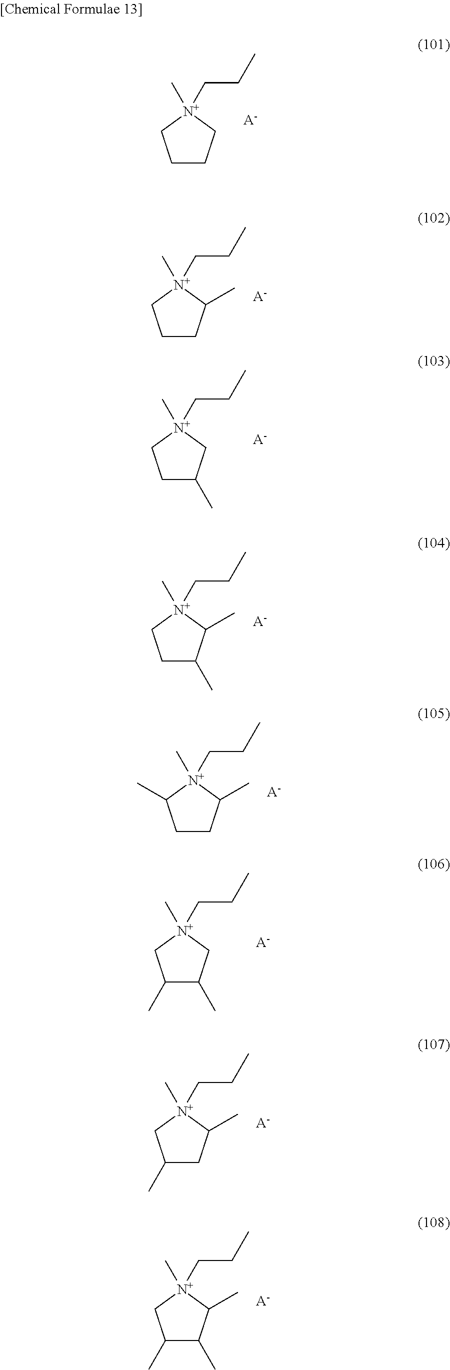

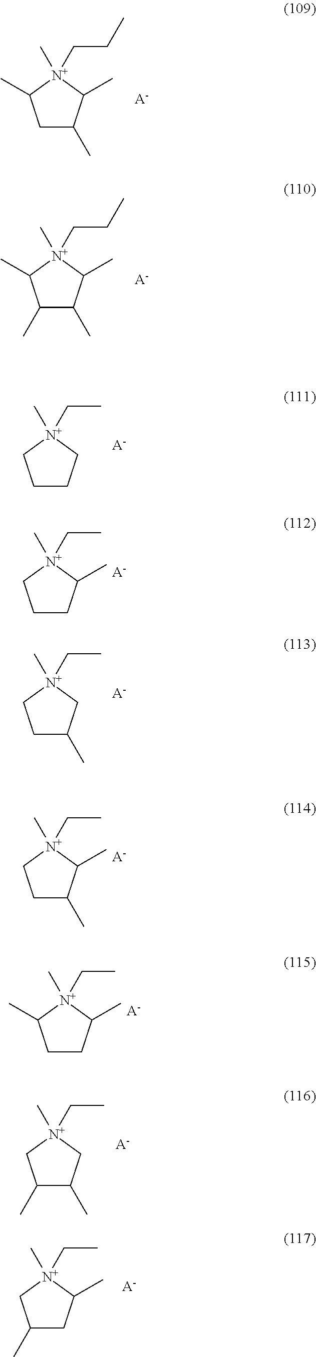

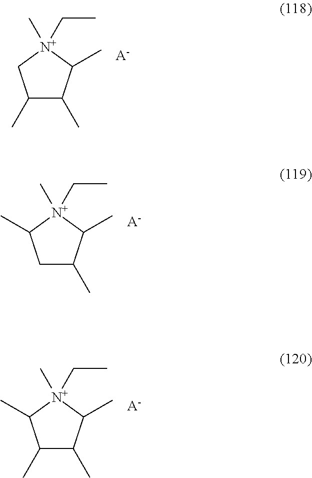

Piperidinium-based ionic liquids are represented by Structural Formulae (201) to (230).

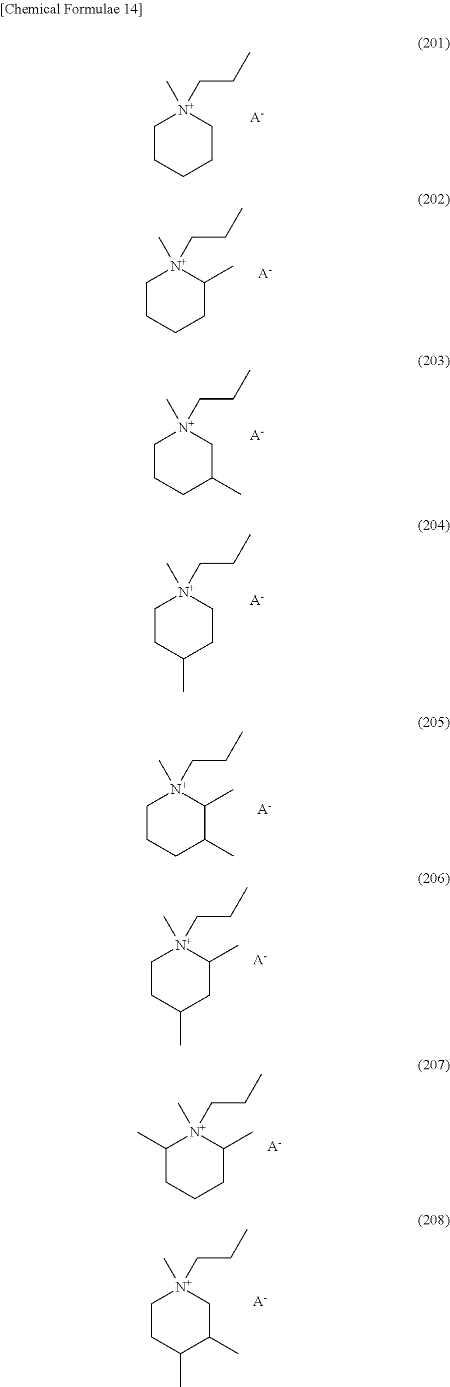

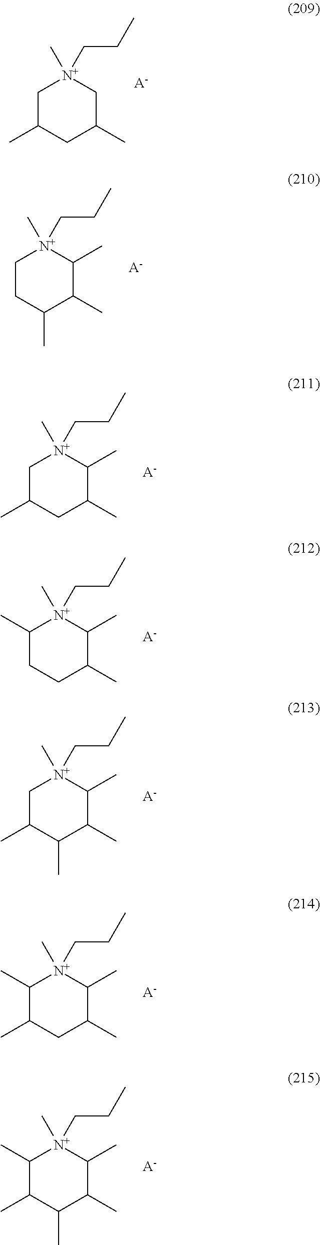

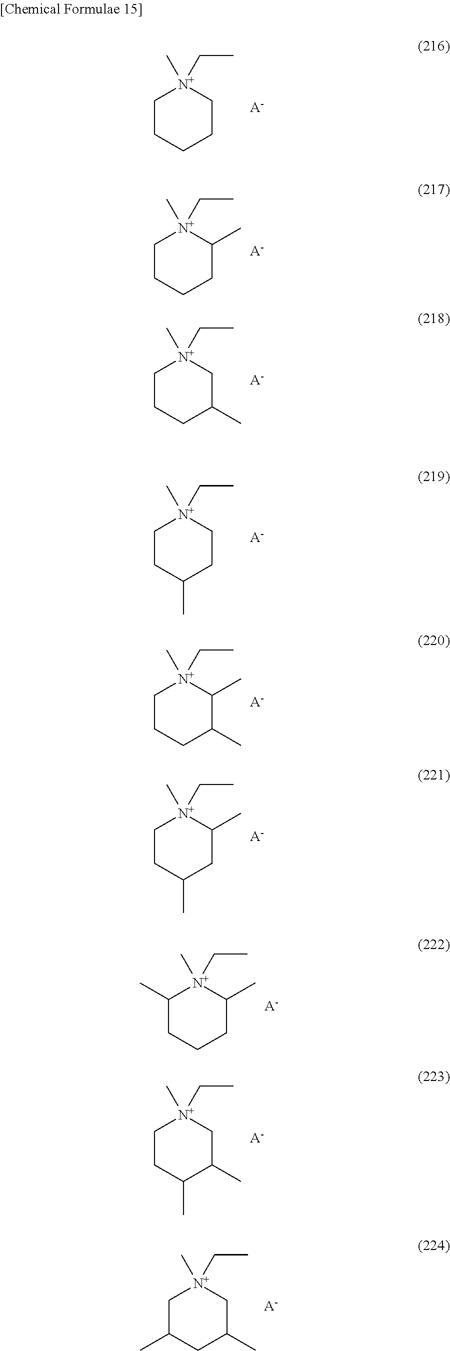

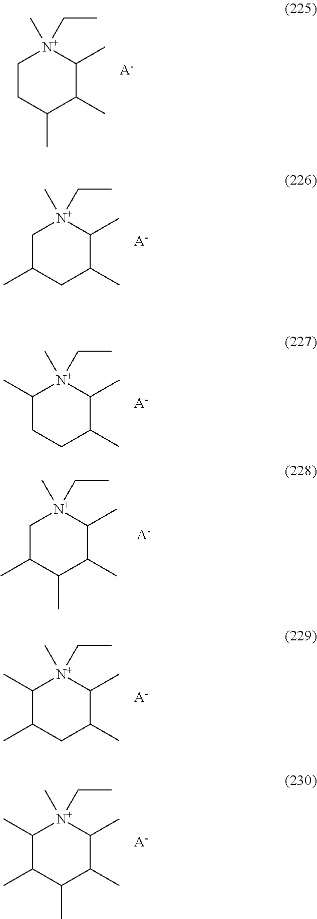

Spiro quaternary ammonium-based ionic liquids are represented by Structural Formulae (301) to (327), Structural Formulae (401) to (457), Structural Formulae (501) to (605), and Structural Formulae (701) to (709).

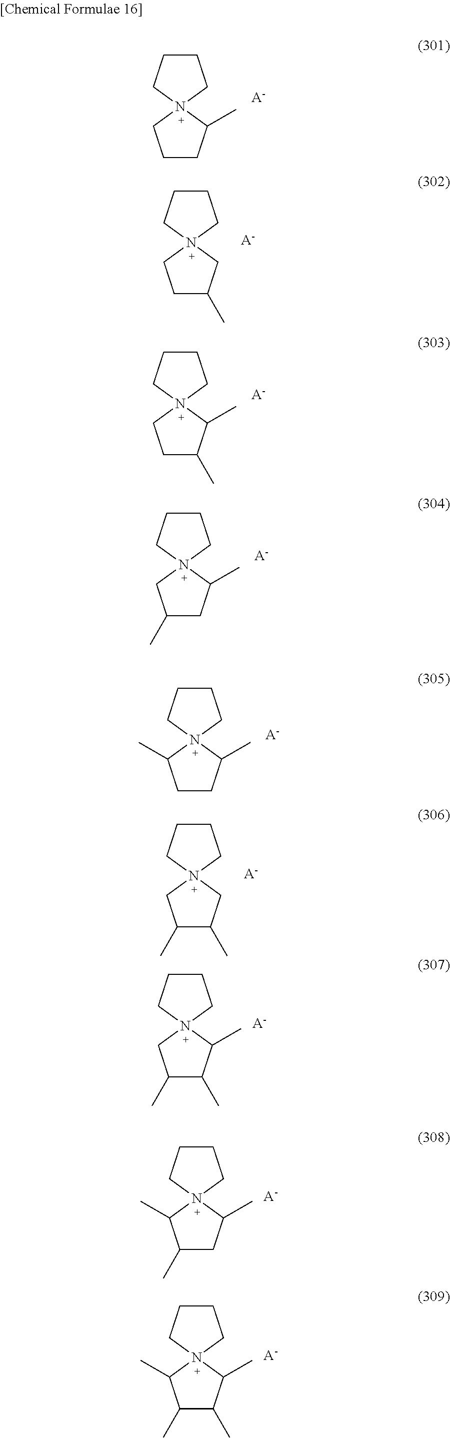

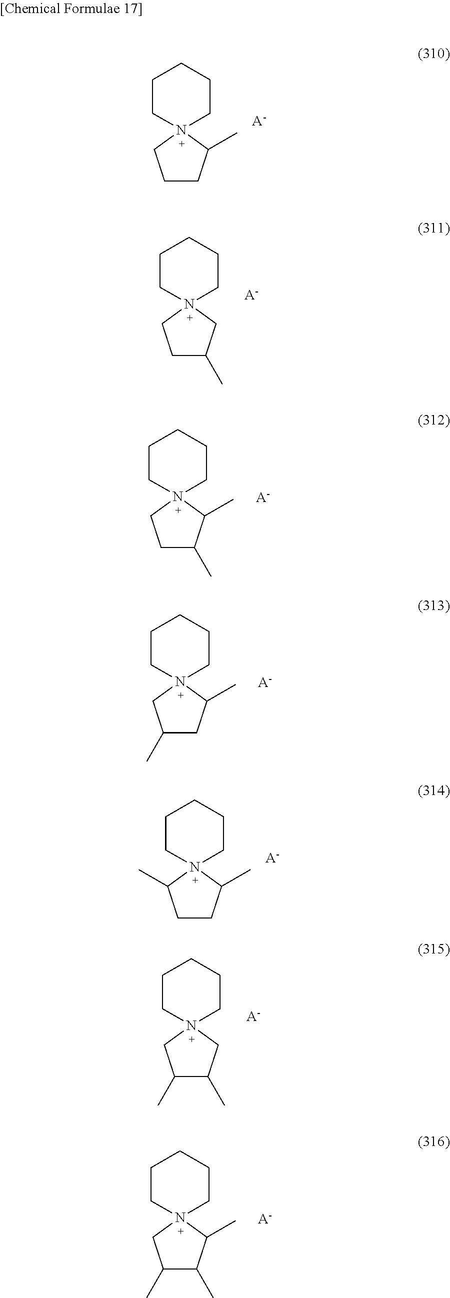

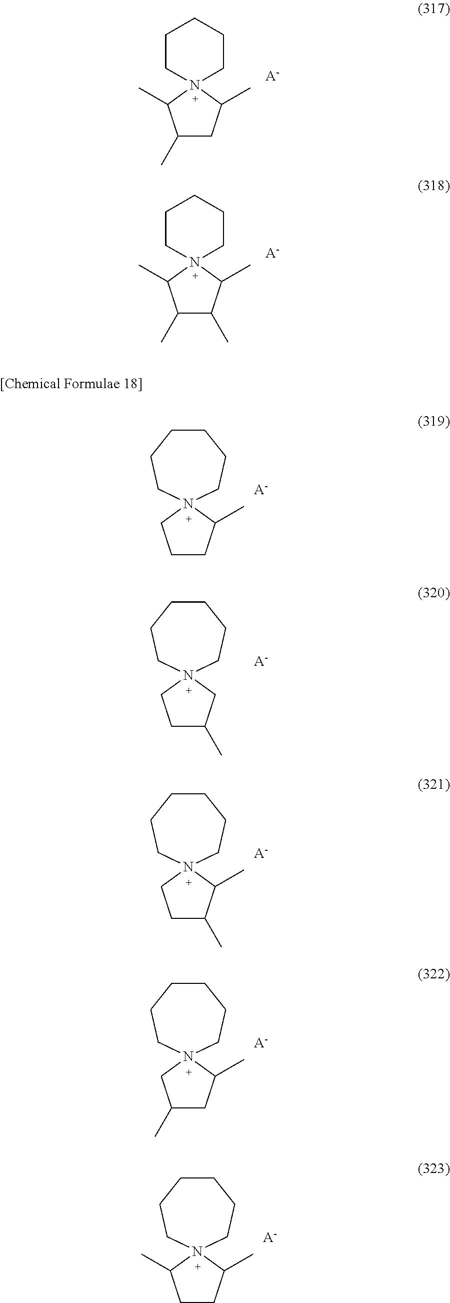

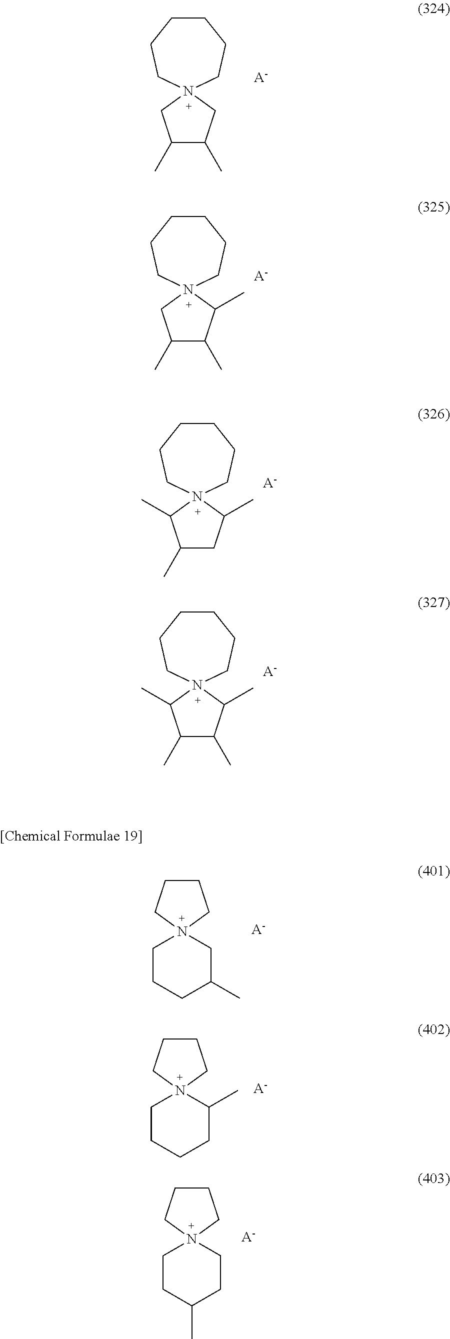

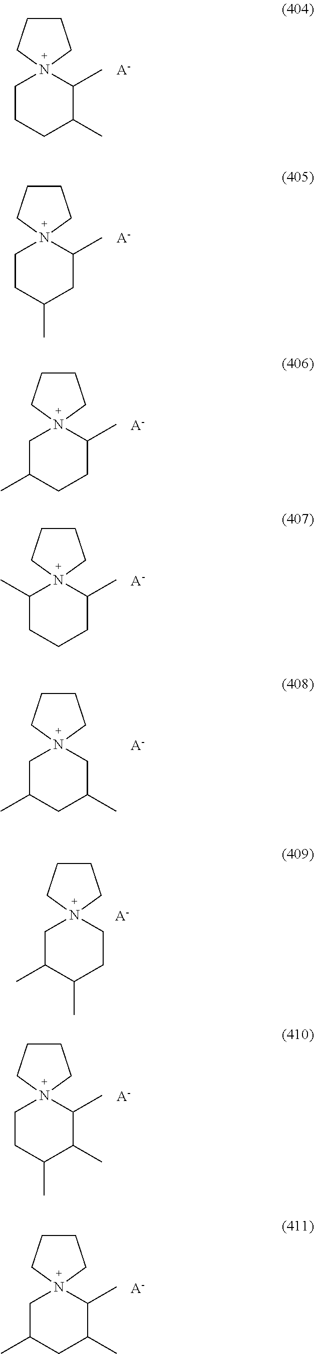

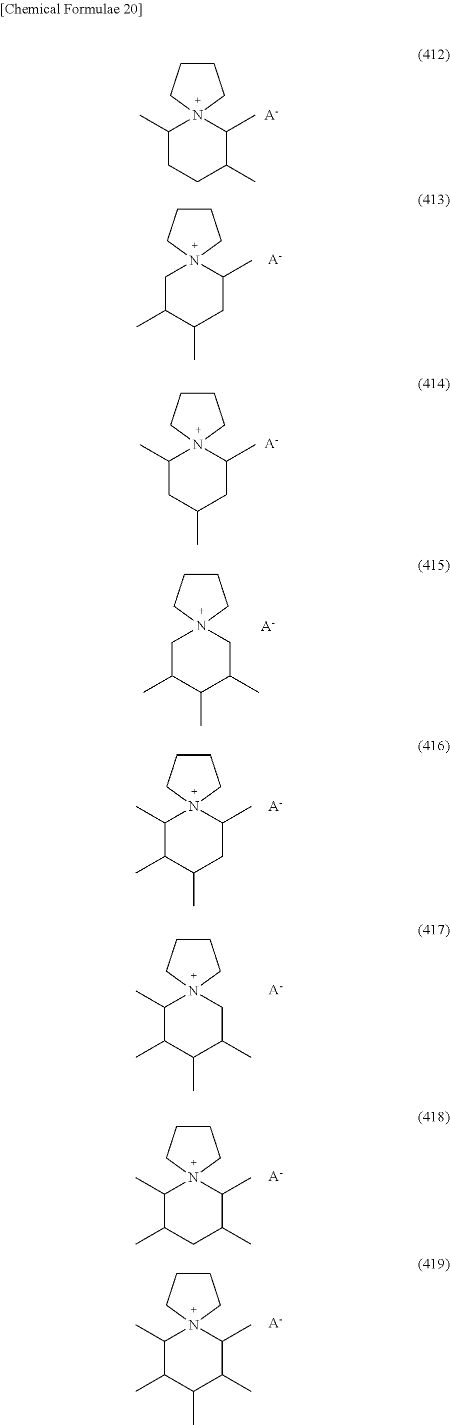

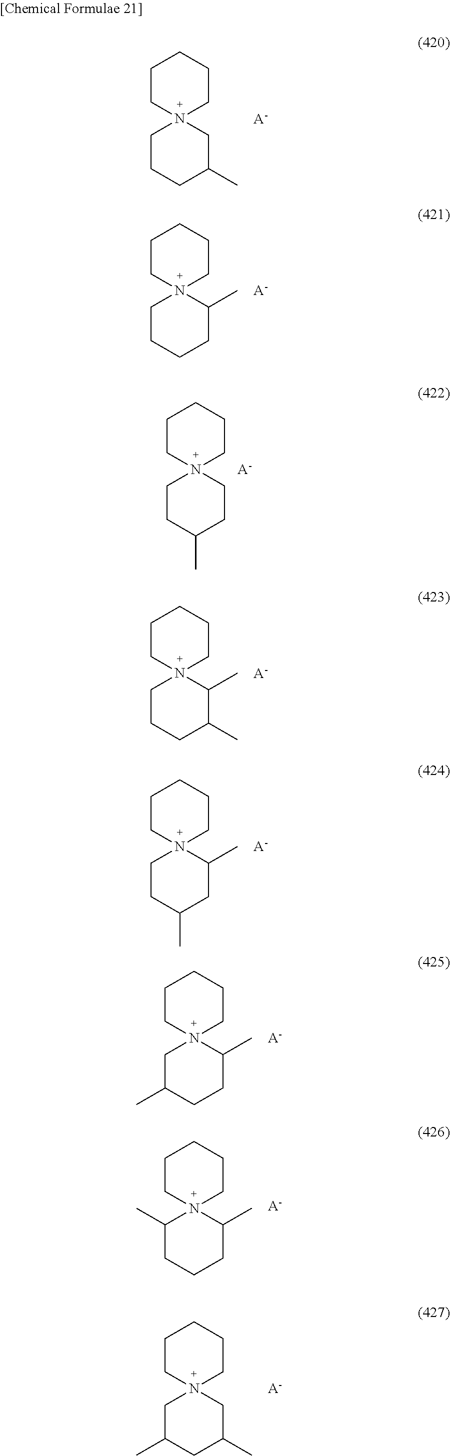

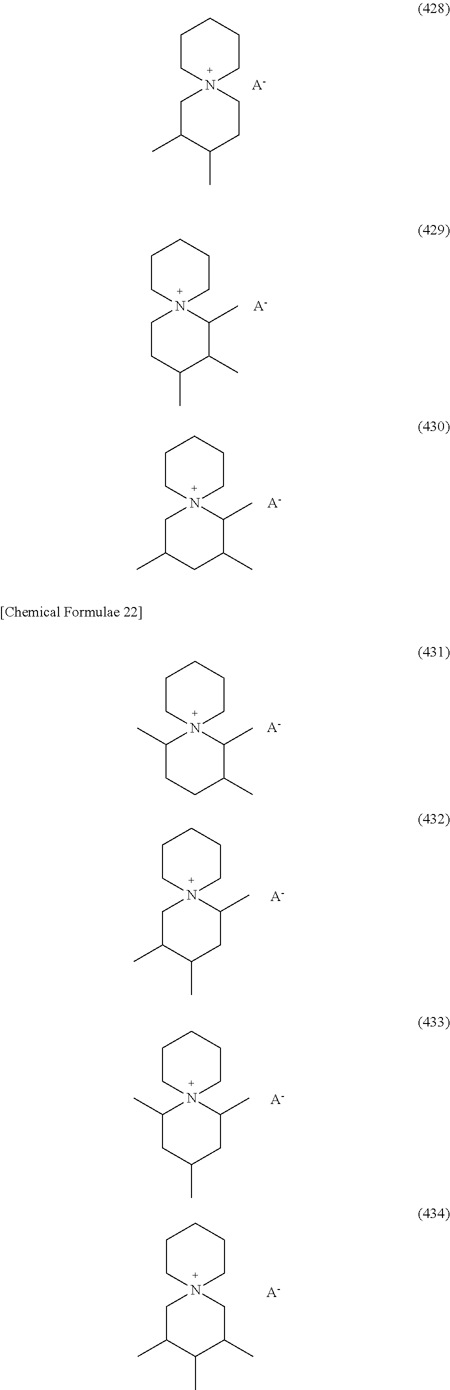

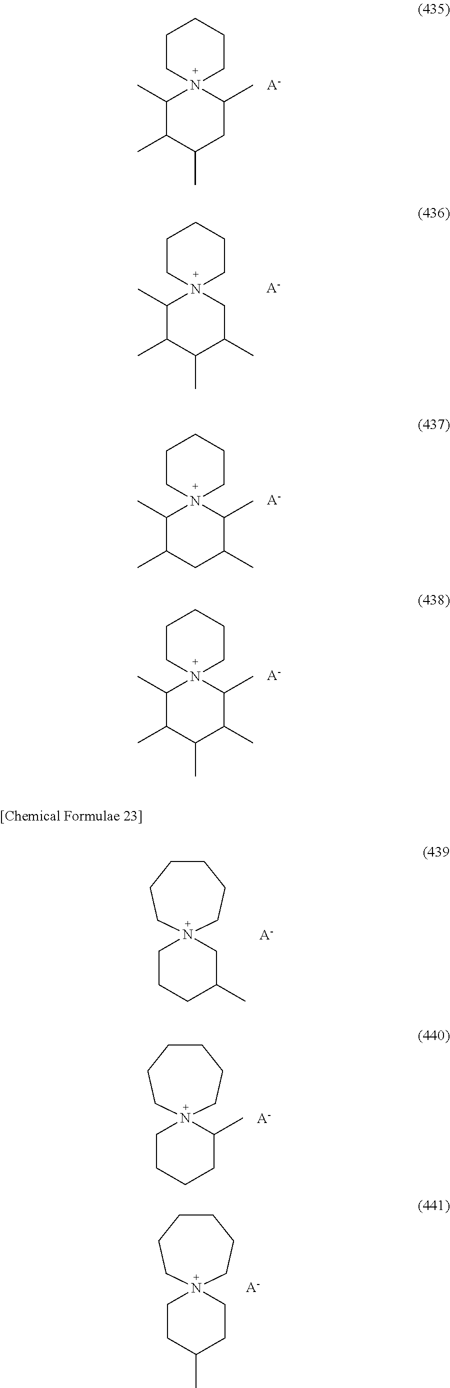

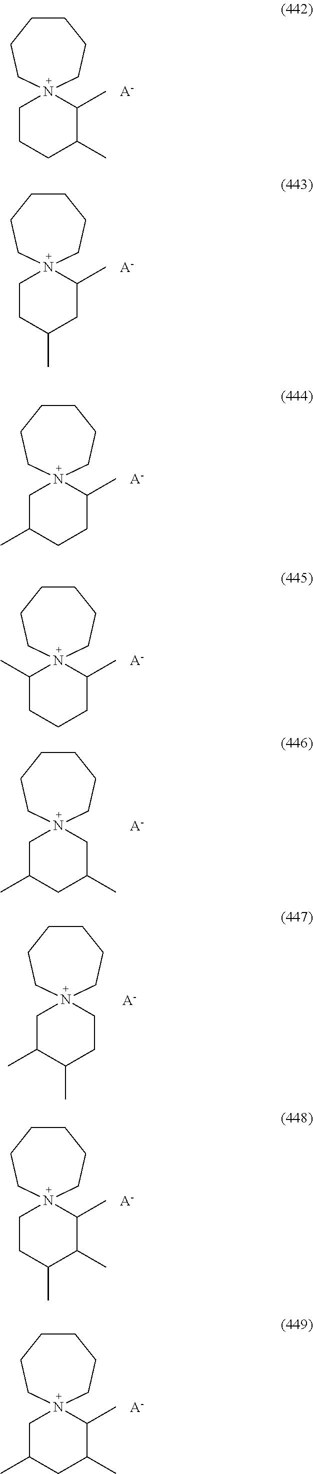

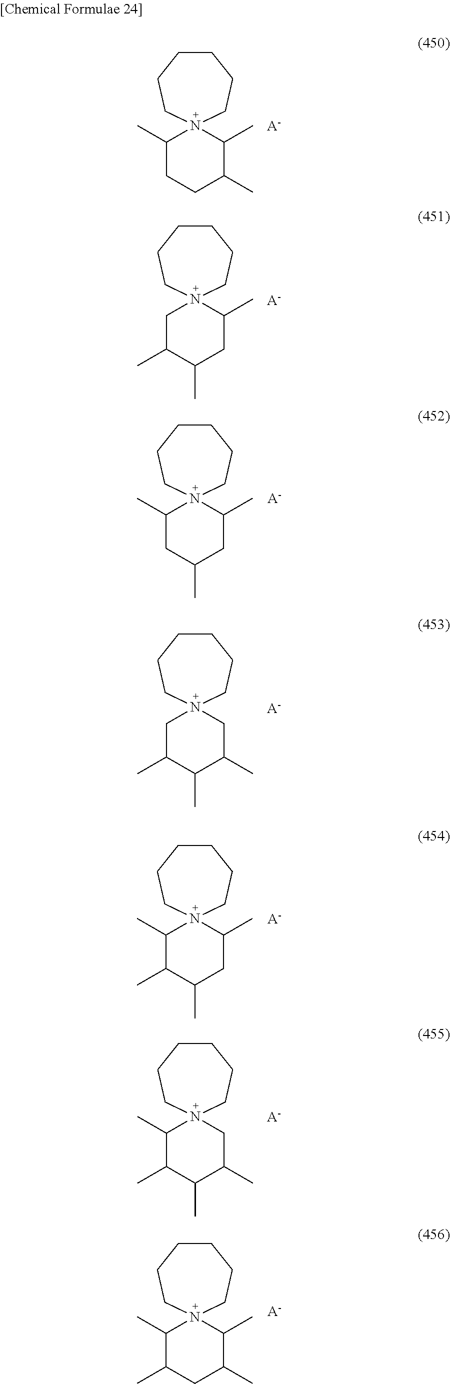

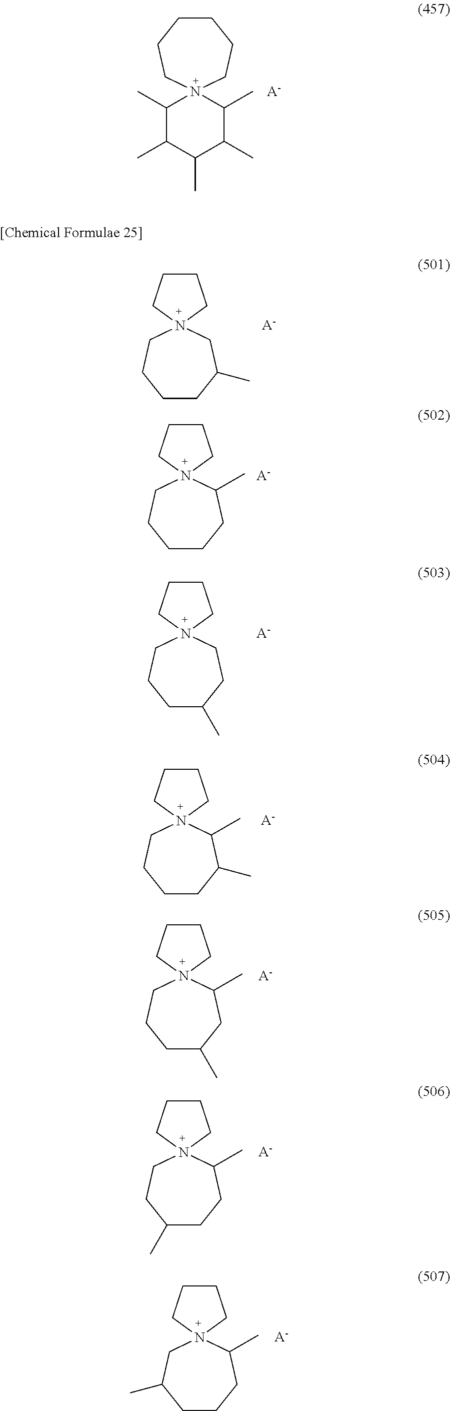

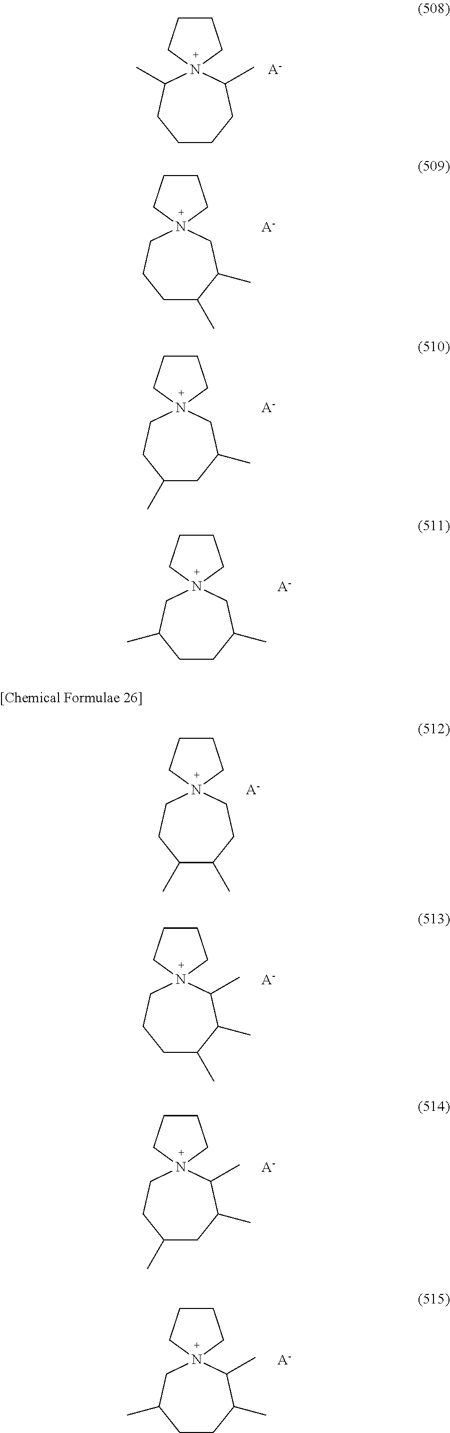

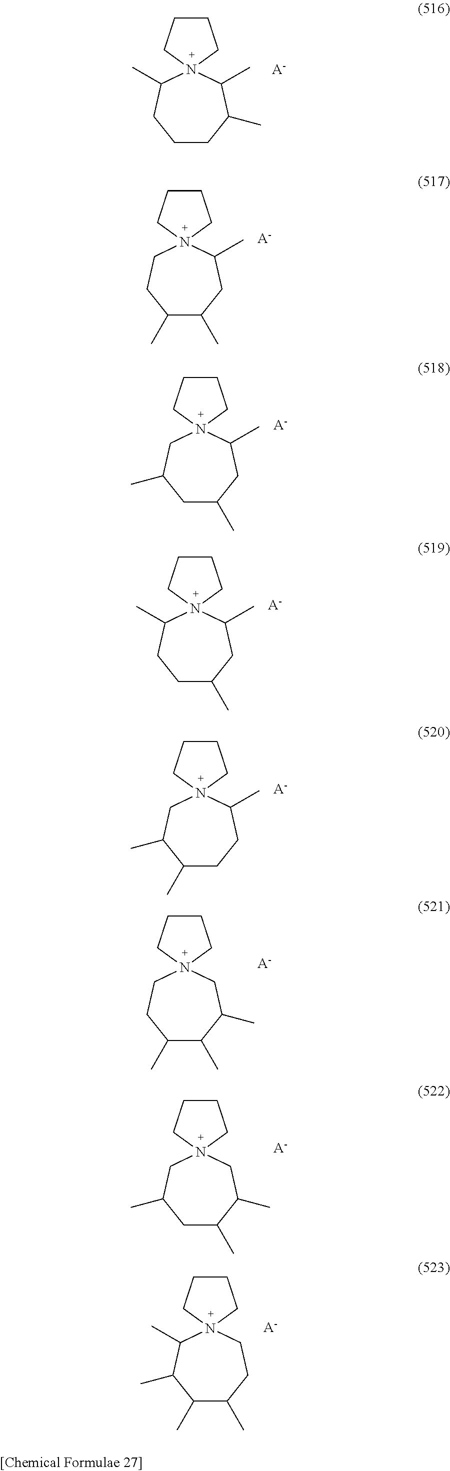

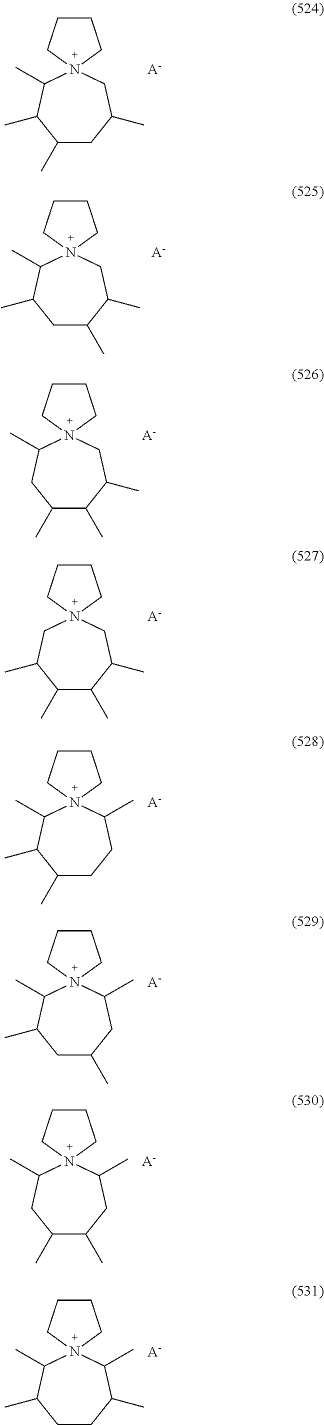

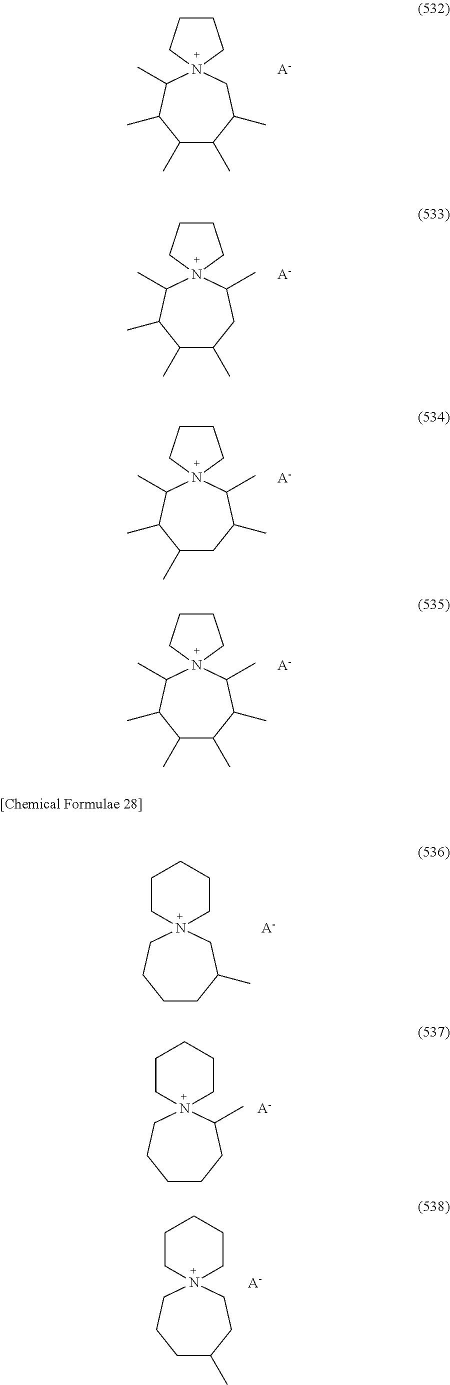

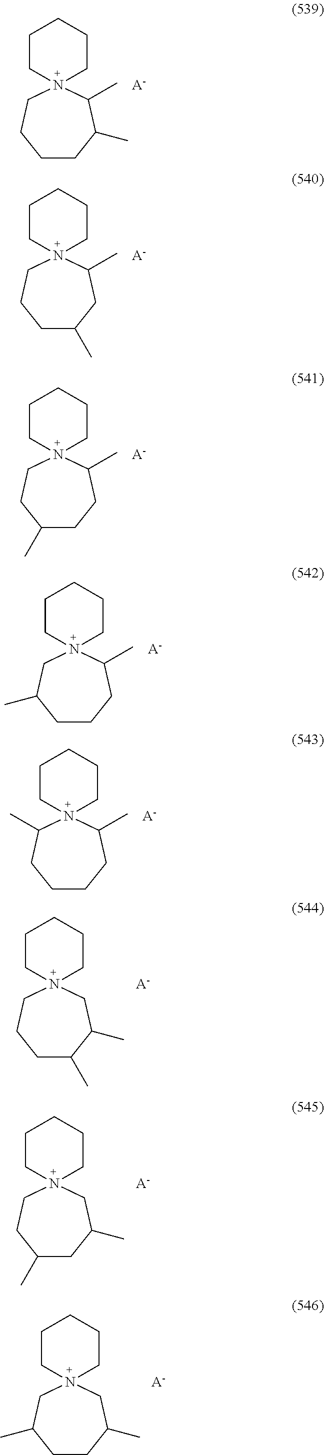

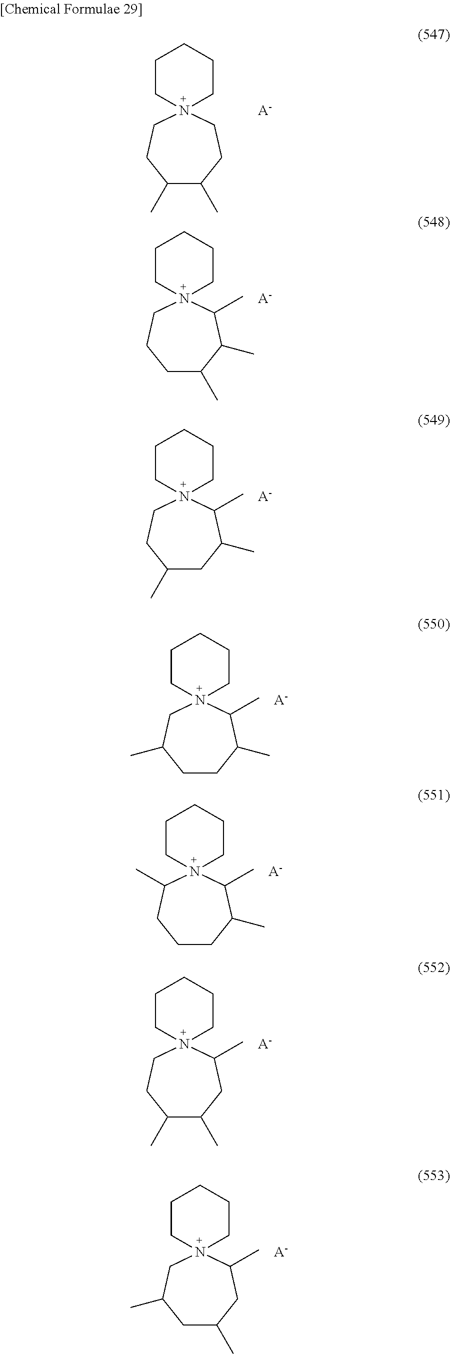

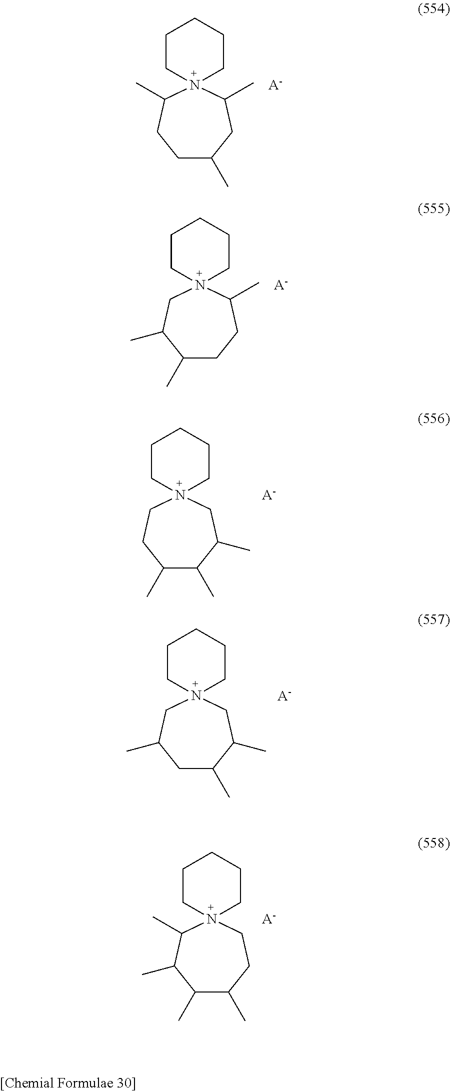

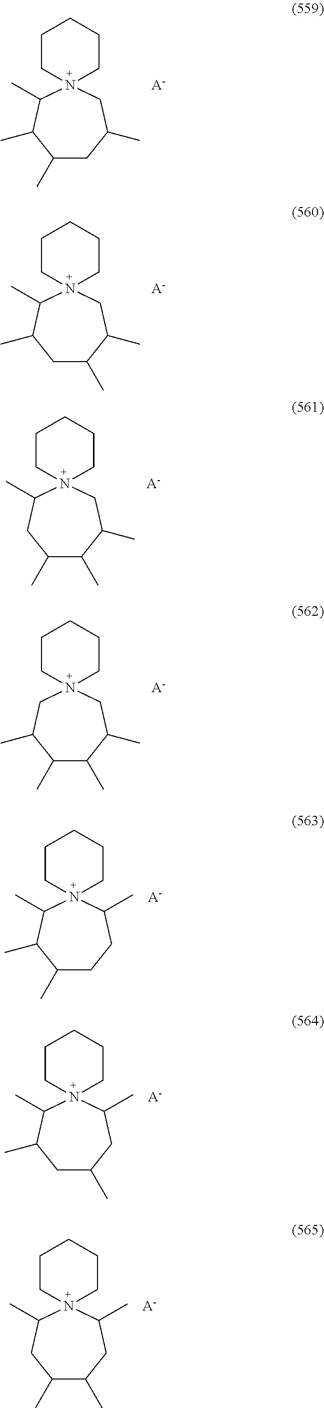

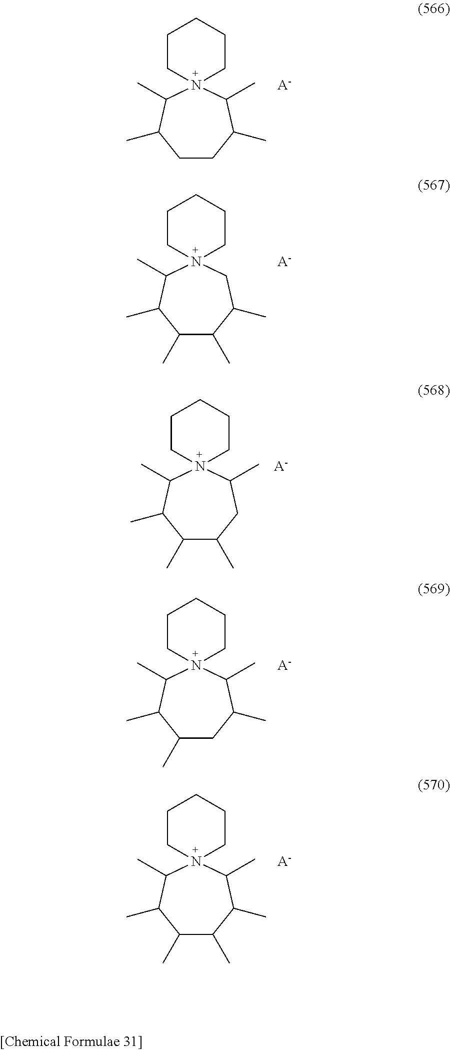

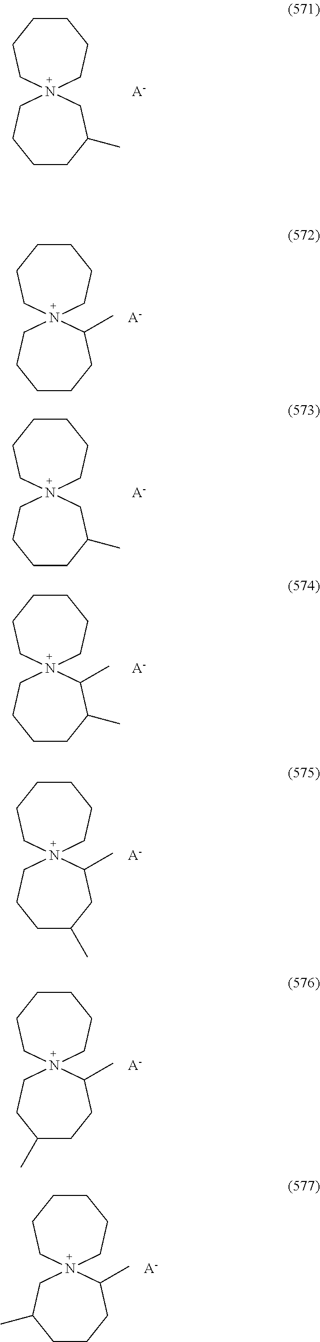

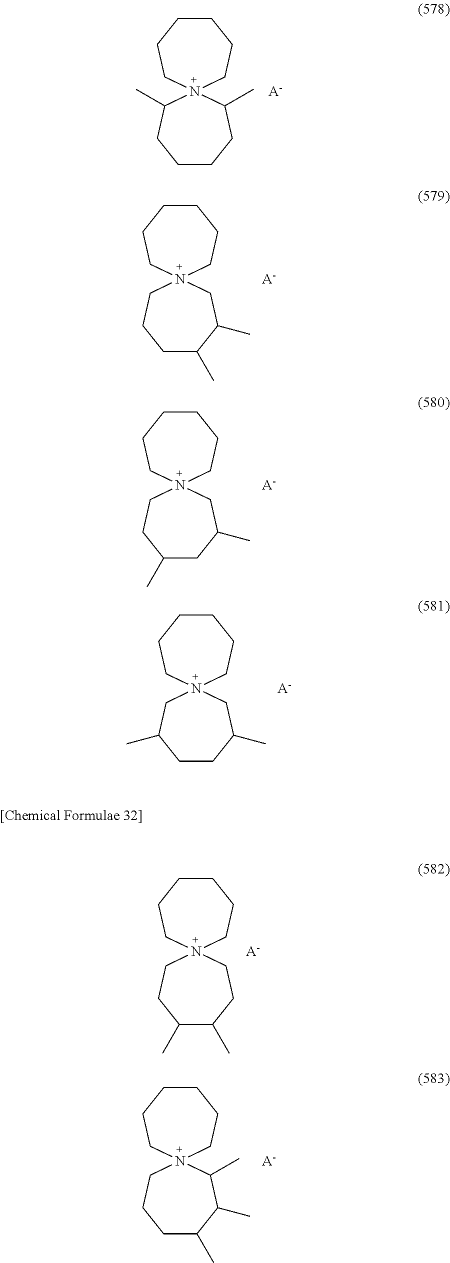

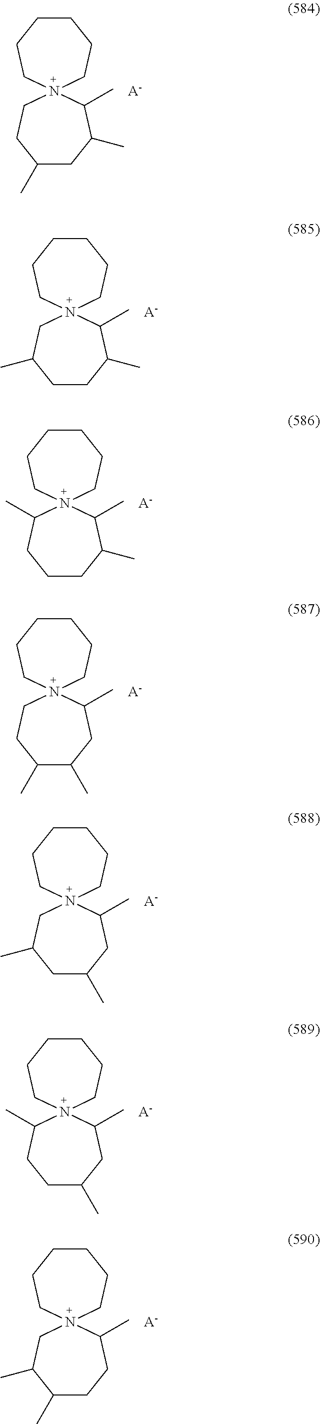

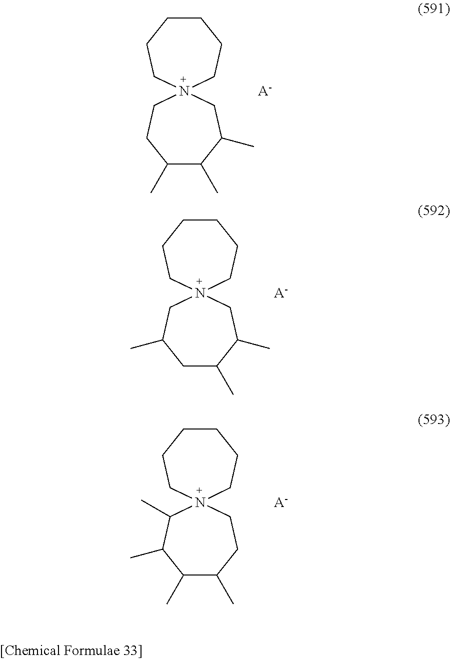

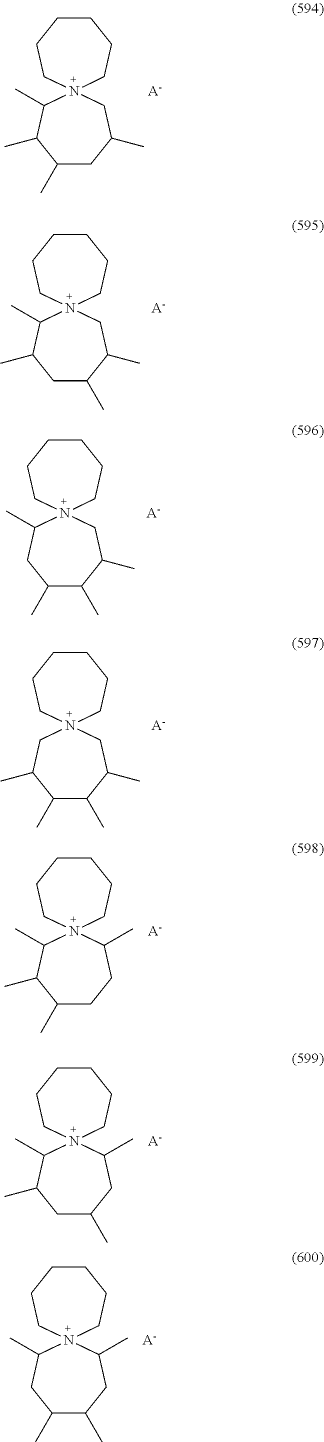

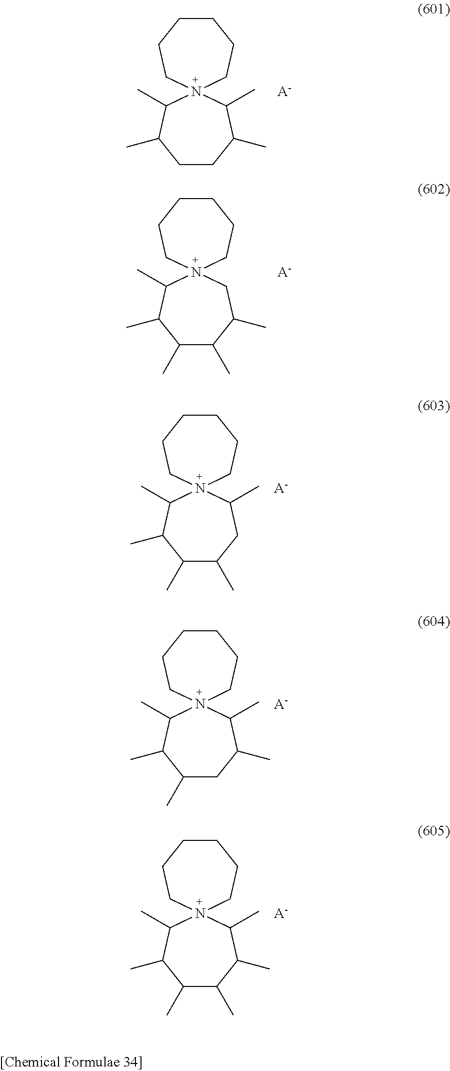

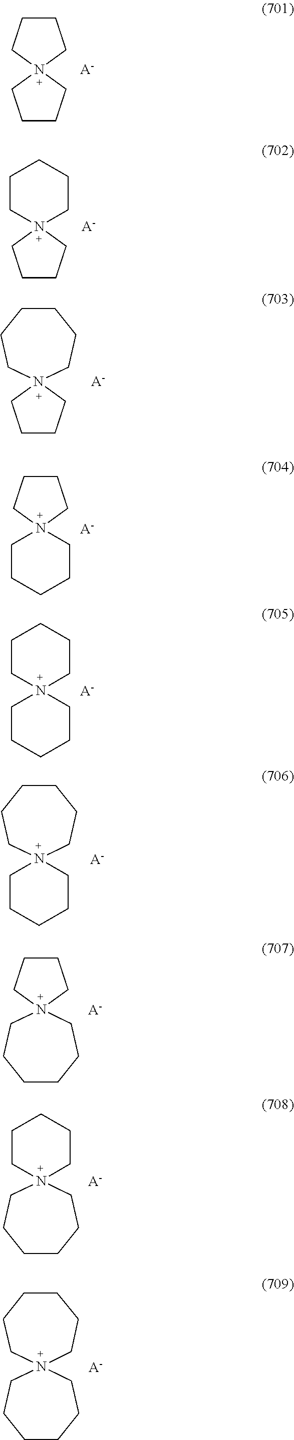

Examples of the anion in Structural Formulae (101) to (120), Structural Formulae (201) to (230), Structural Formulae (301) to (327), Structural Formulae (401) to (457), Structural Formulae (501) to (605), and Structural Formulae (701) to (709) are a monovalent amide-based anion, a monovalent methide-based anion, a fluorosulfonate anion (SO₃F⁻), a perfluoroalkylsulfonate anion, tetrafluoroborate (BF₄⁻), perfluoroalkylborate, hexafluorophosphate (PF₆⁻), and perfluoroalkylphosphate. An example of a monovalent amide anion is (CₙF₂ₙ₊₁SO₂)₂N⁻ (n is greater than or equal to 0 and less than or equal to 3). An example of a monovalent cyclic amide anion is CF₂(CF₂SO₂)₂N⁻. An example of a monovalent methide anion is (CₙF₂ₙ₊₁SO₂)₃C⁻ (n is greater than or equal to 0 and less than or equal to 3). An example of a monovalent cyclic methide anion is CF₂(CF₂SO₂)₂C⁻(CF₃SO₂). An example of the perfluoroalkylsulfonate anion is (CₘF₂ₘ₊₁SO₃)⁻ (m is greater than or equal to 0 and less than or equal to 4). An example of perfluoroalkylborate is _{{BF}ₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m). An example of perfluoroalkylphosphate is {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m). Note that the anion is not limited to these examples.

In the power storage device of one embodiment of the present invention, the ionic liquid may be a stereoisomer of any of the ionic liquids represented by Structural Formulae (101) to (120), Structural Formulae (201) to (230), Structural Formulae (301) to (327), Structural Formulae (401) to (457), Structural Formulae (501) to (605), and Structural Formulae (701) to (709). Isomers are different compounds with the same molecular formula. Stereoisomers are a particular kind of isomers in which only the spatial orientation differs but coupling of atoms is the same. Thus, in this specification and the like, the term “stereoisomers” includes enantiomers, geometric (cis-trans) isomers, and diastereomers which are isomers that have two or more chiral centers and are not enatiomers.

As the ionic liquid, an ionic liquid composed of an aromatic cation and a monovalent anion can be used, for example. Examples of the aromatic cation are an imidazolium cation and a pyridinium cation. Examples of the monovalent anion are a monovalent amide-based anion, a monovalent methide-based anion, a fluorosulfonate anion (SO₃F⁻), a perfluoroalkylsulfonate anion, tetrafluoroborate (BF₄⁻), perfluoroalkylborate, hexafluorophosphate (PF₆⁻), and perfluoroalkylphosphate. An example of a monovalent amide anion is (CₙF₂ₙ₊₁SO₂)₂N⁻ (n is greater than or equal to 0 and less than or equal to 3). An example of a monovalent cyclic amide anion is CF₂(CF₂SO₂)₂N⁻. An example of a monovalent methide anion is (CₙF₂ₙ₊₁SO₂)₃C⁻ (n is greater than or equal to 0 and less than or equal to 3). An example of a monovalent cyclic methide anion is CF₂(CF₂SO₂)₂C⁻(CF₃SO₂). An example of the perfluoroalkylsulfonate anion is (CₘF₂ₘ₊₁SO₃)⁻ (m is greater than or equal to 0 and less than or equal to 4). An example of perfluoroalkylborate is {BFₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m). An example of perfluoroalkylphosphate is {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m). Note that the anion is not limited to these examples.

When the ionic liquid has low reduction resistance and a low potential negative electrode material such as graphite or silicon is used for the negative electrode, the ionic liquid is reduced, which leads to an increase in initial irreversible capacity. An ionic liquid including an aliphatic quaternary ammonium cation has high reduction resistance; therefore, a low potential negative electrode material such as graphite or silicon can be favorably used. However, even in the case where the aliphatic quaternary ammonium cation is used for the ionic liquid, there is still a demand for a further reduction in initial irreversible capacity.

In the formation of an electrode paste for an electrode including a water-soluble polymer, an active material and the water-soluble polymer can be uniformly dispersed. At this time, the water-soluble polymer and another binder (if any) can cover an active material surface. Thus, further suppression of decomposition of the electrolyte solution can be expected. In particular, in the case where a material having a layered structure, such as graphite, is used, it can be expected that the use of the water-soluble polymer can prevent the cation of the ionic liquid from being inserted between graphite layers.

As shown in Structural Formulae (101) to (120), Structural Formulae (201) to (230), Structural Formulae (301) to (327), Structural Formulae (401) to (457), and Structural Formulae (501) to (605), introduction of a substituent to the quaternary ammonium cation can decrease the degree of symmetry of the molecule. This lowers the melting point of the ionic liquid. For example, introduction of a methyl group to a pyrrolidine skeleton decreases the melting point to −10° C. or lower, preferably −30° C. or lower. At a temperature lower than or equal to the melting point of the ionic liquid, an increase in resistance due to solidification of the ionic liquid can be suppressed. The use of an electrolyte solution including such an ionic liquid enables a power storage device to operate favorably even in a low temperature environment.

This embodiment can be implemented in combination with any of the other embodiments as appropriate.

### Embodiment 3

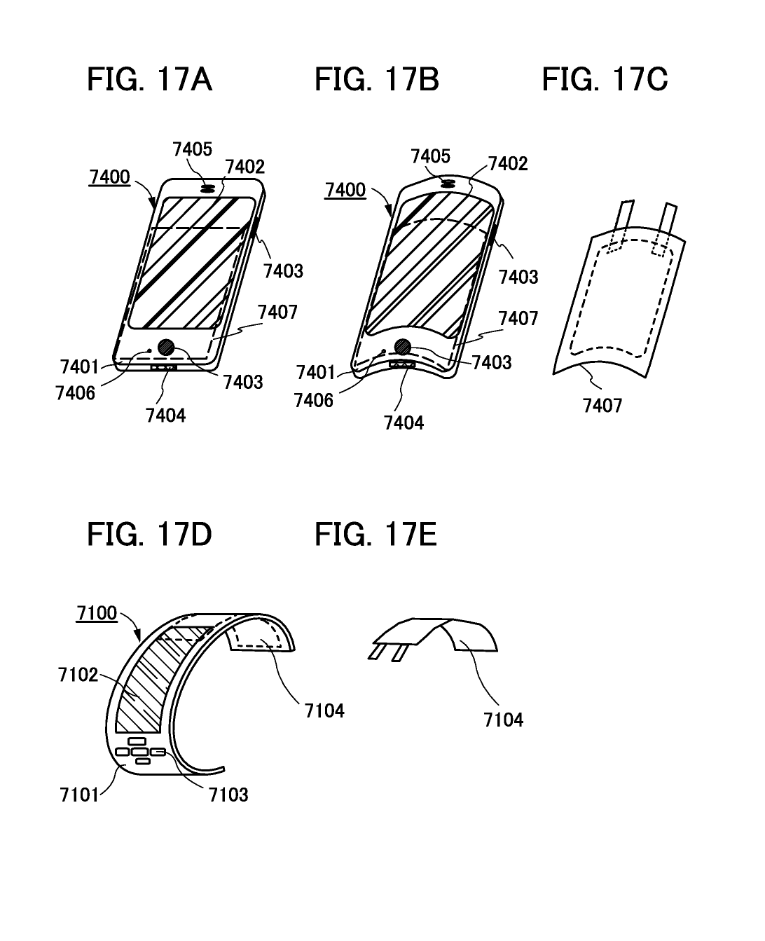

In this embodiment, examples of an electronic device including the laminated storage battery described in Embodiment 1 as a flexible laminated storage battery are described with reference to FIGS. 17A to 17E. Examples of the electronic device including a flexible power storage device are television devices (also referred to as televisions or television receivers), monitors of computers or the like, cameras such as digital cameras and digital video cameras, digital photo frames, mobile phones (also referred to as cellular phones or mobile phone devices), portable game machines, portable information terminals, audio reproduction devices, and large game machines such as pachinko machines.

In addition, the flexible power storage device can be incorporated along a curved inside/outside wall surface of a house or a building or a curved interior/exterior surface of a car.

FIG. 17A illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a power storage device 7407.

The mobile phone 7400 illustrated in FIG. 17B is bent. When the whole mobile phone 7400 is bent by external force, the power storage device 7407 included in the mobile phone 7400 is also bent. FIG. 17C illustrates the bent power storage device 7407. The power storage device 7407 is a laminated storage battery.

FIG. 17D illustrates an example of a bangle display device. A portable display device 7100 includes a housing 7101, a display portion 7102, an operation button 7103, and a power storage device 7104. FIG. 17E illustrates the bent power storage device 7104.

This embodiment can be implemented in combination with any of the other embodiments as appropriate.

### Embodiment 4

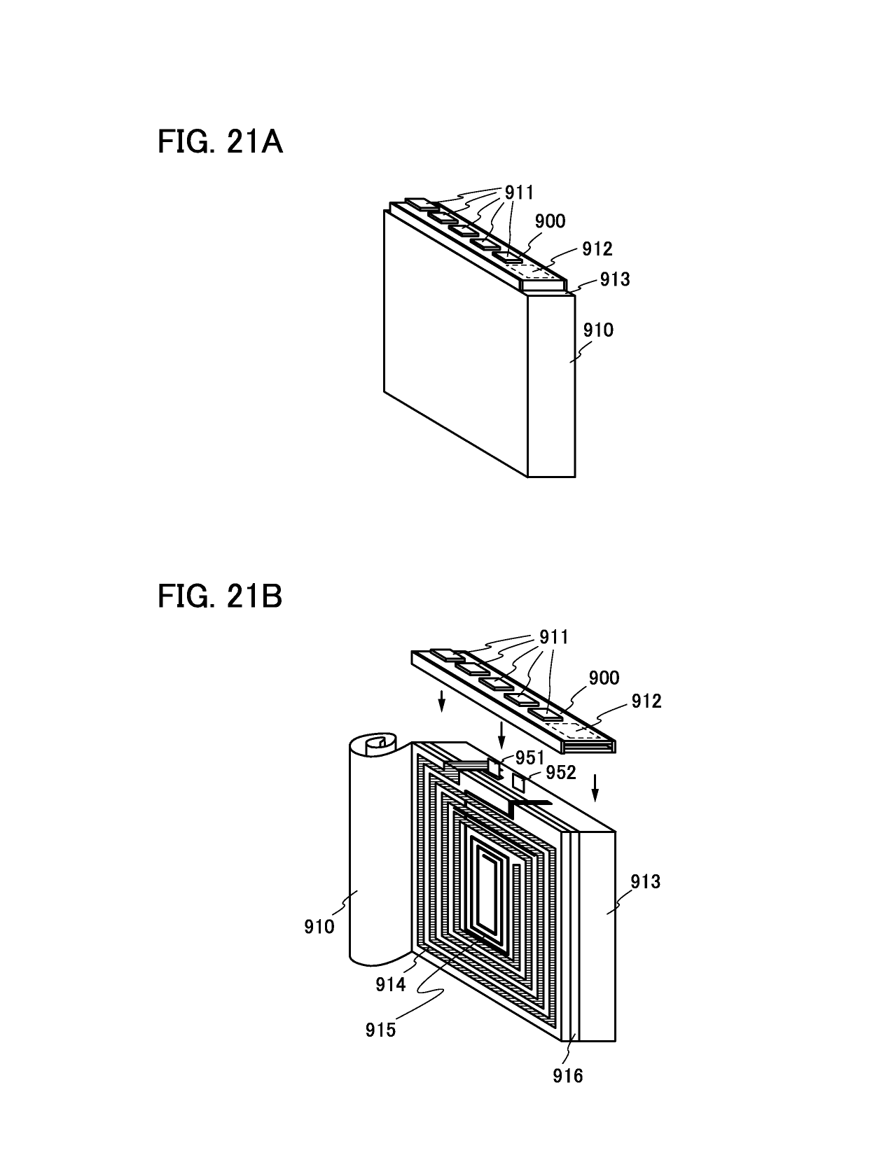

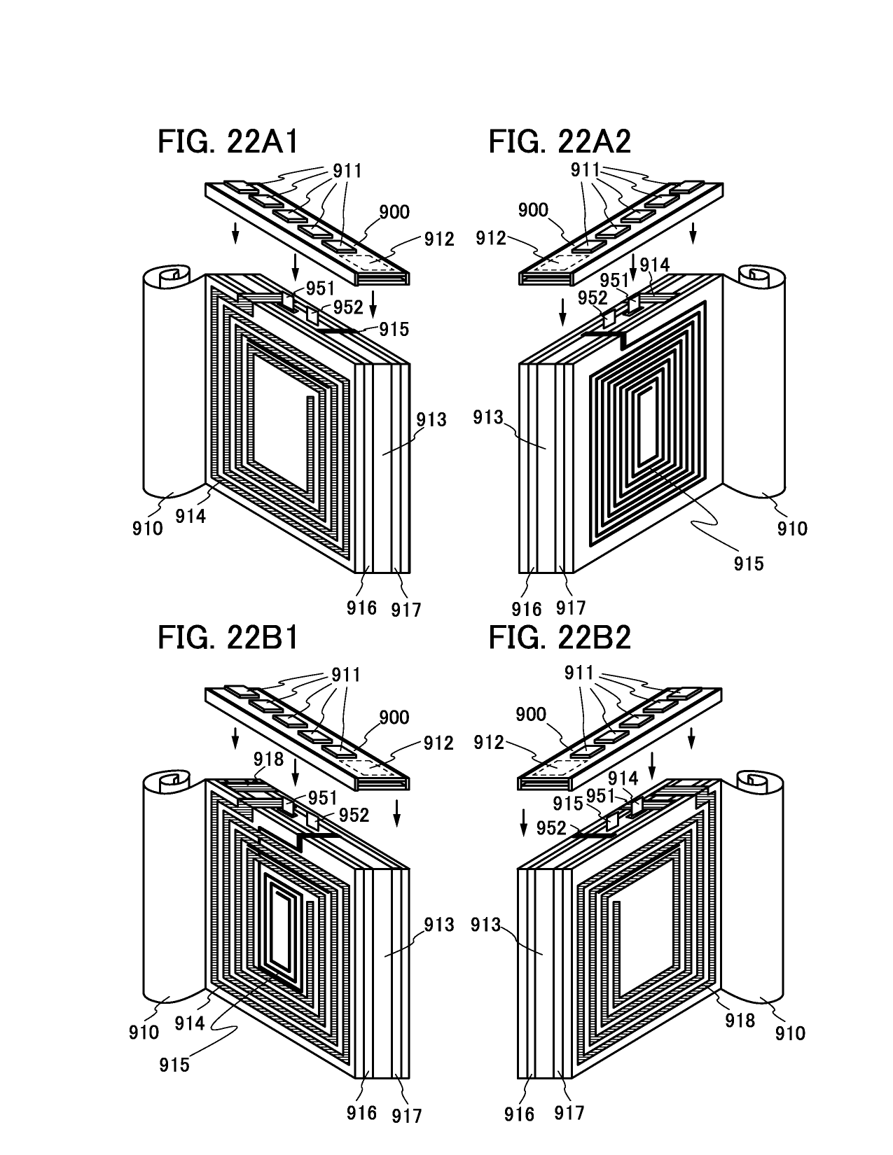

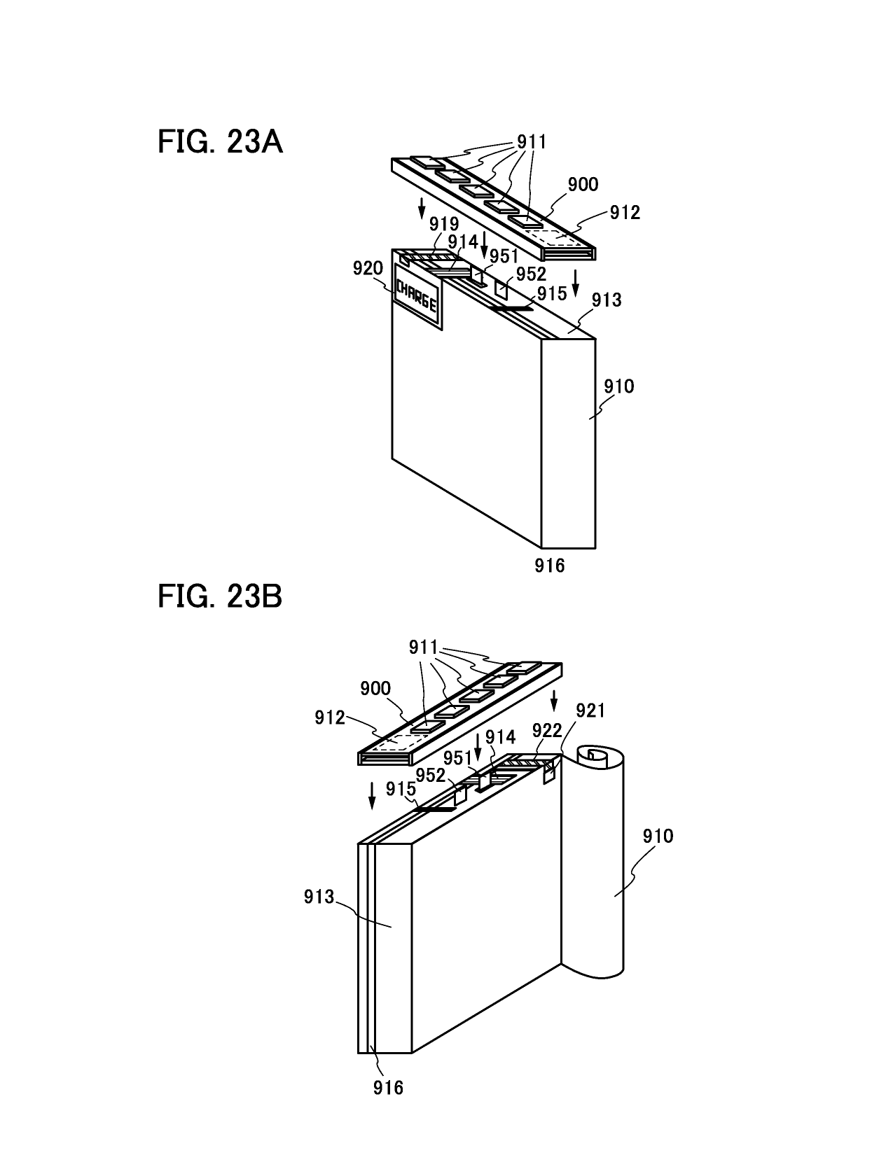

Structural examples of a power storage system are described with reference to FIGS. 21A and 21B, FIGS. 22A1, 22A2, 22B1, and 22B2, FIGS. 23A and 23B, FIGS. 24A and 24B, and FIG. 25.

FIGS. 21A and 21B show external views of a power storage system. The power storage system includes a circuit board 900 and a power storage device 913. A label 910 is attached to the power storage device 913. As illustrated in FIG. 21B, the power storage system further includes a terminal 951, a terminal 952, and an antenna 914 and an antenna 915 which are provided behind the label 910.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. Note that the shape of the antennas 914 and 915 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 914 or the antenna 915 may be a flat-plate conductor. The flat-plate conductor can serve as one of conductors for electric field coupling. That is, the antenna 914 or the antenna 915 may serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage system includes a layer 916 between the power storage device 913 and the antennas 914 and 915. The layer 916 has a function of blocking an electromagnetic field from the power storage device 913, for example. As the layer 916, for example, a magnetic body can be used. The layer 916 may serve as a shielding layer.

Note that the structure of the power storage system is not limited to that in FIGS. 21A and 21B.

For example, as illustrated in FIGS. 22A1 and 22A2, two opposite sides of the power storage device 913 in FIGS. 21A and 21B may be provided with the respective antennas. FIG. 22A1 is an external view showing one of the opposite sides, and FIG. 22A2 is an external view showing the other of the opposite sides. Note that for the same portions as the power storage system in FIGS. 21A and 21B, description on the power storage system in FIGS. 21A and 21B can be referred to as appropriate.

As illustrated in FIG. 22A1, the antenna 914 is provided on one of the opposite sides of the power storage device 913 with the layer 916 provided therebetween, and as illustrated in FIG. 22A2, the antenna 915 is provided on the other of the opposite sides of the power storage device 913 with a layer 917 provided therebetween. The layer 917 has a function of blocking an electromagnetic field from the power storage device 913, for example. As the layer 917, for example, a magnetic body can be used. The layer 917 may serve as a shielding layer.

With the above structure, both the antenna 914 and the antenna 915 can be increased in size.

Alternatively, as illustrated in FIGS. 22B1 and 22B2, two opposite sides of the power storage device 913 in FIGS. 21A and 21B may be provided with different types of antennas. FIG. 22B1 is an external view showing one of the opposite sides, and FIG. 22B2 is an external view showing the other of the opposite sides. Note that for the same portions as the power storage system in FIGS. 21A and 21B, description on the power storage system in FIGS. 21A and 21B can be referred to as appropriate.

As illustrated in FIG. 22B1, the antennas 914 and 915 are provided on one of the opposite sides of the power storage device 913 with the layer 916 provided therebetween, and as illustrated in FIG. 22B2, an antenna 918 is provided on the other of the opposite sides of the power storage device 913 with the layer 917 provided therebetween. The antenna 918 has a function of performing data communication with an external device, for example. An antenna with a shape that can be applied to the antennas 914 and 915 can be used as the antenna 918, for example. As an example of a method for communication between the power storage system and another device via the antenna 918, a response method that can be used between the power storage system and another device, such as NFC, can be employed.

Alternatively, as illustrated in FIG. 23A, the power storage device 913 in FIGS. 21A and 21B may be provided with a display device 920. The display device 920 is electrically connected to the terminal 911 via a terminal 919. It is possible that the label 910 is not provided in a portion where the display device 920 is provided. Note that for the same portions as the power storage system in FIGS. 21A and 21B, description on the power storage system in FIGS. 21A and 21B can be referred to as appropriate.

The display device 920 can display, for example, an image showing whether or not charging is being carried out or an image showing the amount of stored power. As the display device 920, electronic paper, a liquid crystal display device, an electroluminescent (EL) display device, or the like can be used. For example, the power consumption of the display device 920 can be reduced when electronic paper is used.

Alternatively, as illustrated in FIG. 23B, the power storage device 913 in FIGS. 21A and 21B may be provided with a sensor 921. The sensor 921 is electrically connected to the terminal 911 via a terminal 922. Note that the sensor 921 may be provided behind the label 910. Note that for the same portions as the power storage system in FIGS. 21A and 21B, description on the power storage system in FIGS. 21A and 21B can be referred to as appropriate.

The sensor 921 may have a function of measuring displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays, for example. With the sensor 921, for example, data on the environment (e.g., temperature) where the power storage system is placed can be acquired and stored in a memory in the circuit 912.

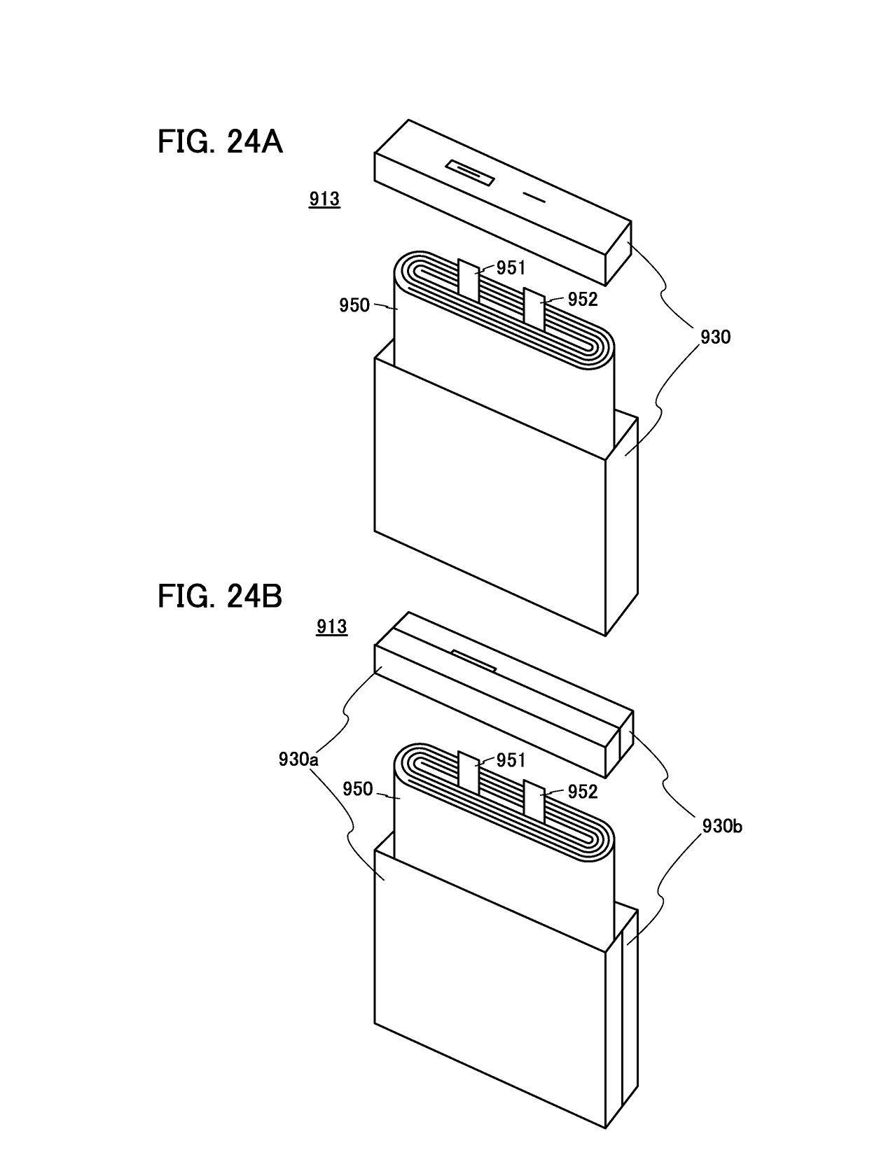

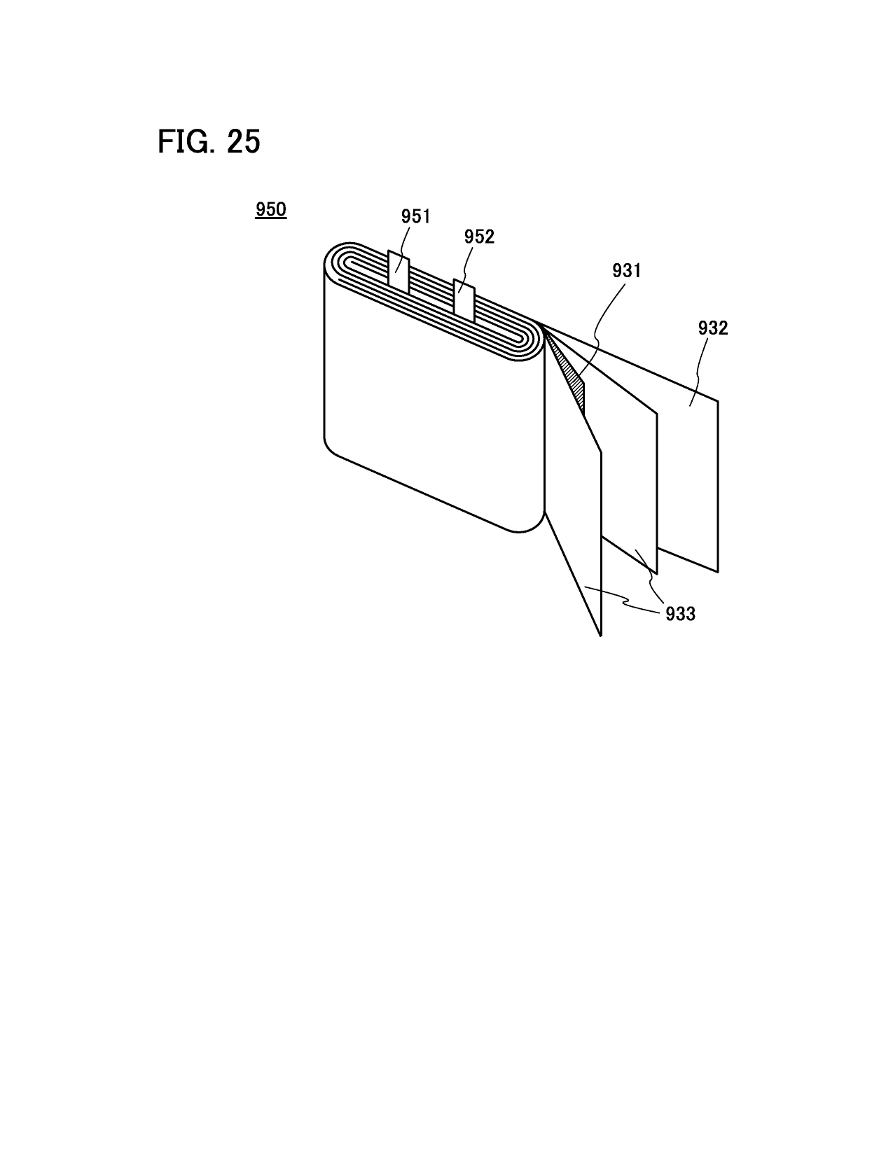

Further, structural examples of the power storage device 913 are described with reference to FIGS. 24A and 24B and FIG. 25.

In the power storage device 913 illustrated in FIG. 24A, a wound body 950 having the terminals 951 and 952 is provided in a housing 930. The wound body 950 is soaked in an electrolyte solution inside the housing 930. The terminal 952 is in contact with the housing 930. An insulator or the like prevents contact between the terminal 951 and the housing 930. Note that FIG. 24A illustrates the housing 930 divided into two pieces for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 24B, the housing 930 in FIG. 24A may be formed using a plurality of materials. For example, in the power storage device 913 in FIG. 24B, a housing 930a and a housing 930b are attached to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, an electric field can be prevented from being blocked by the power storage device 913. When an electric field is not significantly blocked by the housing 930a, an antenna such as the antenna 914 or the antenna 915 may be provided inside the housing 930. For the housing 930b, a metal material can be used, for example.

FIG. 25 shows a structure of the wound body 950. The wound body 950 includes a negative electrode 931, a positive electrode 932, and a separator 933. The wound body 950 is obtained by winding a sheet of a stack in which the negative electrode 931 overlaps with the positive electrode 932 with the separator 933 provided therebetween. Note that a plurality of sheets each including the negative electrode 931, the positive electrode 932, and the separator 933 may be stacked.

The negative electrode 931 is connected to the terminal 911 in FIGS. 21A and 21B via one of the terminals 951 and 952. The positive electrode 932 is connected to the terminal 911 in FIGS. 21A and 21B via the other of the terminals 951 and 952.

This embodiment can be implemented in combination with any of the other embodiments as appropriate.

### Embodiment 5

The power storage device of one embodiment of the present invention can be used as a power source of a variety of electric devices which are driven by electric power.

Specific examples of an electric device including the power storage device of one embodiment of the present invention are as follows: display devices such as televisions and monitors, lighting devices, desktop personal computers, laptop personal computers, word processors, image reproduction devices which reproduce still images and moving images stored in recording media such as digital versatile discs (DVDs), portable CD players, radios, tape recorders, headphone stereos, stereos, table clocks, wall clocks, cordless phone handsets, transceivers, mobile phones, car phones, portable game machines, calculators, portable information terminals, electronic notebooks, e-book readers, electronic translators, audio input devices, video cameras, digital still cameras, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers. electric refrigerators, electric freezers, electric refrigerator-freezers, freezers for preserving DNA, flashlights, electric power tools such as chain saws, smoke detectors, and medical equipment such as dialyzers. The examples also include industrial equipment such as guide lights, traffic lights, belt conveyors, elevators, escalators, industrial robots, power storage systems, and power storage devices for leveling the amount of power supply and smart grid. In addition, moving objects driven by electric motors using electric power from power storage devices are also included in the category of electric devices. Examples of the moving objects are electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In the above electric devices, the power storage device of one embodiment of the present invention can be used as a main power source for supplying enough electric power for almost the whole power consumption. Alternatively, in the above electric devices, the power storage device of one embodiment of the present invention can be used as an uninterruptible power source which can supply electric power to the electric devices when the supply of electric power from the main power source or a commercial power source is stopped. Still alternatively, in the above electric devices, the power storage device of one embodiment of the present invention can be used as an auxiliary power source for supplying electric power to the electric devices at the same time as the power supply from the main power source or a commercial power source.

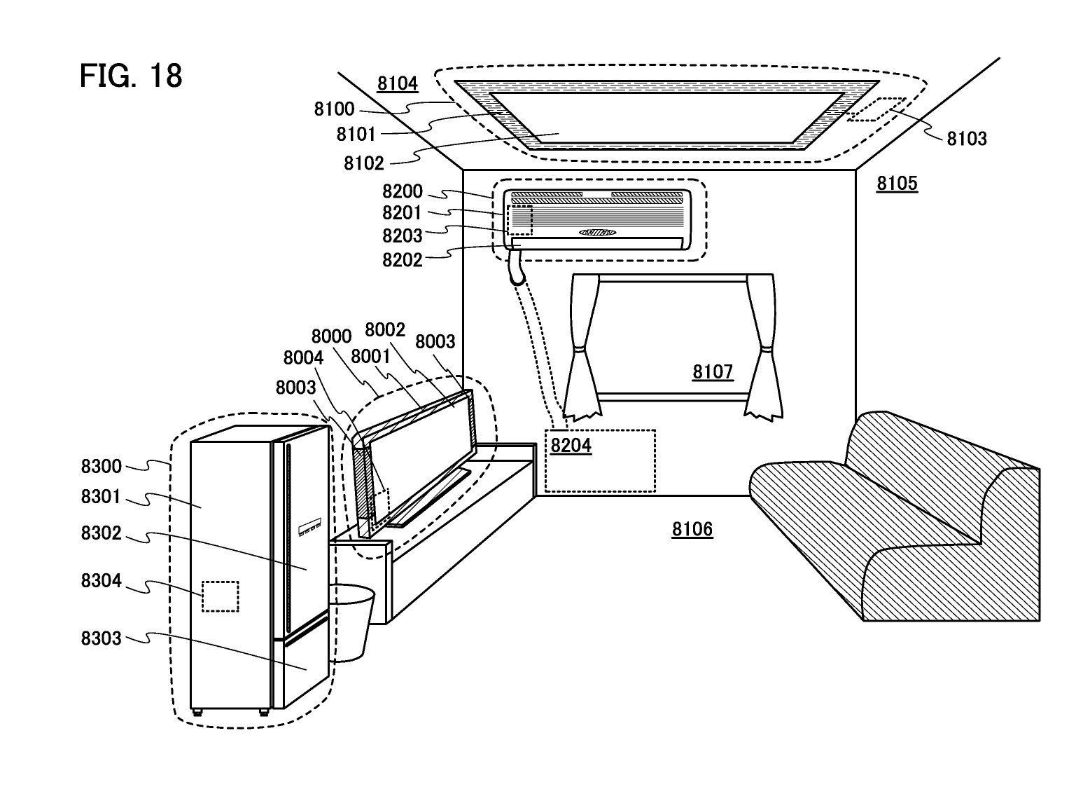

FIG. 18 illustrates specific structures of the electric devices. In FIG. 18, a display device 8000 is an example of an electric device including a power storage device 8004 of one embodiment of the present invention. Specifically, the display device 8000 corresponds to a display device for TV broadcast reception and includes a housing 8001, a display portion 8002, speaker portions 8003, the power storage device 8004, and the like. The power storage device 8004 of one embodiment of the present invention is provided in the housing 8001. The display device 8000 can receive electric power from a commercial power source or use electric power stored in the power storage device 8004. Thus, the display device 8000 can operate with the use of the power storage device 8004 of one embodiment of the present invention as an uninterruptible power source even when electric power cannot be supplied from a commercial power source because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all information display devices for personal computers, advertisement displays, and the like besides the ones for TV broadcast reception.

In FIG. 18, an installation lighting device 8100 is an example of an electric device including a power storage device 8103 of one embodiment of the present invention. Specifically, the lighting device 8100 includes a housing 8101, a light source 8102, the power storage device 8103, and the like. Although FIG. 18 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power source or use electric power stored in the power storage device 8103. Thus, the lighting device 8100 can operate with the use of the power storage device 8103 of one embodiment of the present invention as an uninterruptible power source even when electric power cannot be supplied from a commercial power source because of power failure or the like.

Note that although the installation lighting device 8100 provided in the ceiling 8104 is illustrated in FIG. 18 as an example, the power storage device of one embodiment of the present invention can be used in an installation lighting device provided in, for example, a wall 8105, a floor 8106, a window 8107, or the like besides the ceiling 8104. Alternatively, the power storage device can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 18, an air conditioner including an indoor unit 8200 and an outdoor unit 8204 is an example of an electric device including a power storage device 8203 of one embodiment of the present invention. Specifically, the indoor unit 8200 includes a housing 8201, an air outlet 8202, the power storage device 8203, and the like. Although FIG. 18 illustrates the case where the power storage device 8203 is provided in the indoor unit 8200, the power storage device 8203 may be provided in the outdoor unit 8204. Alternatively, the power storage device 8203 may be provided in both the indoor unit 8200 and the outdoor unit 8204. The air conditioner can receive electric power from a commercial power source or use electric power stored in the power storage device 8203. Particularly in the case where the power storage device 8203 is provided in both the indoor unit 8200 and the outdoor unit 8204, the air conditioner can operate with the use of the power storage device 8203 of one embodiment of the present invention as an uninterruptible power source even when electric power cannot be supplied from a commercial power source because of power failure or the like.

Note that although the split-type air conditioner including the indoor unit and the outdoor unit is illustrated in FIG. 18 as an example, the power storage device of one embodiment of the present invention can be used in an air conditioner in which the functions of an indoor unit and an outdoor unit are integrated in one housing.

In FIG. 18, an electric refrigerator-freezer 8300 is an example of an electric device including a power storage device 8304 of one embodiment of the present invention. Specifically, the electric refrigerator-freezer 8300 includes a housing 8301, a door for a refrigerator 8302, a door for a freezer 8303, the power storage device 8304, and the like. The power storage device 8304 is provided in the housing 8301 in FIG. 18. The electric refrigerator-freezer 8300 can receive electric power from a commercial power source or use electric power stored in the power storage device 8304. Thus, the electric refrigerator-freezer 8300 can operate with the use of the power storage device 8304 of one embodiment of the present invention as an uninterruptible power source even when electric power cannot be supplied from a commercial power source because of power failure or the like.

Note that among the electric devices described above, the high-frequency heating appliances such as microwave ovens, the electric rice cookers, and the like require high electric power in a short time. The tripping of a circuit breaker of a commercial power source in use of the electric devices can be prevented by using the power storage device of one embodiment of the present invention as an auxiliary power source for making up for the shortfall in electric power supplied from a commercial power source.

In addition, in a time period when electric devices are not used, specifically when the proportion of the amount of electric power which is actually used to the total amount of electric power which can be supplied from a commercial power source (such a proportion is referred to as power usage rate) is low, electric power can be stored in the power storage device, whereby the power usage rate can be reduced in a time period when the electric devices are used. For example, in the case of the electric refrigerator-freezer 8300, electric power can be stored in the power storage device 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the power storage device 8304 is used as an auxiliary power source; thus, the power usage rate in daytime can be reduced.

This embodiment can be implemented in combination with any of the other embodiments as appropriate.

### Embodiment 6

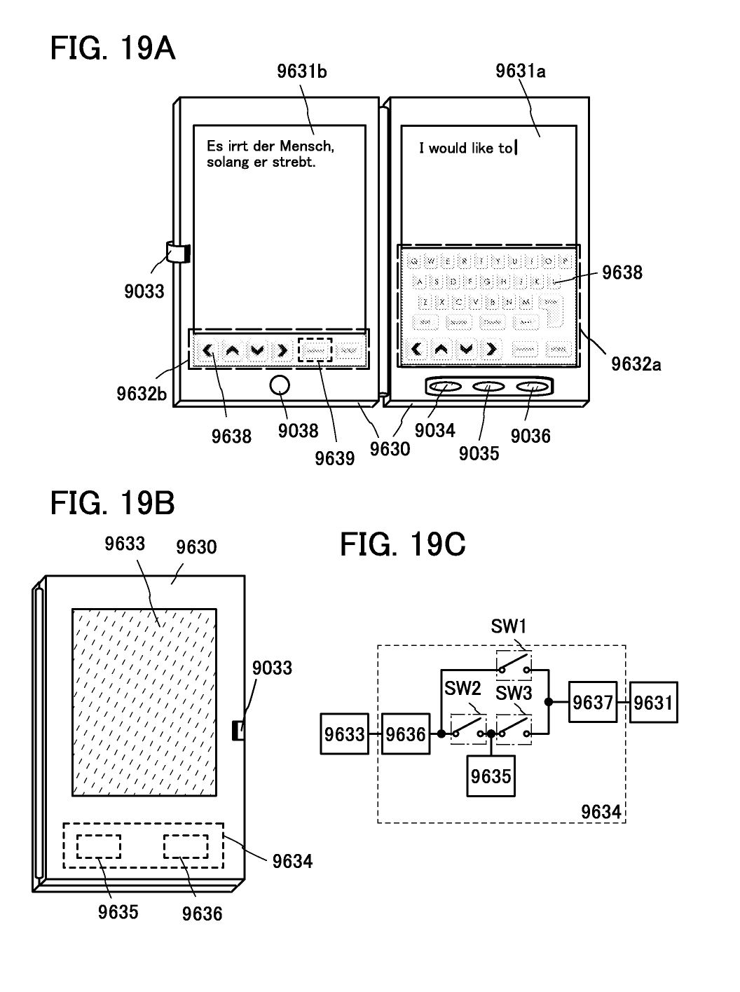

Next, a portable information terminal which is an example of an electric device is described with reference to FIGS. 19A to 19C.

FIGS. 19A and 19B illustrate a foldable tablet terminal. In FIG. 19A, the tablet terminal is open and includes a housing 9630, a display portion 9631a, a display portion 9631b, a switch 9034 for switching display modes, a power switch 9035, a switch 9036 for switching to power-saving mode, a clip 9033, and an operation switch 9038.

Part of the display portion 9631a can be a touch panel region 9632a, and data can be input by touching operation keys 9638 that are displayed. Note that FIG. 19A shows an example in which a half area of the display portion 9631a has only a display function and the other half area has a touch panel function. However, the structure of the display portion 9631a is not limited to this, and the entire area of the display portion 9631a may have a touch panel function. For example, the entire display portion 9631a can display keyboard buttons and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, keyboard buttons can be displayed on the display portion 9631b.

Touch input can be performed on the touch panel regions 9632a and 9632b at the same time.

With the switch 9034 for switching display modes, the display orientation can be switched (e.g., between landscape mode and portrait mode) and a display mode (e.g., monochrome display or color display) can be selected. With the switch 9036 for switching to power-saving mode, the luminance of display can be optimized in accordance with the amount of external light in use, which is sensed with an optical sensor incorporated in the tablet terminal. The tablet terminal may include another detection device such as a sensor for determining inclination (e.g., a gyroscope or an acceleration sensor) in addition to the optical sensor.

Note that FIG. 19A illustrates an example in which the display portion 9631a and the display portion 9631b have the same display area; however, one embodiment of the present invention is not limited to this example. One of the display portions may be different from the other display portion in size and display quality. For example, one of them may be a display panel that can display higher-definition images than the other.

In FIG. 19B, the tablet terminal is folded and includes the housing 9630, a solar cell 9633, a charge and discharge control circuit 9634, a battery 9635, and a DCDC converter 9636. Note that FIG. 19B illustrates an example in which the charge and discharge control circuit 9634 includes the battery 9635 and the DCDC converter 9636. The power storage device described in the above embodiment is used as the battery 9635.

Since the tablet terminal is foldable, the housing 9630 can be closed when the tablet terminal is not used. Thus, the display portions 9631a and 9631b can be protected, which can provide the tablet terminal with excellent endurance and high reliability for long-term use.

The tablet terminal in FIGS. 19A and 19B can have other functions such as a function of displaying various kinds of data (e.g., a still image, a moving image, and a text image), a function of displaying a calendar, a date, the time, or the like on the display portion, a touch-input function of operating or editing the data displayed on the display portion by touch input, and a function of controlling processing by various kinds of software (programs).

The solar cell 9633, which is attached on a surface of the tablet terminal, can supply electric power to a touch panel, a display portion, an image signal processor, and the like. Note that the solar cell 9633 can be provided on one or both surfaces of the housing 9630 and the battery 9635 can be charged efficiently. The use of the power storage device of one embodiment of the present invention as the battery 9635 brings an advantage such as a reduction in size.

The structure and operation of the charge and discharge control circuit 9634 in FIG. 19B are described with reference to a block diagram in FIG. 19C. The solar cell 9633, the battery 9635, the DCDC converter 9636, a converter 9637, switches SW1 to SW3, and the display portion 9631 are illustrated in FIG. 19C, and the battery 9635, the DCDC converter 9636, the converter 9637, and the switches SW1 to SW3 correspond to the charge and discharge control circuit 9634 in FIG. 19B.

First, an example of the operation in the case where electric power is generated by the solar cell 9633 using external light is described. The voltage of electric power generated by the solar cell is raised or lowered by the DCDC converter 9636 to a voltage for charging the battery 9635. Then, when the electric power from the solar cell 9633 is used for the operation of the display portion 9631, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the battery 9635 can be charged.

Note that the solar cell 9633 is described as an example of a power generation means; however, one embodiment of the present invention is not limited to this example. The battery 9635 may be charged using another power generation means such as a piezoelectric element or a thermoelectric conversion element (Peltier element). For example, the battery 9635 may be charged using a non-contact power transmission module that transmits and receives electric power wirelessly (without contact) or using another charging means in combination.

Needless to say, one embodiment of the present invention is not limited to the electric device in FIGS. 19A to 19C as long as the electric device is equipped with the power storage device described in the above embodiment.

This embodiment can be implemented in combination with any of the other embodiments as appropriate.

### Embodiment 7

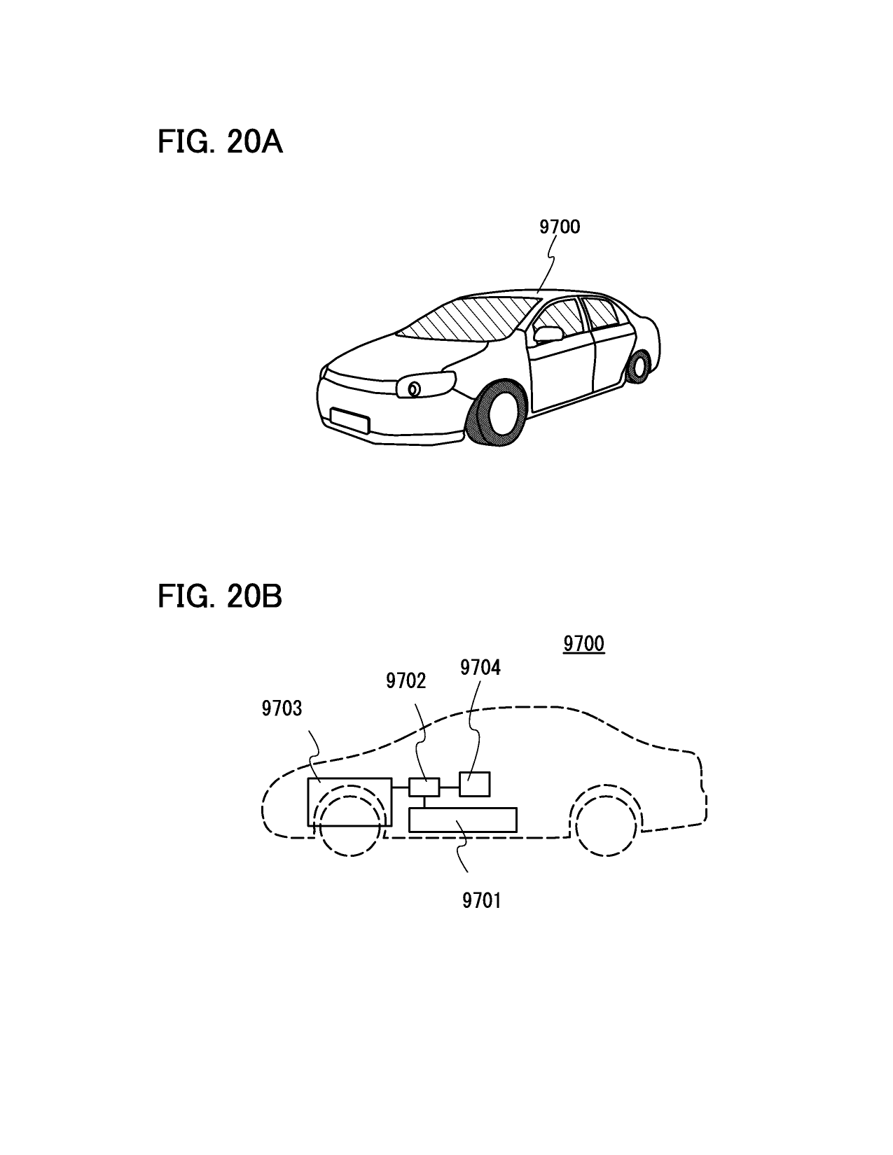

An example of a moving object which is an example of an electric device is described with reference to FIGS. 20A and 20B.

The power storage device described in the above embodiment can be used as a control battery. The control battery can be charged by external power supply using a plug-in technique or contactless power feeding. Note that in the case where the moving object is an electric railway vehicle, the electric railway vehicle can be charged by power supply from an overhead cable or a conductor rail.

FIGS. 20A and 20B illustrate an example of an electric vehicle. An electric vehicle 9700 is equipped with a power storage device 9701. The output of electric power from the power storage device 9701 is controlled by a control circuit 9702 and the electric power is supplied to a driving device 9703. The control circuit 9702 is controlled by a processing unit 9704 including a ROM, a RAM, a CPU, or the like (not illustrated).

The driving device 9703 includes a DC motor or an AC motor either alone or in combination with an internal-combustion engine. The processing unit 9704 outputs a control signal to the control circuit 9702 based on input data such as data on operation (e.g., acceleration, deceleration, or stop) by a driver of the electric vehicle 9700 or data during driving (e.g., data on an upgrade or a downgrade, or data on a load on a driving wheel). The control circuit 9702 adjusts the electric energy supplied from the power storage device 9701 in accordance with the control signal of the processing unit 9704 to control the output of the driving device 9703. In the case where an AC motor is mounted, although not illustrated, an inverter which converts direct current into alternate current is also incorporated.

The power storage device 9701 can be charged by external power supply using a plug-in technique. For example, the power storage device 9701 is charged by a commercial power source through a power plug. The power storage device 9701 can be charged by converting the supplied power into a constant DC voltage having a predetermined voltage level through a converter such as an AC-DC converter. The use of the power storage device of one embodiment of the present invention as the power storage device 9701 can contribute to a reduction in charging time or the like, so that convenience can be improved. Moreover, the higher charge-discharge speed of the power storage device 9701 can contribute to higher acceleration and excellent performance of the electric vehicle 9700. When the power storage device 9701 itself can be more compact and more lightweight as a result of improved characteristics of the power storage device 9701, the vehicle can also be lightweight, leading to an increase in fuel efficiency.

This embodiment can be implemented in combination with any of the other embodiments as appropriate.

### EXAMPLE 1

In this example, a coin-type storage battery was fabricated based on Embodiment 1. This example shows the results of comparison of the charge and discharge characteristics between a lithium ion secondary battery including CMC-Na and SBR as binders in a negative electrode active material layer and a lithium ion secondary battery including PVdF.

First, coin-type storage batteries fabricated in this example are described with reference to FIGS. 2A and 2B.

### (Formation of Positive Electrode)

A positive electrode paste was formed using graphene as a conductive additive. Lithium iron phosphate (LiFePO₄) was used as a positive electrode active material, and polyvinylidene fluoride (PVdF) was used as a binder. Lithium iron phosphate, graphene oxide, and polyvinylidene fluoride were mixed in a ratio of 94.4:0.6:5. NMP was added as a dispersion medium for viscosity adjustment, and mixing was performed. Thus, the positive electrode paste was formed.

The positive electrode paste formed by the above method was applied to a positive electrode current collector (20-μm-thick aluminum).

Subsequently, the paste provided on the current collector was dried with a circulation dryer. The drying was performed in an air atmosphere at 80° C. for 40 minutes.

Subsequently, graphene oxide was reduced by reaction in a solvent containing a reducer. The reduction treatment was performed at 60° C. for 4.5 hours. Ascorbic acid was used as the reducer. As the solvent, ethanol was used. The concentration of the reducer was 13.5 g/L.

After that, cleaning with ethanol was performed, and drying was performed at 70° C. for 10 hours. The drying was performed in a vacuum atmosphere.

Subsequently, the positive electrode active material layer was pressed by a roll press method so as to be consolidated.

The positive electrode active material layer was formed by the above method. Here, the content of lithium iron phosphate in the positive electrode was measured. The content in a positive electrode which was combined with a negative electrode A described later into a coin-type storage battery was 7.3 mg/cm², and the content in a positive electrode which was combined with a negative electrode B described later into a coin-type storage battery was 6.9 mg/cm².

### (Formation Process 1 of Negative Electrode A: Formation of Paste)

Next, the negative electrode A including CMC-Na and SBR as binders was formed. First, with the use of a negative electrode active material, a binder, and a dispersion medium, a negative electrode paste was formed.

Here, spherical natural graphite having a particle diameter of 15 μm was used as the negative electrode active material, and styrene-butadiene rubber (SBR) and sodium carboxymethyl cellulose (CMC-Na) were used as binders. The specification of CMC-Na used is as follows: the polymerization degree ranges from 600 to 800; the aqueous solution viscosity in the case of a 1% aqueous solution ranges from 300 mPa·s to 500 mPa·s; and the sodium content after drying ranges from 6.5% to 8.5%. The compounding ratio in the paste was set to graphite:SBR:CMC-Na=97:1.5:1.5 (weight ratio).

A method for forming the paste is now described in detail. First, an aqueous solution was prepared in such a manner that CMC-Na, which has high viscosity modifying properties, was uniformly dissolved in pure water. Then, the active material was weighed and the CMC-Na aqueous solution was added thereto.

Subsequently, the mixture of these materials was kneaded with a mixer at 1500 rpm to provide a thick paste.

Subsequently, an SBR aqueous dispersion was added to the mixture, and mixing was performed with a mixer at 1500 rpm for 5 minutes. Pure water serving as a dispersion medium was then added to the mixture until a predetermined viscosity was obtained, and mixing was performed with a mixer at 1500 rpm. Through the above steps, the negative electrode paste for the negative electrode A was formed.

### (Formation Process 2 of Negative Electrode A: Application and Drying)

The negative electrode paste formed by the above method was applied to a current collector with the use of a blade. The distance between the blade and the current collector was set to 200 μm. An 18-μm-thick rolled copper foil was used as the current collector.

Subsequently, drying on a hot plate was performed in an air atmosphere. The drying step was started at 25° C. to 30° C., and the temperature was then raised to 70° C. or lower and kept for approximately 30 minutes, so that water, i.e., the dispersion medium was evaporated. After that, drying was performed in a reduced pressure environment at 100° C. for 10 hours. In this manner, the negative electrode A was formed. The active material content in the obtained negative electrode A was 9.2 g/cm². Here, the term “active material content” refers to the weight of an active material per unit area of an electrode.

### (Formation Process 1 of Negative Electrode B (Comparative Example): Formation of Paste)

Next, the negative electrode B was formed as a comparative example of the negative electrode A. The negative electrode B includes PVdF as a binder. First, with the use of a negative electrode active material, a binder, and a dispersion medium, a negative electrode paste was formed.

Here, spherical natural graphite having a particle diameter of 15 μm was used as the negative electrode active material, and polyvinylidene fluoride (PVdF) was used as the binder. The compounding ratio in the paste was set to graphite:PVdF=90:10 (weight ratio). First, graphite and an NMP solution of PVdF were mixed with a mixer, and then, NMP was added for viscosity adjustment and mixing with a mixer was performed again, so that the negative electrode paste for the negative electrode B was formed.

### (Formation Process 2 of Negative Electrode B (Comparative Example): Application and Drying)

The negative electrode paste formed by the above method was applied to a current collector (18-μm-thick rolled copper foil) with the use of a blade. The distance between the blade and the current collector was set to 200 μm.

Subsequently, drying was performed with an oven in an air atmosphere at 70° C. for 30 minutes. After that, drying was performed in a reduced pressure environment at 170° C. for 10 hours. In this manner, the negative electrode B was formed. The active material content in the obtained negative electrode B was 8.0 mg/cm².

### (Fabrication of Coin Cell)

Coin cells (coin-type storage batteries) were fabricated by combining the formed positive electrodes with the respective negative electrodes, the negative electrode A and the negative electrode B, which was a comparative example of the negative electrode A.

In an electrolyte solution, 1,3-dimethyl-1-propylpiperidinium bis(fluorosulfonyl)amide (abbreviation: 3mPP13-FSA) was used as a nonaqueous solvent and lithium bis(trifluoromethylsulfonyl)amide (abbreviation: LiTFSA) was used as an electrolyte. LiTFSA was dissolved in 3mPP13-FSA at a concentration of 1 mol/L.

For a separator, GF/C, which is a glass fiber filter produced by Whatman Ltd., was used. The thickness of GF/C was 260 μm. The separator was immersed in the electrolyte solution to be used.

A positive electrode can and a negative electrode can were formed of stainless steel (SUS). As a gasket, a spacer or a washer was used.

The positive electrode can, the positive electrode, the separator, the negative electrode (the negative electrode A or the negative electrode B), the gasket, and the negative electrode can were stacked, and the positive electrode can and the negative electrode can were crimped to each other with a “coin cell crimper”. Thus, the coin-type storage battery was fabricated. The coin-type storage battery fabricated using the negative electrode A is referred to as a sample A, and the coin-type storage battery fabricated using the negative electrode B, which is a comparative example of the negative electrode A, is referred to as a comparative sample B.

### (Charge and Discharge Characteristics)

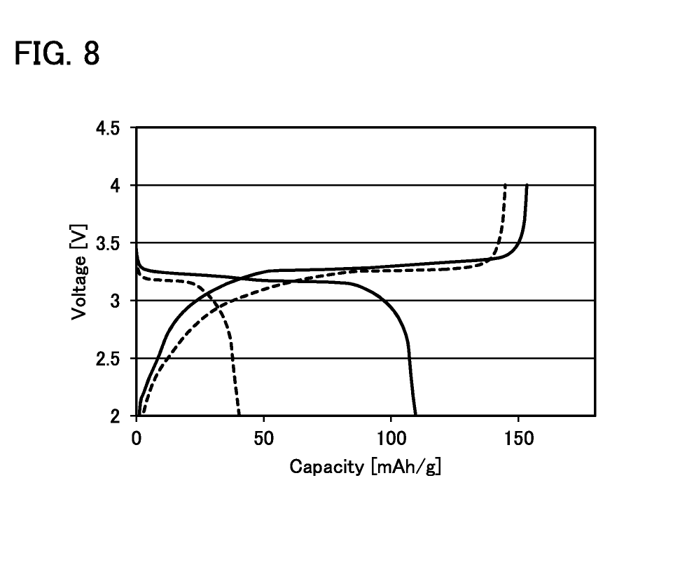

FIG. 8 shows the measurement results of the charge and discharge characteristics of the sample A and the comparative sample B. The solid lines represent the charge-discharge curves of the sample A, and the dashed lines represent those of the comparative sample B. The charge and discharge temperature was 60° C., the charge-discharge rate was 0.1 C, the charging was performed at a constant current until the voltage reached a termination voltage of 4 V, and the discharging was performed at a constant current until the voltage reached a termination voltage of 2 V. The first charging was followed by discharging with a 2-hour break in between.

In this specification and the like, the term “rate” refers to an index of the speed at which a battery is charged or discharged. That is, the “rate” at which a battery is charged or discharged is represented by a multiple of a current value 1 C, which is needed to complete the discharge of the theoretical capacity of an active material in 1 hour.

The comparative sample B showed high initial irreversible capacity: for the charge capacity of 145 mAh/g, the discharge capacity was only 40 mAh/g (approximately 28% of the charge capacity). In contrast, for the charge capacity of approximately 153 mAh/g, the sample A was able to achieve a discharge capacity of approximately 110 mAh/g (approximately 72%).

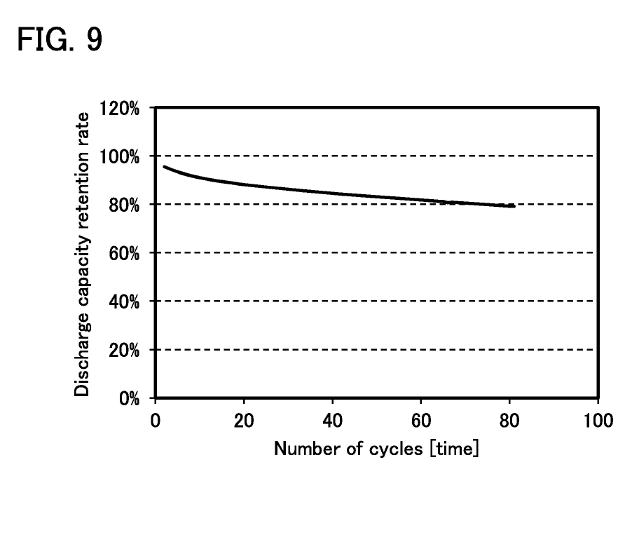

Next, with the use of a negative electrode A-2 which was formed under the same conditions as the negative electrode A, a coin-type storage battery was fabricated. The fabricated coin-type storage battery is referred to as a sample A-2. The conditions of all components except for the negative electrode were same as those of the sample A. FIG. 9 shows the cycle performance of the sample A-2 at 60° C. The charge and discharge temperature was 60° C., the charge-discharge rate in the first cycle was 0.1 C, the charge-discharge rate in the second and subsequent cycles was 0.5 C, the charging was performed at a constant current until the voltage reached a termination voltage of 4 V, and the discharging was performed at a constant current until the voltage reached a termination voltage of 2 V.

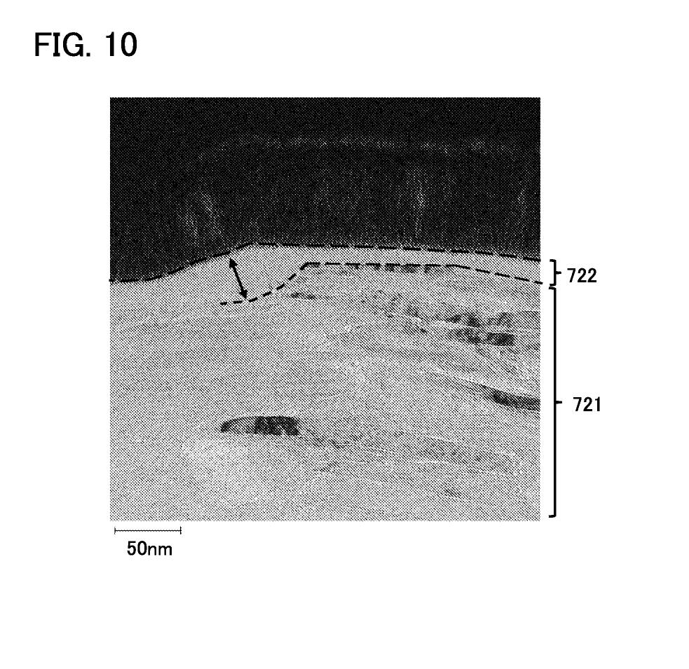

The storage battery was disassembled after 80 cycles for observation of the negative electrode. FIG. 10 shows the results of cross-sectional observation of the negative electrode of the sample A-2 which was disassembled after the cycle performance measurement. The observation was performed using a high resolution transmission electron microscope (TEM). A coating film 722 covering a surface of a graphite particle 721 was observed.

### EXAMPLE 2

The electrolyte solution used in Example 1 was subjected to cyclic voltammetry (CV) measurement. In the electrolyte solution, 1,3-dimethyl-1-propylpiperidinium bis(fluorosulfonyl)amide (abbreviation: 3mPP13-FSA) was used as a nonaqueous solvent and lithium bis(trifluoromethylsulfonyl)amide (abbreviation: LiTFSA) was used as an electrolyte. LiTFSA was dissolved in 3mPP13-FSA at a concentration of 1 mol/L. Two electrodes, a negative electrode A-3 and a negative electrode B-2, were each used as a working electrode. A paste for the negative electrode A-3 was formed under the same conditions as the paste for the negative electrode A. The graphite content in the negative electrode A-3 was 2.4 mg/cm², which was lower than that in the negative electrode A. A paste for the negative electrode B-2 was formed under the same conditions as the paste for the negative electrode B. The graphite content in the negative electrode B-2 was 1.1 mg/cm², which was lower than that in the negative electrode B.

Methods for forming the negative electrode A-3 and the negative electrode B-2 are described below. The paste for the negative electrode A-3 was formed under the same conditions as the paste for the negative electrode A. The paste for the negative electrode B-2 was formed under the same conditions as the paste for the negative electrode B. Then, the pastes were each applied to a current collector. In the application of the negative electrode A-3, the distance between a blade and the current collector was set to 50 μm. In the application of the negative electrode B-2, the distance between a blade and the current collector was set to 50 μm.

Next, coin-type storage batteries were fabricated under the following conditions. The two electrodes, the negative electrode A-3 and the negative electrode B-2, were each used as a working electrode. Lithium metal was used for a reference electrode and a counter electrode. As an electrolyte solution, a solution obtained by dissolving LiTFSA in 3mPP13-FSA at a concentration of 1 mol/L was used. Note that in this example, one electrode served as the reference electrode and the counter electrode.

Three cycles were performed in a scanning range of 2 V to 0 V (vs. Li/Li⁺), where the scanning speed was 0.0167 mV/s and the measurement temperature was 60° C. Note that in the first cycle, the scanning was started from an open-circuit potential.

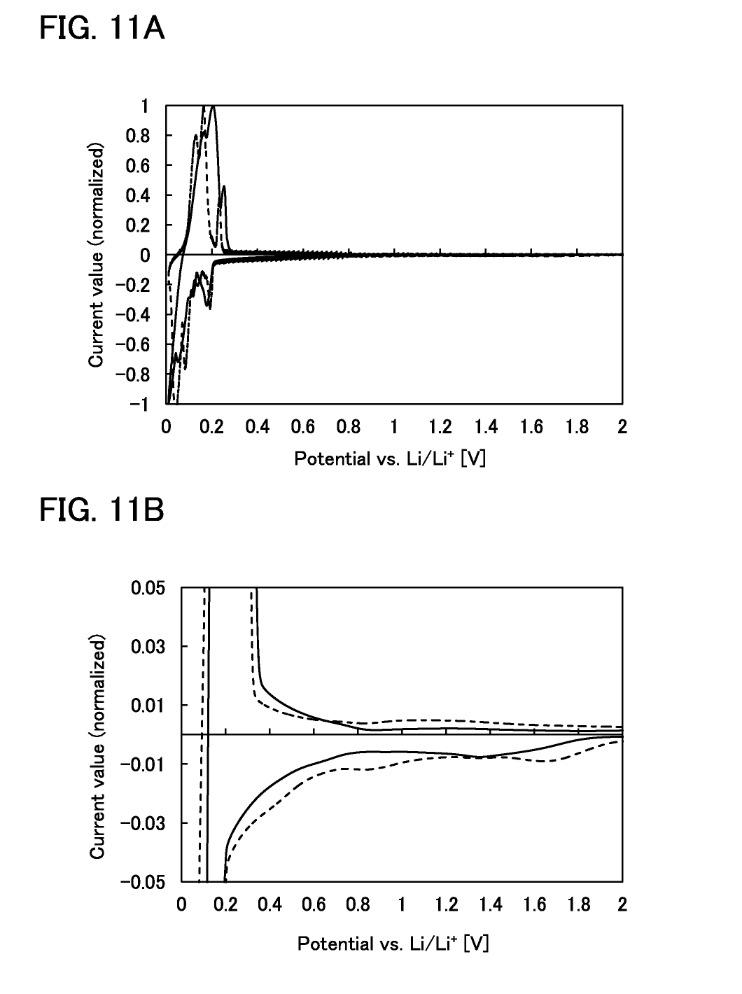

FIG. 11A shows the results of the cyclic voltammetry (CV) measurement in the first cycle. The measurement results in the second and third cycles are omitted. In the graph, the solid line represents the data of the negative electrode A-3 and the dashed line represents the data of the negative electrode B-2. Note that the current value was normalized by the maximum current value. The maximum of the absolute value of current of the sample including the negative electrode A-3 was 20 mA/g (here, g denotes the weight of the active material) and that of the sample including the negative electrode B-2 was 34 mA/g (similarly, g denotes the weight of the active material). FIG. 11B shows an enlarged view of FIG. 11A. Note that calculated moving average was plotted in FIG. 11B in order to eliminate noise due to a measuring device. In the first cycle of the negative electrode B-2, which was a graphite negative electrode including PVdF as a binder, peaks were observed at about 1.7 V and at about 0.9 V. On the other hand, no significant peak was observed in the corresponding positions in the data of the negative electrode A-3, which was a graphite negative electrode including CMC-Na and SBR as binders.

The two peaks observed in the first cycle of the negative electrode B-2 are probably a factor of the irreversible capacity. These results indicate that the reason why the graphite negative electrode including CMC-Na and SBR as binders had lower irreversible capacity than the graphite negative electrode including PVdF as a binder, as shown in FIG. 8 in Example 1, is that side reactions typified by these two peaks were suppressed. As possible side reactions, for example, there are insertion of a cation of an ionic liquid that is used as a solvent of an electrolyte solution and decomposition of an electrolyte solution.

### EXAMPLE 3

In this example, the sample A and the comparative sample B, which were the coin-type storage batteries fabricated in Example 1, were disassembled. Surfaces of the negative electrode active material layers taken out of the batteries were analyzed by XPS.

### (1. Composition)

Table 1 shows the composition found by XPS. Note that the presence of Cu was lower than or equal to the lower limit of the detection.

TABLE 1
[atomic %]

| Name of sample | C | F | O | Li | S | N | P | Cu | Na |
|---|---|---|---|---|---|---|---|---|---|
| Sample A | 46.7 | 14.7 | 13.8 | 13.4 | 4.6 | 6.8 | 0.0 | / | 0.0 |
| Comparative | 19.7 | 5.4 | 39.9 | 29.4 | 4.5 | 1.1 | 0.0 | / | 0.0 |
| sample B | | | | | | | | | |

It can be seen that the proportions of fluorine and nitrogen in the sample A are higher than those in the comparative sample B. The ratio of the proportion of oxygen to the proportion of fluorine (═O/F) is preferably greater than or equal to 0.1 and less than or equal to 2, further preferably greater than or equal to 0.3 and less than or equal to 2. The ratio of the proportion oxygen to the proportion of nitrogen (═O/N) is preferably less than or equal to 20, further preferably less than or equal to 10, still further preferably less than or equal to 5.

Such a difference in proportion probably comes from the difference in components of the coating films formed on graphite surfaces. The coating film is supposed to be formed by deposition of decomposed matters of the electrolyte solution. The analysis results suggest that different decomposition reactions of the electrolyte solution occurred as described in Example 2. Thus, a difference was also observed between the formed coating films.

### (2. C1s Spectrum)

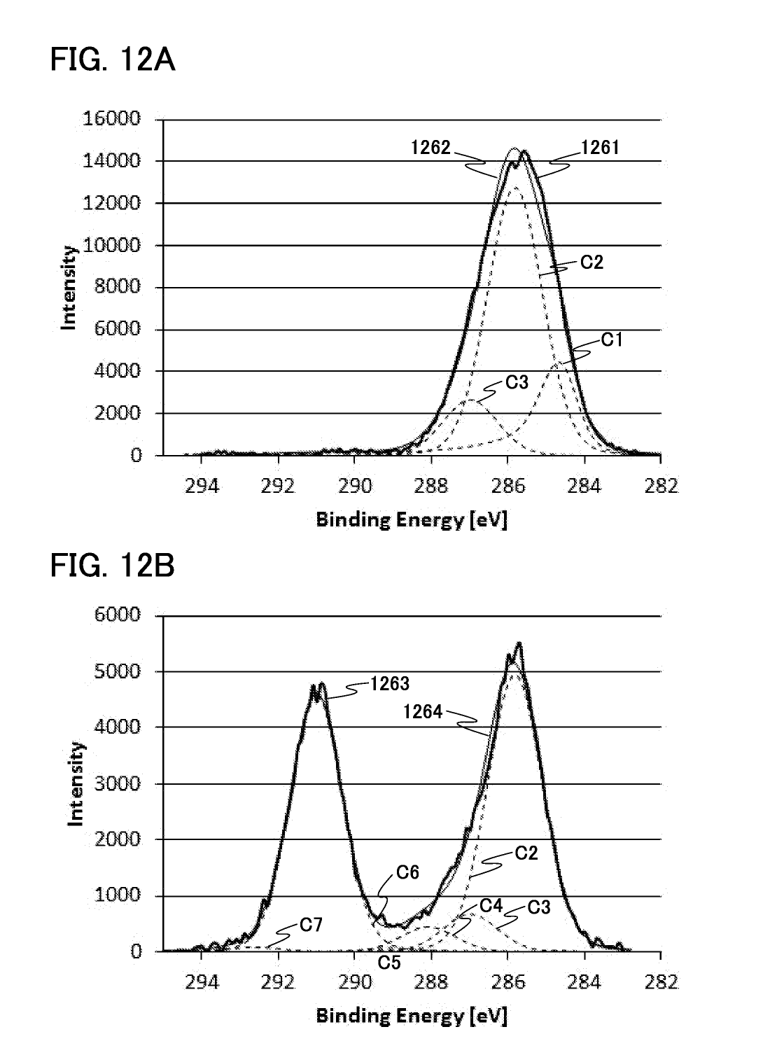

FIGS. 12A and 12B show C1s spectra of the sample A and the comparative sample B measured by XPS and the results of waveform separation of the spectra. FIG. 12A shows the measurement results of the negative electrode A, and FIG. 12B shows the measurement results of the negative electrode B. The spectra in FIGS. 12A and 12B were separated into seven peaks, C1, C2, C3, C4, C5, C6, and C7, which were then subjected to fitting. Table 2 shows data on the assignment of C1, C2, C3, C4, C5, C6, and C7, the peak intensity obtained by the fitting, and the like. FIG. 12A shows a spectrum 1261 (represented by the thick line) obtained by measuring the negative electrode A and a sum 1262 (represented by the thin line) of the spectra of C1 to C7, which were obtained by the fitting. FIG. 12B shows a spectrum 1263 (represented by the thick line) obtained by measuring the negative electrode B and a sum 1264 (represented by the thin line) of the spectra of C1 to C7, which were obtained by the fitting.

TABLE 2

| | | | Peak | Peak | Peak | Existing |
|---|---|---|---|---|---|---|
| | | | position | intensity | area | proportion |
| | | | [eV] | [%] | [%] | [%] |
| Sample A | C1 | C═C or the like | 284.66 | 30.71 | 21.63 | 10.10 |
| | C2 | C—C, C—H, or the like | 285.82 | 88.05 | 64.82 | 30.27 |
| | C3 | C*-CFₓ, C—O, or the like | 286.99 | 18.41 | 13.55 | 6.33 |
| | C4 | C═O or the like | 288.09 | 0.00 | 0.00 | 0.00 |
| | C5 | —CF, O═C—O, or the like | 289.09 | 0.00 | 0.00 | 0.00 |
| | C6 | CF₂, CO₃, or the like | 291.04 | 0.00 | 0.00 | 0.00 |
| | C7 | —CF₃ or the like | 292.59 | 0.00 | 0.00 | 0.00 |
| Comparative | C1 | C═C or the like | 284.66 | 0.45 | 0.22 | 0.04 |
| sample B | C2 | C—C, C—H, or the like | 285.82 | 89.91 | 46.7 | 9.20 |
| | C3 | C*-CFₓ, C—O, or the like | 286.99 | 12.31 | 6.39 | 1.26 |
| | C4 | C═O or the like | 288.09 | 8.17 | 4.24 | 0.84 |
| | C5 | —CF, O═C—O, or the like | 289.09 | 1.35 | 0.70 | 0.14 |
| | C6 | CF₂, CO₃, or the like | 291.01 | 83.63 | 40.91 | 8.06 |
| | C7 | —CF₃ or the like | 292.59 | 1.59 | 0.83 | 0.16 |

In FIG. 12A, compared to the peak of C2 in Table 2, which lies in a range from 285 eV to 286 eV inclusive and is derived from a C—C bond, a C—H bond, or the like, a peak which lies in a range from 290.5 eV to 291.5 eV inclusive and is derived from a —CF₂ group, a —CO₃ group, or the like is significantly low. In FIG. 12B, in contrast, the intensity of the peak of C6 in the range from 290.5 eV to 291.5 eV inclusive is high. In the C1s spectrum obtained by XPS, the ratio of the maximum intensity in a range from 290 eV to 292 eV inclusive to the maximum intensity in a range from 284.5 eV to 286 eV inclusive is preferably less than or equal to 0.3, further preferably less than or equal to 0.1.

The peak of C6 in Table 2, which lies in the range from 290.5 eV to 291.5 eV inclusive, is assigned to a —CF₂ group or a —CO₃ group. The —CF₂ group is a component of PVdF. The —CO₃ group is not contained as a main component of the electrolyte solution, graphite, or the binder; therefore, the —CO₃ group might be generated in such a manner that any of their main components is decomposed and reacts with another component. Assuming that a component containing carbon is decomposed, the generation of the —CO₃ group might be caused by, for example, decomposition a cation, which suggests a possibility that a surface of graphite was covered with CMC—Na or SBR, so that the decomposition was suppressed in the sample A as compared to in the comparative sample B.

Note that the detection depth in XPS spectroscopy is approximately 5 nm and that a peak of graphite under the coating film formed on the surface is detected in some cases, depending on the thickness of the coating film.

### (3. O1s Spectrum)

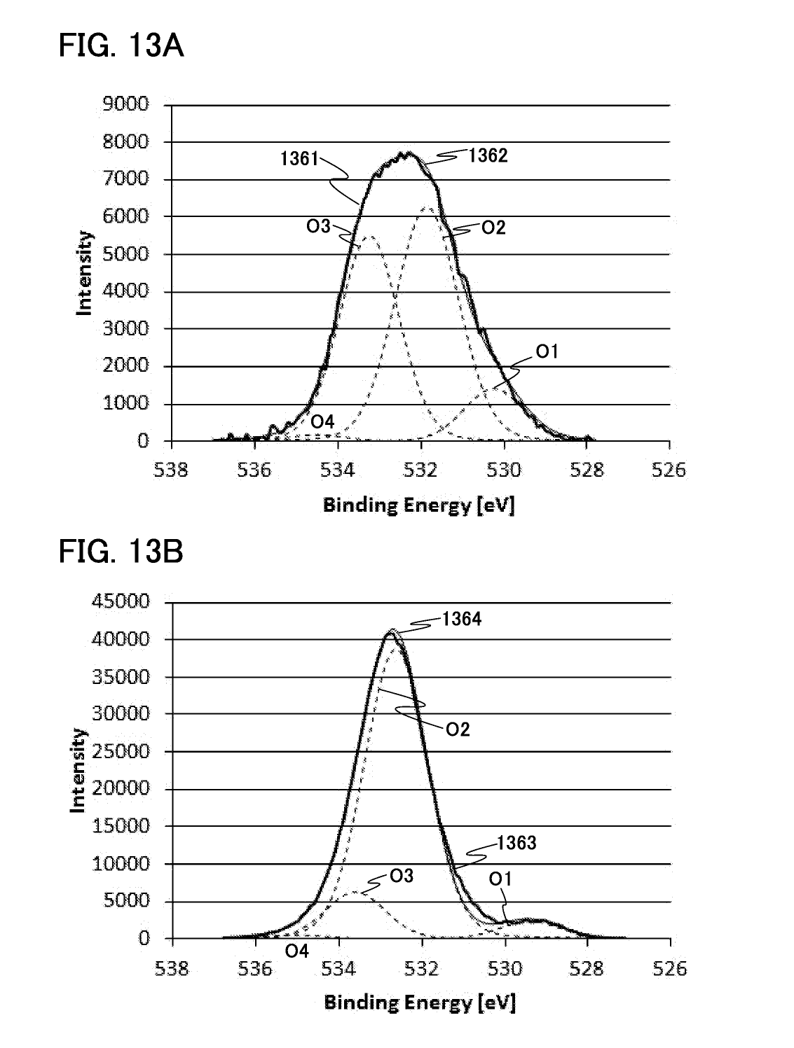

FIGS. 13A and 13B show O1s spectra of the sample A and the comparative sample B measured by XPS and the results of waveform separation of the spectra. FIG. 13A shows the measurement results of the negative electrode A, and FIG. 13B shows the measurement results of the negative electrode B. The spectra in FIGS. 13A and 13B were separated into four peaks, O1, O2, O3, and O4, which were then subjected to fitting. Table 3 shows data on the assignment of O1, O2, O3, and O4, the peak intensity obtained by the fitting, and the like. FIG. 13A shows a spectrum 1361 obtained by measuring the negative electrode A and a sum 1362 of the spectra of O1 to O4, which were obtained by the fitting. FIG. 13B shows a spectrum 1363 obtained by measuring the negative electrode B and a sum 1364 of the spectra of O1 to O4, which were obtained by the fitting.

TABLE 3

| | | | Peak | Peak | | Existing |
|---|---|---|---|---|---|---|
| | | | posi- | inten- | Peak | propor- |
| | | | tion | sity | area | tion |
| | | | [eV] | [%] | [%] | [%] |
| Sample A | O1 | metal-O | 530.25 | 18.19 | 10.26 | 1.42 |
| | O2 | metal-OH, metal-CO₃, | 531.86 | 80.93 | 48.31 | 6.67 |
| | | C═O, S—O, or the | | | | |
| | | like | | | | |
| | O3 | C—O—C or the like | 533.25 | 71.13 | 40.12 | 5.54 |
| | O4 | O—CF_{y} or the like | 534.52 | 2.31 | 1.3 | 0.18 |
| Compar- | O1 | metal-O | 529.4 | 5.8 | 4.72 | 1.88 |
| ative | O2 | metal-OH, metal-CO₃, | 532.63 | 94.93 | 81.82 | 32.65 |
| sample B | | C═O, S—O, or the | | | | |
| | | like | | | | |
| | O3 | C—O—C or the like | 533.61 | 15.34 | 12.49 | 4.98 |
| | O4 | O—CF_{y} or the like | 534.98 | 1.19 | 0.97 | 0.39 |

The half width of a peak observed in the vicinity of 532.5 eV is wide in FIG. 13A, whereas the half width is narrow in FIG. 13B. The results of fitting in FIG. 13A indicate two peaks, namely a peak derived from a C—O—C bond (O3: observed in a range from 533 eV to 534 eV inclusive) and a peak derived from a metal-OH bond, a metal-CO₃ bond, a C═O bond, a S—O bond, or the like (O2: observed in a range from 531 eV to 533 eV inclusive). In contrast, in FIG. 13B, the peak derived from a C—O—C bond or the like (O3: observed in the range from 533 eV to 534 eV inclusive) is relatively weak. Taking also the results in the C1s spectrum into consideration, there is another possibility that metal-CO₃ is formed, for example.

### (4. F1s Spectrum)

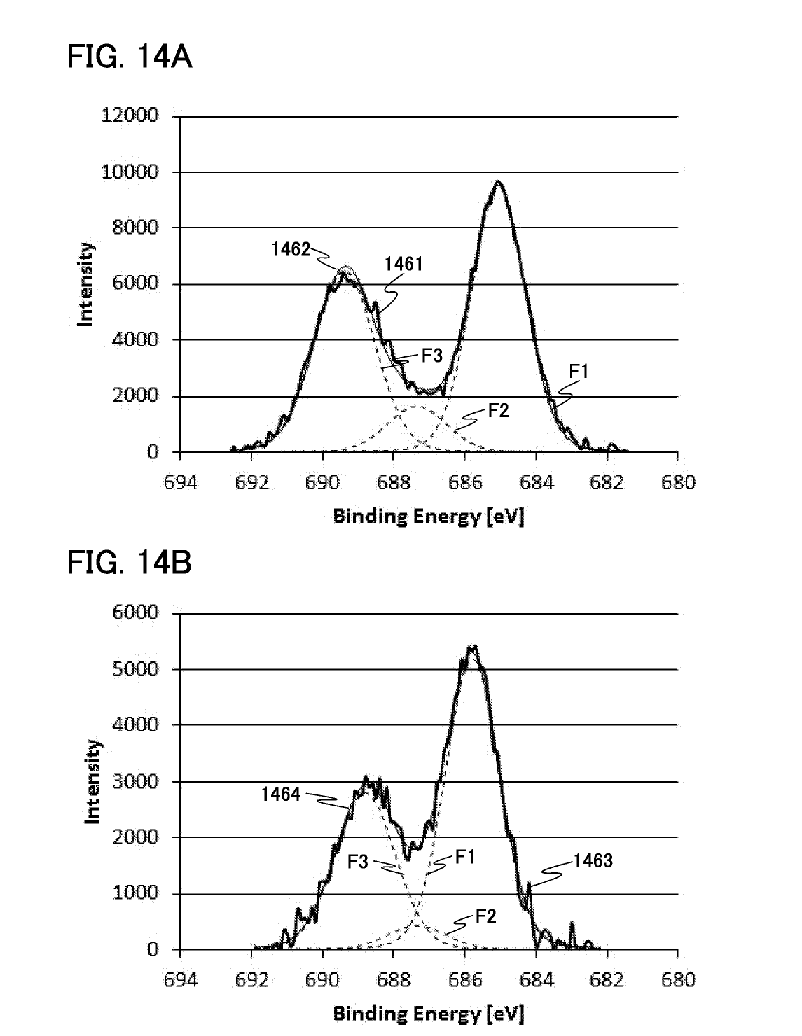

FIGS. 14A and 14B show F1s spectra of the sample A and the comparative sample B measured by XPS and the results of waveform separation of the spectra.

FIG. 14A shows the measurement results of the negative electrode A, and FIG. 14B shows the measurement results of the negative electrode B. The spectra in FIGS. 14A and 14B were separated into three peaks, F1, F2, and F3, which were then subjected to fitting. Table 4 shows data on the assignment of F1, F2, and F3, the peak intensity obtained by the fitting, and the like. FIG. 14A shows a spectrum 1461 obtained by measuring the negative electrode A and a sum 1462 of the spectra of F1 to F3, which were obtained by the fitting. FIG. 14B shows a spectrum 1463 obtained by measuring the negative electrode B and a sum 1464 of the spectra of F1 to F3, which were obtained by the fitting.

TABLE 4

| | | | Peak | Peak | Peak | Existing |
|---|---|---|---|---|---|---|
| | | | position | intensity | area | proportion |
| | | | [eV] | [%] | [%] | [%] |
| Sample A | F1 | Li—F, N—F | 685.06 | 97.82 | 51.17 | 7.52 |
| | F2 | LiPF_{z} | 687.35 | 17.03 | 9.89 | 1.45 |
| | F3 | C—F, S—F | 689.38 | 67.06 | 38.94 | 5.72 |
| Comparative | F1 | Li—F, N—F | 685.79 | 95.95 | 59.14 | 3.19 |
| sample B | F2 | LiPF_{z} | 687.35 | 7.96 | 5.45 | 0.29 |
| | F3 | C—F, S—F | 688.8 | 51.76 | 35.42 | 1.91 |

From the results of the fitting in FIG. 14A, the intensity of the peak of F2 in Table 4, which lies in a range from 687 eV to 688 eV inclusive and is derived from LiPF_{z} (z>0) or the like, is approximately 0.17 times the intensity of the peak of F1 in Table 4, which lies in a range from 685 eV to 686 eV inclusive or in the vicinity thereof and is derived from a Li—F bond, a N—F bond, or the like.

### (5. S2p Spectrum)

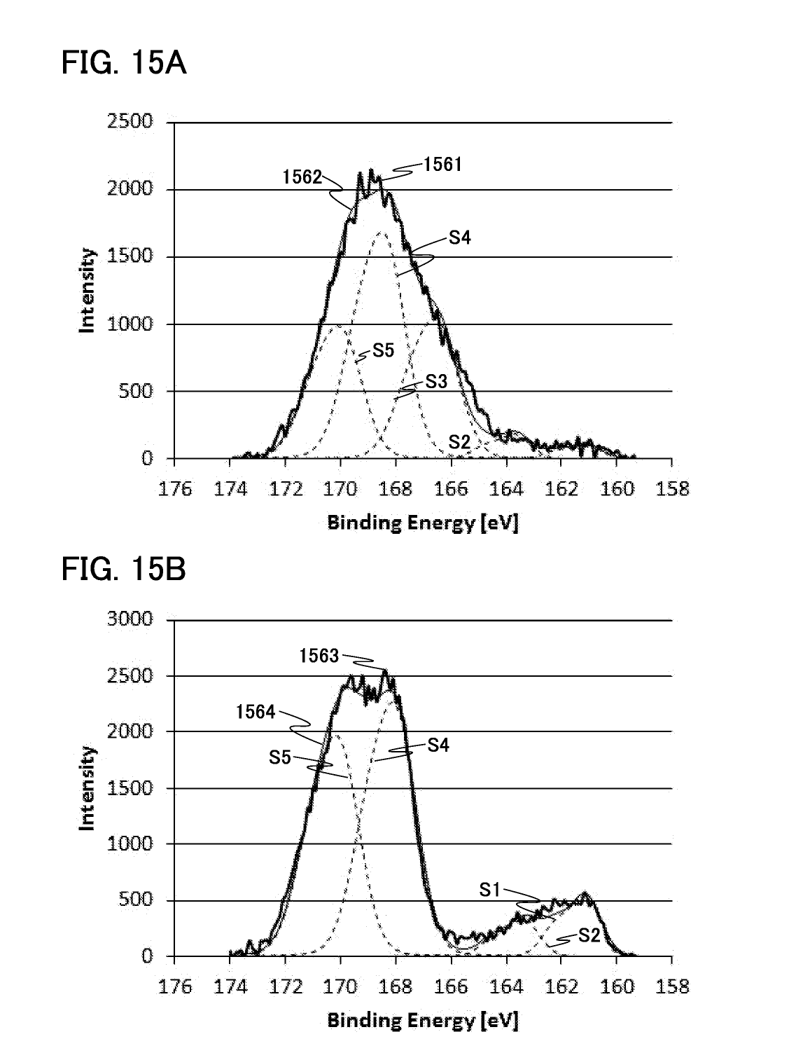

FIGS. 15A and 15B show S2p spectra of the sample A and the comparative sample B measured by XPS and the results of waveform separation of the spectra.

FIG. 15A shows the measurement results of the negative electrode A, and FIG. 15B shows the measurement results of the negative electrode B. The spectra in FIGS. 15A and 15B were separated into five peaks, S1, S2, S3, S4 and S5, which were then subjected to fitting. Table 5 shows data on the assignment of S1, S2, S3, S4 and S5, the peak intensity obtained by the fitting, and the like. FIG. 15A shows a spectrum 1561 obtained by measuring the negative electrode A and a sum 1562 of the spectra of S1 to S5, which were obtained by the fitting. FIG. 15B shows a spectrum 1563 obtained by measuring the negative electrode B and a sum 1564 of the spectra of S1 to S5, which were obtained by the fitting.

TABLE 5

| | | | Peak | Peak | Peak | Existing |
|---|---|---|---|---|---|---|
| | | | position | intensity | area | proportion |
| | | | [eV] | [%] | [%] | [%] |
| Sample A | S1 | metal-S | 161.1 | 4.97 | 2.24 | 0.10 |
| | S2 | C—S | 163.65 | 8.67 | 3.9 | 0.18 |
| | S3 | S—N | 166.39 | 48.53 | 26.33 | 1.21 |
| | S4 | SO_{α} | 168.3 | 78.47 | 42.58 | 1.96 |
| | S5 | SF_{β} | 169.88 | 45.98 | 24.95 | 1.15 |
| Comparative | S1 | metal-S | 161.1 | 21.80 | 9.26 | 0.42 |
| sample B | S2 | C—S | 163.33 | 12.89 | 5.48 | 0.25 |
| | S3 | S—N | 166.39 | 0.52 | 0.27 | 0.01 |
| | S4 | SO_{α} | 167.92 | 88.73 | 45.43 | 2.04 |
| | S5 | SF_{β} | 169.97 | 77.26 | 39.56 | 1.78 |

Note that since SO_{α} (α>0) or a S—N bond is also a component of an anion of the ionic liquid, it might be a component of a residue of the ionic liquid.

### (6. Calculation of Existing Proportion)

Here, the value obtained by multiplying the area of each of the peaks, which are separated in accordance with the results of the waveform analysis, by the proportion of each element is defined as an existing proportion. For example, according to the C1s spectrum in FIG. 12A, the area of the peak of C2 in Table 2 accounts for 64.82%. This value is multiplied by 46.7%, which is the proportion of carbon in the sample A. That is, the solution of 0.6482×0.467×100=30.27% is defined as the existing proportion of C2. Table 2 shows the existing proportions of the separate peaks.

In the comparative sample B, the existing proportion of the peak of C6 is 8.06% and the existing proportion of the peak of F1 is 3.19%. The ratio C6/F1 is 2.53. In the sample A, on the other hand, the peak of C6 obtained by the waveform separation is found to be very weak.

The ratio of the existing proportion of C6 to that of F1 (C6/F1) is preferably less than or equal to 2, further preferably less than or equal to 1, still further preferably less than or equal to 0.5.

### (7. Existing Proportion of Li Sorted by State)

Next, Table 6 shows the existing proportion of Li sorted by the state, which was calculated from the results of the waveform analysis of C1s, O1s, F1s, and S2p.

TABLE 6
[atomic %]

| Name of | | | | | | | |
|---|---|---|---|---|---|---|---|
| sample | Li₂O | LiOH | Li₂CO₃ | LiF | Metal Li | Li₂SO₄ | LiSFₓ |
| Sample A | 23.0 | 0.0 | 0.0 | 35.2 | 0.0 | 32.8 | 9.0 |
| Comparative | 13.0 | 0.0 | 55.5 | 11.0 | 0.0 | 14.4 | 6.2 |
| sample B | | | | | | | |

On the assumption of the existence of the compounds Li₂O, LiOH, Li₂O₃, LiF, Li₂SO₄, and LiSF_{γ} (γ>0) and metal Li, the respective existing proportions of Li in the states of the compounds and the metal Li were calculated. First, as for Li₂O, all peaks of O1 in the O1s spectrum were assumed to be derived from Li₂O. Next, as for Li₂O₃, all peaks of C6 in the C1s spectrum were assumed to be derived from Li₂O₃. As for Li₂SO₄, all S4 components in the S2p spectrum were assumed to be derived from Li₂SO₄. As for LiSF_{γ} (γ>0), all S5 components in the S2p spectrum were assumed to be derived from LiSF_{γ} (γ>0). The existing proportion of LiOH was calculated by subtracting the number of components of Li₂O₃ and Li₂SO₄ from the O2 spectrum in the O1s analysis.

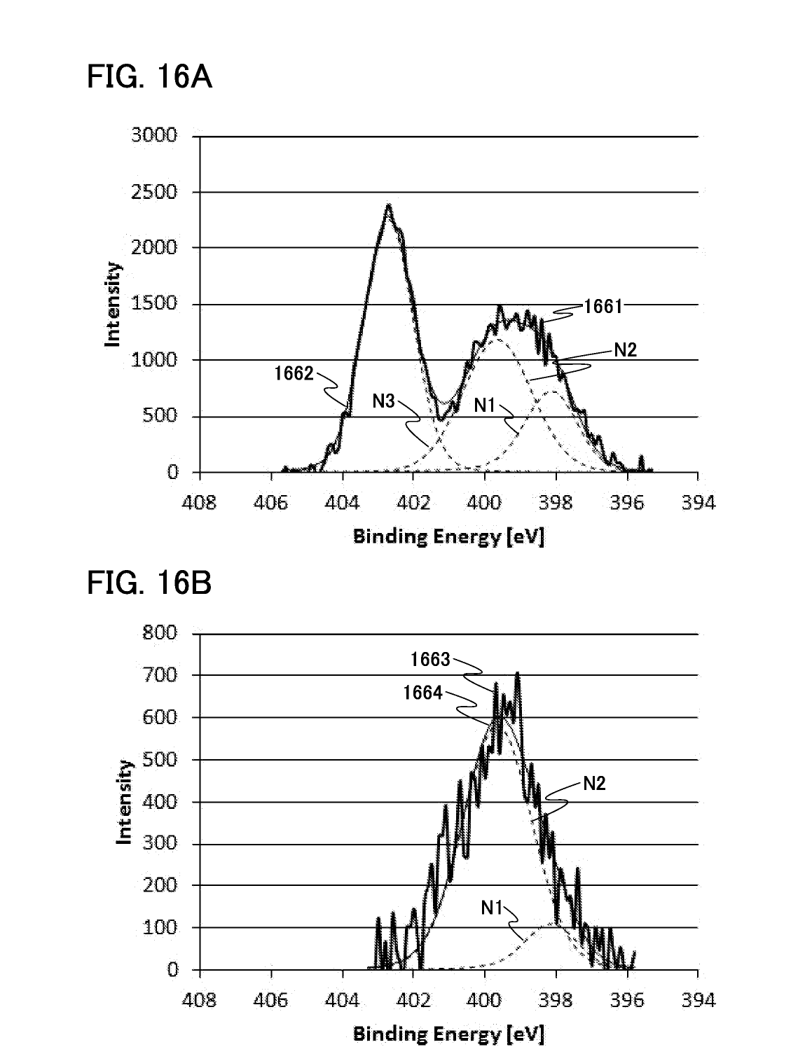

The existing proportion of LiF was obtained by subtracting the number of components derived from a N—F bond from the F1 spectrum. The number of components derived from a N—F bond was obtained by the analysis of a N1s spectrum. FIGS. 16A and 16B show N1s spectra and the results of waveform separation of the spectra. FIG. 16A shows the results of the negative electrode A, and FIG. 16B shows the results of the negative electrode B. Among three peaks N1, N2, and N3, the N3 peak is derived from a N—F bond and a N—SO bond (Δ>0). In FIG. 16B, the number of existing N—F bonds is assumed to be zero because the N3 peak is hardly observed.

From the results of the waveform analysis in FIG. 16A, the estimated areas of the N1, N2, and N3 peaks account for 17%, 35%, and 48%, respectively. These values were each multiplied by 6.8%, which was the proportion of nitrogen, so that 1.2%, 2.4%, and 3.2% were obtained as the existing proportions of the N1, N2, and N3 peaks, respectively. Here, all the N3 peaks were assumed to be derived from a N—F bond, and 3.2%, which was the existing proportion of the N3 peak, was subtracted from 7.52%, which was the existing proportion of the F1 peak (derived from a Li—F bond and a N—F bond) in the F1s spectrum, so that the existing proportion of LiF was found to be 4.52%. Note that although all the N3 peaks were assumed to be derived from a N—F bond here, the calculated existing proportion of LiF is higher in the presence of N—SO_{Δ} (Δ>0). To be precise, the existing proportion of LiF was able to be estimated to be at least 4.52%.

The existing proportion of metal Li was obtained by subtracting the amount of Li in a compound from the proportion of Li in Table 1.

Note that Table 6 shows the existing proportion of Li. It is assumed that the ratio of the existing proportion of Li derived from lithium carbonate to the existing proportion of Li derived from lithium fluoride, i.e., Li (lithium carbonate):Li (lithium fluoride) is 2:1. In this case, since lithium carbonate (Li₂CO₃) has two Li atoms while lithium fluoride (LiF) has one Li atom, the ratio of the existing proportions of these compounds is as follows: lithium carbonate:lithium fluoride=(2/2):1=1:1.

Table 6 indicates a tendency: in the sample A, the proportion of Li in the state of lithium fluoride (LiF) is high and the proportion of Li in the state of lithium carbonate (Li₂CO₃) is low, as compared to the comparative sample B.

The ratio of the proportion of lithium carbonate to the proportion of lithium fluoride (lithium carbonate/lithium fluoride) is preferably less than or equal to 2, further preferably less than or equal to 0.5.

The fluorine element in LiF, the bond between S and O in Li₂SO₄, and the oxygen element in Li2CO₃ are each an element or a bond included in the cation or the anion of the ionic liquid. Supposing that components of the coating film are mainly resultant products of reaction between a decomposed matter of the electrolyte solution and another component, the decomposition voltage, the amount of decomposition, and the like at the time of charging differ between the sample A and the comparative sample B; in the sample A, the amount of decomposition is probably small and thus decomposition can be suppressed even at a low potential. Moreover, as described above, it is also possible that a —CO₃ group or the like is generated by decomposition of the cation. In addition, a large number of LiF components were observed in the sample A. As an example of a component containing fluorine, the anion of the ionic liquid can be given. The high proportion of LiF suggests that the anion is decomposed at a relatively low potential or that the anion is easily decomposed through slow decomposition.

### EXAMPLE 4

In this example, a method for manufacturing a power storage device of one embodiment of the present invention and characteristics thereof are described.

### (Formation of Negative Electrode C)

Negative electrodes C and E including CMC—Na and SBR as binders were formed.

First, a method for forming the negative electrode C is described.

With the use of a negative electrode active material, a binder, and a dispersion medium, a paste for a negative electrode active material layer was formed.

Spherical natural graphite having a particle diameter of 15 μm was used as the negative electrode active material. SBR and CMC—Na were used as binders. The specification of CMC—Na used is as follows: the polymerization degree ranges from 600 to 800; the aqueous solution viscosity in the case of a 1% aqueous solution ranges from 300 mPa·s to 500 mPa·s; and the sodium content after drying ranges from 6.5% to 8.5%. The compounding ratio in the paste was set to graphite:SBR:CMC—Na=97:1.5:1.5 (weight ratio).

A method for forming the paste is now described.

Mixing was performed with a planetary mixer. A container with a volume of 1.4 L was used for the mixing,

First, the active material was weighed and carbon fibers and CMC—Na powder were added thereto, so that a mixture A was obtained.

Subsequently, water was added to the mixture A, and the mixture was kneaded with a mixer for approximately 40 minutes into a thick paste; thus, a mixture B was obtained. The weight of water added here was 39% of the total weight of the mixture. Here, “kneading something into a thick paste” means “mixing something with a high viscosity”.

Subsequently, an SBR aqueous dispersion was added to the mixture B, additional water was added, and mixing was performed with a mixer for 20 minutes; thus, a mixture C was obtained.

Subsequently, pure water serving as a dispersion medium was added to the mixture C until a predetermined viscosity was obtained, and mixing was performed with a mixer for 20 minutes, so that a mixture D was obtained. Here, the predetermined viscosity refers to an appropriate viscosity for application, for example.

Subsequently, the obtained mixture D was degassed under reduced pressure. The pressure in the mixer containing this mixture was reduced and degasification was performed for 20 minutes. The pressure was adjusted so that a pressure difference from the atmospheric pressure was 0.096 Mpa or less.

Through the above steps, a paste for an active material layer of the negative electrode C was formed.

Subsequently, the paste was applied to a current collector with the use of a continuous coating device. An 18-μm-thick rolled copper foil was used as the current collector. The coating speed was set to 0.5 m/min.

Subsequently, the applied electrode was dried using a drying furnace. The drying was performed in an air atmosphere. Regarding the temperature and time for the drying, the electrode was dried at 50° C. for 180 seconds and then dried at 80° C. for 180 seconds.

After the drying in the drying furnace, further drying was performed in a reduced pressure environment at 100° C. for 10 hours.

Through the above steps, the negative electrode C was formed.

### (Formation of Negative Electrode E)

Next, the negative electrode E including CMC—Na and SBR as binders was formed. First, with the use of a negative electrode active material, a binder, and a dispersion medium, a negative electrode paste was formed.

Here, spherical natural graphite having a particle diameter of 15 μm was used as the negative electrode active material, and styrene-butadiene rubber (SBR) and sodium carboxymethyl cellulose (CMC—Na) were used as binders. The specification of CMC—Na used is as follows: the polymerization degree ranges from 600 to 800; the aqueous solution viscosity in the case of a 1% aqueous solution ranges from 300 mPa·s to 500 mPa·s; and the sodium content after drying ranges from 6.5% to 8.5%. The compounding ratio in the paste was set to graphite:SBR:CMC—Na=97:1.5:1.5 (weight ratio).

A method for forming the paste is now described in detail. First, an aqueous solution was prepared in such a manner that CMC—Na, which has high viscosity modifying properties, was uniformly dissolved in pure water. Then, the active material was weighed and the CMC—Na aqueous solution was added thereto.

Subsequently, the mixture of these materials was kneaded with a mixer at 1500 rpm to provide a thick paste.

Subsequently, an SBR aqueous dispersion was added to the mixture, and mixing was performed with a mixer at 1500 rpm for 5 minutes. Pure water serving as a dispersion medium was then added to the mixture until a predetermined viscosity was obtained, and mixing was performed with a mixer at 1500 rpm. Through the above steps, the negative electrode paste for the negative electrode E was formed.

The negative electrode paste formed by the above method was applied to a current collector with the use of a blade. The distance between the blade and the current collector was set to 220 μm. An 18-μm-thick rolled copper foil was used as the current collector.

Subsequently, drying on a hot plate was performed in an air atmosphere. The drying step was started at 25° C. to 30° C., and the temperature was then raised to 50° C. or lower and kept for approximately 30 minutes, so that water, i.e., the dispersion medium was evaporated. After that, drying was performed in a reduced pressure environment at 100° C. for 10 hours. In this manner, the negative electrode E was formed.

### (Formation of Comparative Negative Electrode D)

Next, a comparative negative electrode D including PVdF as a binder was formed as a comparative sample. First, with the use of a negative electrode active material, a binder, and a dispersion medium, a paste for a negative electrode active material layer was formed.

Spherical natural graphite having a particle diameter of 15 μm was used as the negative electrode active material. PVdF was used as the binder. The compounding ratio in the paste was set to graphite:PVdF=90:10 (weight ratio).

A method for forming the paste is now described.

First, graphite and PVdF were weighed and mixed with a mixer, so that a mixture E was obtained. Then, NMP was added to the mixture E and mixing was performed with a mixer to form a paste.

Subsequently, the paste was applied to a current collector with the use of a blade. An 18-μm-thick rolled copper foil was used as the current collector. The scanning speed of the blade was set to 10 mm/sec.

Subsequently, the applied electrode was dried using a hot plate in an air atmosphere at 50° C. for 30 minutes, and then, further drying was performed in a reduced pressure environment at 100° C. for 10 hours.

Through the above steps, the comparative negative electrode D was formed.

### (Fabrication of Storage Battery)

Next, with the use of the formed negative electrode C, negative electrode E, and comparative negative electrode D, the coin-type storage batteries described in Embodiment 1 were fabricated. The single-electrode characteristics of the negative electrodes were measured with lithium metal used as the counter electrodes.

The characteristics were measured with the use of a CR2032 coin-type storage battery (with a diameter of 20 mm and a height of 3.2 mm). A positive electrode can and a negative electrode can were formed of stainless steel (SUS). For a separator, a stack of polypropylene and GF/C, which is a glass fiber filter produced by Whatman Ltd., was used. As an electrolyte solution, either an electrolyte solution A or an electrolyte solution B shown below was used.

As a nonaqueous solvent of the electrolyte solution A, 1-ethyl-3-methylimidazolium bis(fluorosulfonyl)amide (abbreviation: EMI-FSA) represented by Structural Formula (51) was used, and LiTFSA used as an electrolyte was dissolved at a concentration of 1 mol/L.

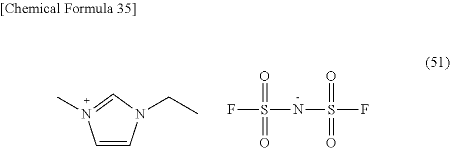

As a nonaqueous solvent of the electrolyte solution B, P13-FSA represented by Structural Formula (52) was used, and LiTFSA used as an electrolyte was dissolved at a concentration of 1 mol/L.

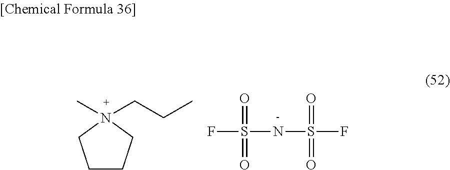

Table 7 shows the conditions of the negative electrodes and the electrolyte solutions used for the respective storage batteries. Table 8 shows the active material content, the thickness, and the density of the negative electrode active material layers of the negative electrodes used in this example. In Table 7, the negative electrode C was used as negative electrodes of storage batteries C-1-1, C-1-2, C-2-1, and C-2-2, the negative electrode E was used as negative electrodes of storage batteries E-1-1 and E-1-2, and the comparative negative electrode D was used as negative electrodes of storage batteries D-1-1, D-1-2, D-2-1, and D-2-2. The electrolyte solution A was used for the storage batteries C-1-1, C-1-2, D-1-1, and D-1-2, and the electrolyte solution B was used for the storage batteries C-2-1, C-2-2, D-2-1, and D-2-2.

TABLE 7

| | Negative electrode | Electrolyte solution |
|---|---|---|
| Storage battery C-1-1 | Negative electrode C | Electrolyte solution A |
| Storage battery C-1-2 | | |
| Storage battery E-1-1 | Negative electrode E | |
| Storage battery E-1-2 | | |
| Storage battery D-1-1 | Negative electrode D | |
| Storage battery D-1-2 | | |
| Storage battery C-2-1 | Negative electrode C | Electrolyte solution B |
| Storage battery C-2-2 | | |
| Storage battery D-2-1 | Negative electrode D | |
| Storage battery D-2-2 | | |

TABLE 8

| | Active material | | |
|---|---|---|---|
| | content | Thickness | Density |
| | [mg/cm²] | [μm] | [g/cc] |
| Storage battery C-1-1 | 5.5 | 71 | 0.81 |
| Storage battery C-1-2 | 5.1 | 65 | 0.81 |
| Storage battery E-1-1 | 8.7 | 93 | 0.96 |
| Storage battery E-1-2 | 8.6 | 104 | 0.85 |
| Storage battery D-1-1 | 8.4 | 99 | 0.94 |
| Storage battery D-1-2 | 8.3 | 95 | 0.97 |
| Storage battery C-2-1 | 4.5 | 49 | 0.95 |
| Storage battery C-2-2 | 4.5 | 49 | 0.95 |
| Storage battery D-2-1 | 7.2 | 72 | 1.12 |
| Storage battery D-2-2 | 7.2 | 79 | 1.02 |

### (Charge and Discharge Characteristics)

Next, the charge and discharge characteristics of the fabricated storage batteries were measured. The measurement temperature was 25° C. The discharging (Li insertion) was performed in the following manner: constant current discharging was performed at a rate of 0.1 C to a lower limit of 0.01 V, and then, constant voltage discharging was performed at a voltage of 0.01 V to a lower limit of a current value corresponding to 0.01 C. As the charging (Li extraction), constant current charging was performed at a rate of 0.1 C to an upper limit of 1 V.

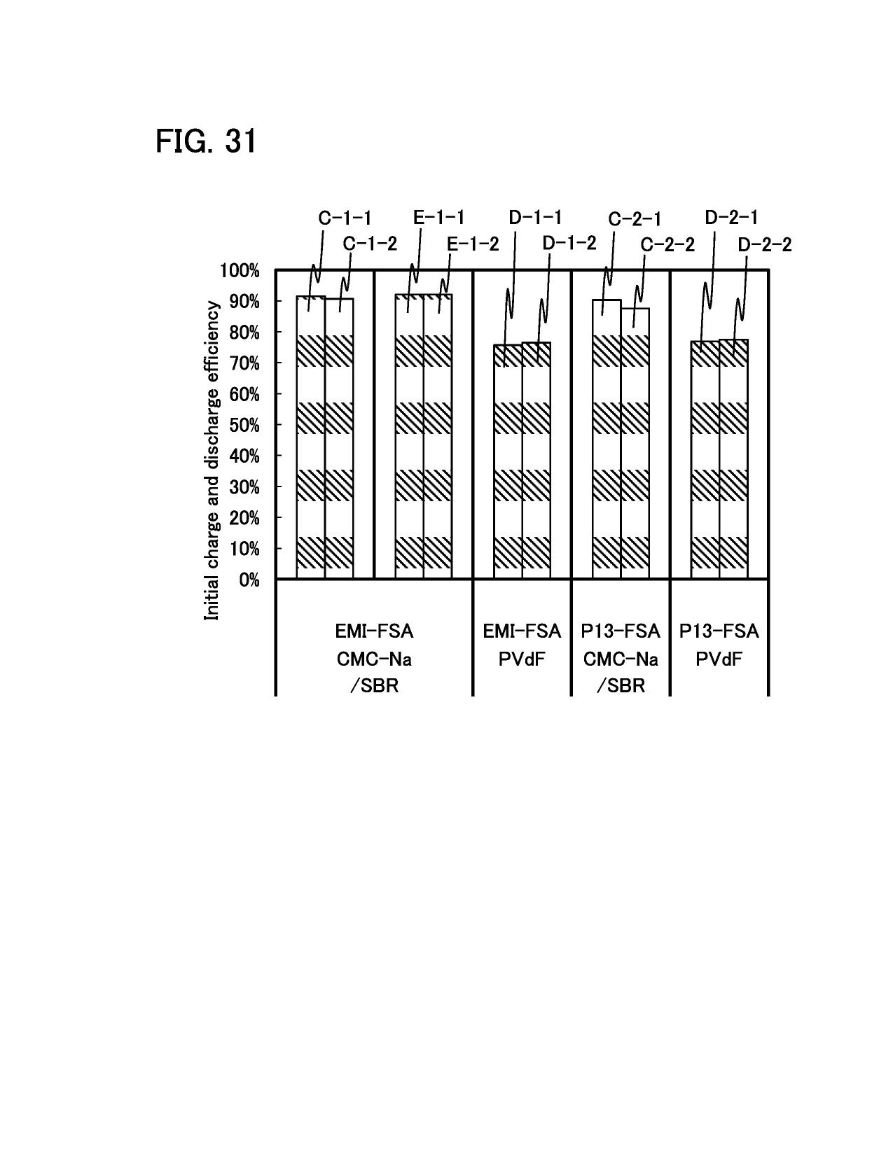

The initial charge and discharge efficiency is calculated by ([charge capacity]/[discharge capacity])×100 [%]. The initial charge and discharge efficiency of the storage batteries is shown in Table 9 and FIG. 31.

TABLE 9

| | Initial charge and |
|---|---|
| | discharge |
| | efficiency [%] |
| Storage battery C-1-1 | 91.5 |
| Storage battery C-1-2 | 90.6 |
| Storage battery E-1-1 | 92.1 |
| Storage battery E-1-2 | 92.1 |
| Storage battery D-1-1 | 75.7 |
| Storage battery D-1-2 | 76.5 |
| Storage battery C-2-1 | 90.3 |
| Storage battery C-2-2 | 87.5 |
| Storage battery D-2-1 | 76.9 |
| Storage battery D-2-2 | 77.5 |

The storage batteries having the negative electrode C, i.e., the electrode including CMC—Na and SBR as binders were able to achieve higher initial charge and discharge efficiency than the storage batteries having the comparative negative electrode D, i.e., the electrode including PVdF as a binder.

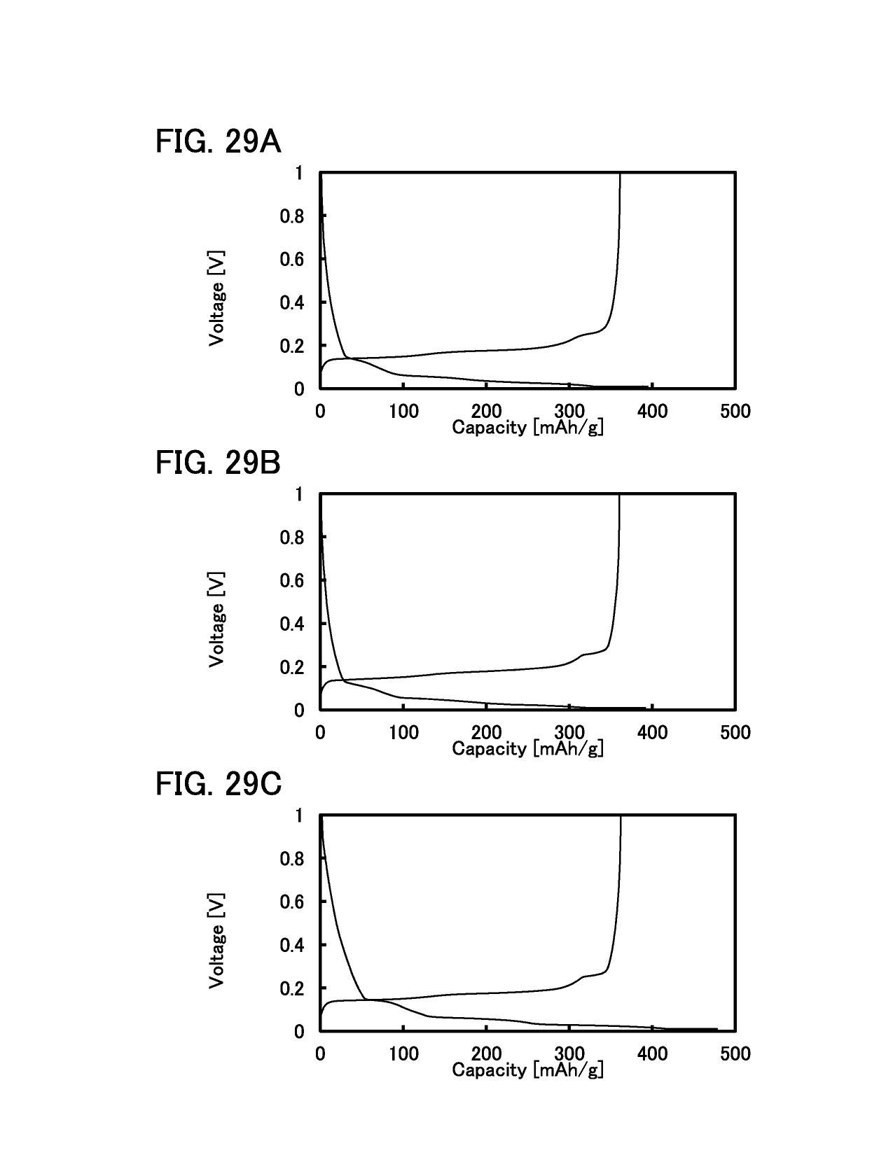

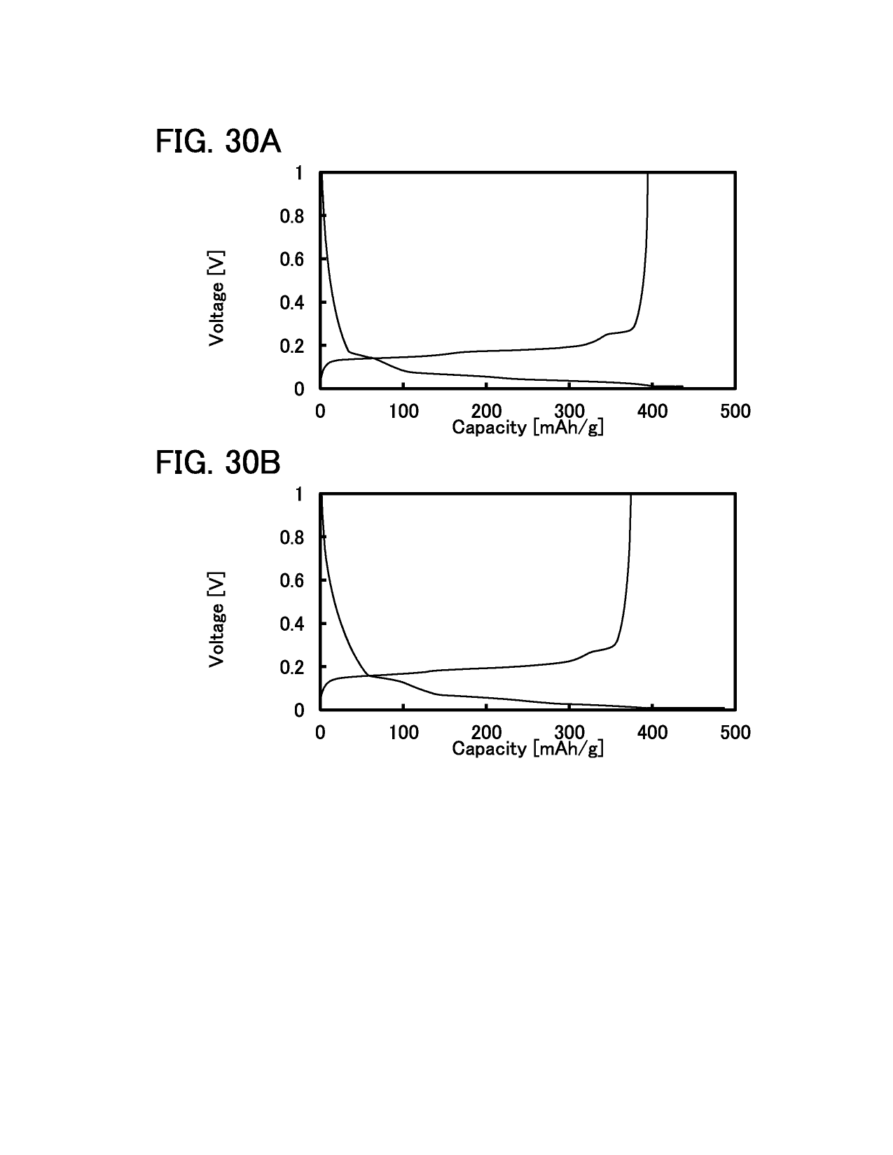

FIGS. 29A, 29B, and 29C show the charge-discharge curves of the storage batteries C-1-1, E-1-1, and D-1-1, respectively. FIGS. 30A and 30B show the charge-discharge curves of the storage batteries C-2-1 and D-2-1, respectively.

As an example, FIGS. 30A and 30B are compared with each other; it can be seen that, under the conditions under which the initial charge and discharge efficiency was low (FIG. 30B), the capacity during discharging, i.e., Li insertion from 1 V to approximately 0.15 V is higher. Under the conditions under which the initial charge and discharge efficiency was low, the degree of side reactions, i.e., reactions other than Li insertion, such as cation insertion or decomposition of the electrolyte solution, is probably high in the voltage range.

The above results can confirm that the use of the negative electrode C including CMC—Na and SBR as binders for a storage battery can suppress a capacity drop due to a side reaction or the like, so that a storage battery with higher performance can be obtained. Furthermore, when a storage battery is manufactured by combining the negative electrode C, for example, with the positive electrode including the positive electrode active material or the like described in Embodiment 1, a high-capacity storage battery in which a capacity drop due to a side reaction is suppressed can be achieved.

Both in the case of using the electrolyte solution A and in the case of using the electrolyte solution B, the use of the negative electrode C led to high initial charge and discharge efficiency. This indicates that the use of the negative electrode C can achieve high initial charge and discharge efficiency both in the case where a quaternary ammonium cation, which is a cation having an aliphatic ring, is used as a cation included in a solvent of an electrolyte solution and in the case where an imidazolium cation, which is a cation having an aromatic ring, is used, for example.

### EXAMPLE 5

In this example, a method for manufacturing the laminated storage battery described in Embodiment 1, which is an example of a power storage device of one embodiment of the present invention, and characteristics thereof are described.

### (Formation of Positive Electrode)

The compounding ratio and manufacturing conditions of a positive electrode are described. LiFePO₄ with a specific surface area of 9.2 m²/g was used as an active material. PVdF was used as a binding agent, and graphene was used as a conductive additive. Note that graphene was originally graphene oxide in the formation of a paste and obtained by reduction treatment after application of the electrode. The compounding ratio in the paste for the electrode was set to LiFePO₄:graphene oxide:PVdF=94.4:0.6:5.0 (weight %).

Next, a method for forming the paste for the positive electrode is described.

First, graphene oxide powder and NMP serving as a solvent were mixed with a mixer, so that a mixture 1 was obtained.

Subsequently, the active material was added to the mixture 1 and the mixture was kneaded with a mixer into a thick paste, so that a mixture 2 was obtained, By kneading the mixture into a thick paste, the cohesion of the active material can be weakened and graphene oxide can be dispersed highly uniformly.

Subsequently, PVdF was added to the mixture 2 and mixing was performed with a mixer, so that a mixture 3 was obtained.

Subsequently, the solvent NMP was added to the mixture 3 and mixing was performed with a mixer. Through the above steps, the paste was formed.

Subsequently, the formed paste was applied to an aluminum current collector (20 μm) which had been covered with an undercoat. The application was performed with a continuous coating device at a coating speed of 1 m/sec. After that, drying was performed using a drying furnace. The drying was performed at 80° C. for 4 minutes. Then, the electrode was reduced.

As the reduction, chemical reduction was first performed, followed by thermal reduction. Firstly, conditions of the chemical reduction are described. A solution used for the reduction was prepared as follows: a solvent in which NMP and water were mixed at 9:1 was used, and ascorbic acid and LiOH were added to the solvent to have a concentration of 77 mmol/L and 73 mmol/L, respectively. The reduction treatment was performed at 60° C. for 1 hour. After that, cleaning with ethanol was performed, and drying was performed in a reduced pressure atmosphere at room temperature. Next, conditions of the thermal reduction are described. After the chemical reduction, the thermal reduction was performed. The thermal reduction was performed in a reduced pressure atmosphere at 170° C. for 10 hours.

Subsequently, the positive electrode active material layer was pressed by a roll press method so as to be consolidated. Through the above steps, the positive electrode was formed.

### (Formation of Negative Electrode)

Next, a negative electrode was formed through steps similar to those of the negative electrode A described in Example 1. Spherical natural graphite having a particle diameter of 15 μm was used as a negative electrode active material, and SBR and CMC—Na were used as binders. The compounding ratio in the paste was set to graphite:SBR:CMC—Na=97:1.5:1.5 (weight ratio).

### (Fabrication of Laminated Storage Battery)

Next, with the use of the formed positive electrode and negative electrode, a laminated storage battery X and a laminated storage battery Y were fabricated. An aluminum film covered with a heat sealing resin was used as an exterior body. The area of the positive electrode was 8.194 cm², and the area of the negative electrode was 9.891 cm². As a separator, 50-μm-thick solvent-spun regenerated cellulosic fiber (TF40, produced by NIPPON KODOSHI CORPORATION) was used.

The positive electrode active material layer of the positive electrode used for the storage battery had an active material content higher than or equal to 9.0 mg/cm² and lower than or equal to 9.1 mg/cm², a thickness greater than or equal to 54 μm and less than or equal to 62 μm, and a density higher than or equal to 1.6 g/cc and lower than or equal to 1.8 g/cc. The negative electrode active material layer of the negative electrode used for the storage battery had an active material content higher than or equal to 4.9 mg/cm² and lower than or equal to 5.3 mg/cm², a thickness greater than or equal to 51 μm and less than or equal to 68 μm, and a density higher than or equal to 0.8 g/cc and lower than or equal to 1.0 g/cc.

One positive electrode and one negative electrode C were used as electrodes of one storage battery and were arranged so that surfaces on which their respective active material layers were formed faced each other with the separator provided therebetween.

As an electrolyte solution of the storage battery X, an electrolyte solution C given below was used; as an electrolyte solution of the storage battery Y, an electrolyte solution D given below was used.

As a nonaqueous solvent of the electrolyte solution C, 1,3-dimethyl-1-propylpiperidinium bis(fluorosulfonyl)amide (abbreviation: 3mPP13-FSA) represented by Structural Formula (53) was used, and LiTFSA used as an electrolyte was dissolved at a concentration of 1 mol/L.

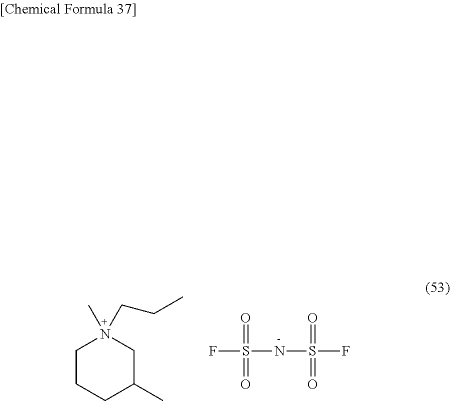

As a nonaqueous solvent of the electrolyte solution D, 1-butyl-3 -methylimidazolium bis(fluorosulfonyl)amide (abbreviation: BMI-FSA) represented by Structural Formula (54) was used, and LiTFSA used as an electrolyte was dissolved at a concentration of 1 mol/L.

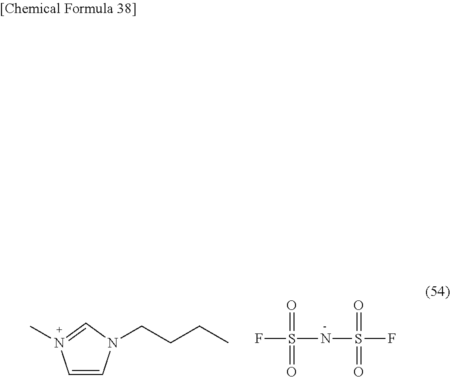

Next, the fabricated storage batteries X and Y were subjected to aging. Note that for calculation of the rate, 1 C was set to 170 mA/g, which was the current value per weight of the positive electrode active material.

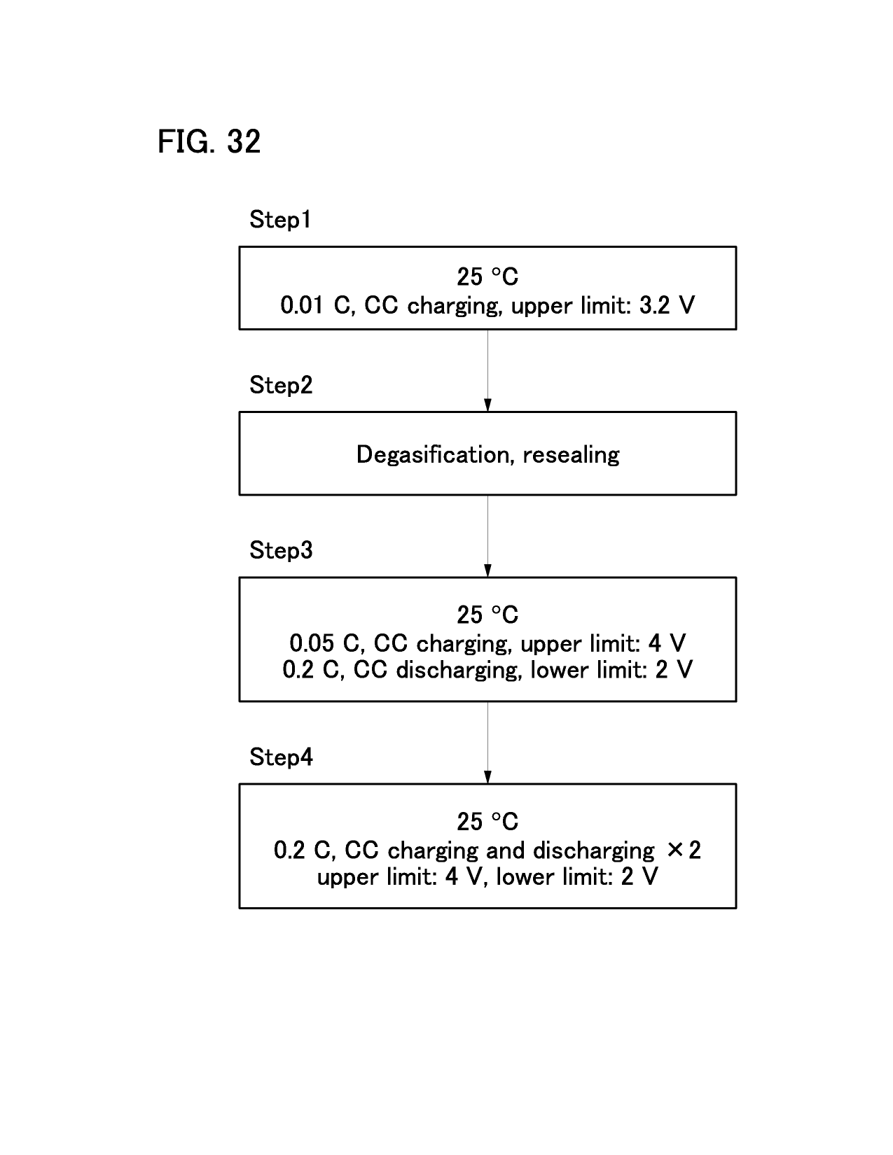

FIG. 32 shows a flow chart of the aging. First, charging was performed at 25° C. at a rate of 0.01 C to an upper limit voltage of 3.2 V (Step 1).

Subsequently, degasification was performed, and then, the batteries were sealed again (Step 2). Particularly in the initial charging, a large amount of gas might be generated. When the generated gas locally hinders the existence of the electrolyte solution on an electrode surface, for example, normal charging and discharging cannot be performed. This is why the degasification is preferably performed.

Subsequently, charging was performed at 25° C. at a rate of 0.05 C to an upper limit voltage of 4 V, and then, discharging was performed at a rate of 0.2 C to a lower limit voltage of 2 V (Step 3).

Subsequently, charging and discharging were each performed twice at 25° C. As the charging conditions, the upper limit voltage was set to 4 V and the rate was set to 0.2 C. As the discharging conditions, the lower limit voltage was set to 2 V and the rate was set to 0.2 C (Step 4).

Next, a charge-discharge cycle test of the fabricated storage batteries X and Y was performed. The measurement temperature was 60° C. Here, the charge-discharge cycle test means repetition of cycles, where one cycle corresponds to one charging and one discharging after the charging. In the first cycle, charging and discharging were performed at a rate of 0.1 C. Subsequently, 200 cycles of charging and discharging were performed at a rate of 0.5 C, followed by one charge-discharge cycle at a rate of 0.1C. After that, one charge-discharge cycle at a rate of 0.1 C was performed every 200 cycles at a rate of 0.5 C, and this procedure was repeated.

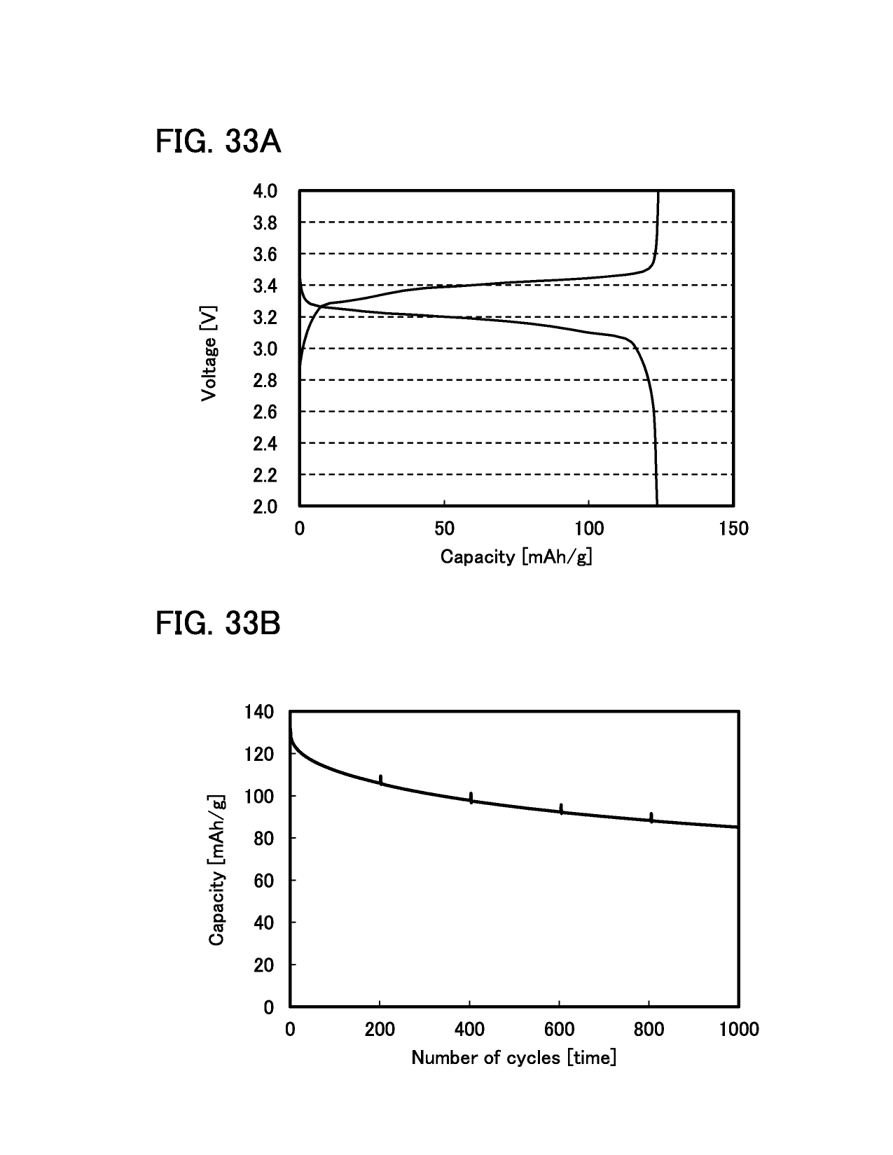

FIG. 33A shows the charge-discharge curves of the storage battery X in the second cycle. FIG. 33B shows the change in discharge capacity of the storage battery X with respect to the number of cycles. The discharge capacity in the 600th cycle was 92 mAh/g; 70% or more capacity of the discharge capacity in the second cycle, 128 mAh/g, was retained, and favorable characteristics were able to be achieved.

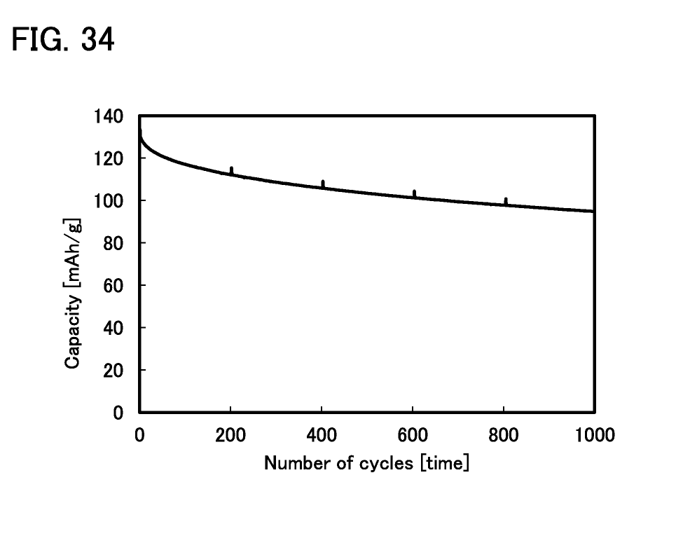

FIG. 34 shows the change in discharge capacity of the storage battery Y with respect to the number of cycles. As the discharge capacity in the 600th cycle, 70% or more capacity of the discharge capacity in the second cycle was retained, and favorable characteristics were able to be achieved.

This application is based on Japanese Patent Application serial no. 2013-200405 filed with Japan Patent Office on Sep. 26, 2013, the entire contents of which are hereby incorporated by reference.

What is claimed is:

1. A power storage device comprising:
a positive electrode;
a negative electrode comprising a negative electrode active material and a water-soluble polymer; and
an electrolyte solution comprising an ionic liquid between the positive electrode and the negative electrode,
wherein the ionic liquid comprises a cation and a monovalent amide anion.

2. A power storage device comprising:
a positive electrode;
a negative electrode comprising a negative electrode active material, a first material, and a second material; and
an electrolyte solution comprising an ionic liquid between the positive electrode and the negative electrode,
wherein the first material comprises a material having rubber elasticity,
wherein the second material comprises a water-soluble polymer, and
wherein the ionic liquid comprises a cation and a monovalent amide anion.

3. The power storage device according to claim 1, wherein the water-soluble polymer is polysaccharide.

4. The power storage device according to claim 2, wherein the water-soluble polymer is polysaccharide.

5. The power storage device according to claim 2, wherein the material having rubber elasticity is a polymer including a styrene monomer unit or a butadiene monomer unit.

6. The power storage device according to claim 1, wherein the monovalent amide anion is an anion represented by (CₙF₂ₙ₊₁SO₂)₂N⁻ or CF₂(CF₂SO₂)₂N⁻, n being greater than or equal to 0 and less than or equal to 3.

7. The power storage device according to claim 2, wherein the monovalent amide anion is an anion represented by (CₙF₂ₙ₊₁SO₂)₂N⁻ or CF₂(CF₂SO₂)₂N⁻, n being greater than or equal to 0 and less than or equal to 3.

8. The power storage device according to claim 1, further comprising a coating film on a surface of the negative electrode,
wherein a ratio of a proportion of oxygen to a proportion of fluorine (O/F) in the coating film is greater than or equal to 0.1 and less than or equal to 2.

9. The power storage device according to claim 2, further comprising a coating film on a surface of the negative electrode,
wherein a ratio of a proportion of oxygen to a proportion of fluorine (O/F) in the coating film is greater than or equal to 0.1 and less than or equal to 2.

10. The power storage device according to claim 1, further comprising a coating film on a surface of the negative electrode,
wherein the electrolyte solution comprises a lithium ion,
wherein the coating film comprises lithium fluoride and lithium carbonate, and
wherein a weight ratio of the lithium carbonate to the lithium fluoride (lithium carbonate/lithium fluoride) in the coating film is less than or equal to 2.

11. The power storage device according to claim 2, further comprising a coating film on a surface of the negative electrode,
wherein the electrolyte solution comprises a lithium ion,
wherein the coating film comprises lithium fluoride and lithium carbonate, and
wherein a weight ratio of the lithium carbonate to the lithium fluoride (lithium carbonate/lithium fluoride) in the coating film is less than or equal to 2.

12. The power storage device according to claim 1, wherein in a C1s spectrum obtained by X-ray photoelectron spectroscopy, a maximum value in a range from 290 eV to 292 eV inclusive is less than or equal to 0.3 times a maximum value in a range from 284.5 eV to 286 eV inclusive.

13. The power storage device according to claim 2, wherein in a C1s spectrum obtained by X-ray photoelectron spectroscopy, a maximum value in a range from 290 eV to 292 eV inclusive is less than or equal to 0.3 times a maximum value in a range from 284.5 eV to 286 eV inclusive.

14. The power storage device according to claim 1, wherein the negative electrode active material is a carbon material.

15. The power storage device according to claim 2, wherein the negative electrode active material is a carbon material.

16. The power storage device according to claim 14, wherein the carbon material is at least one selected from natural graphite, artificial graphite, mesophase pitch-based carbon fiber, isotropic pitch-based carbon fiber, and graphene.

17. The power storage device according to claim 15, wherein the carbon material is at least one selected from natural graphite, artificial graphite, mesophase pitch-based carbon fiber, isotropic pitch-based carbon fiber, and graphene.
